(19) United States
(12) Patent Application Publication
(10) Pub. No.: US 2014/0002762 A1
(43) Pub. Date: Jan. 2, 2014

(54) LIQUID CRYSTAL DRIVE METHOD AND LIQUID CRYSTAL DISPLAY DEVICE

(71) Applicants: Yosuke Iwata, Osaka-shi (JP); Mitsuhiro Murata, Osaka-shi (JP); Yasuhiro Nasu, Osaka-shi (JP); Hidefumi Yoshida, Osaka-shi (JP); Hiroaki Asagi, Osaka-shi (JP)

(72) Inventors: Yosuke Iwata, Osaka-shi (JP); Mitsuhiro Murata, Osaka-shi (JP); Yasuhiro Nasu, Osaka-shi (JP); Hidefumi Yoshida, Osaka-shi (JP); Hiroaki Asagi, Osaka-shi (JP)

(73) Assignee: SHARP KABUSHIKI KAISHA, Osaka-shi, Osaka (JP)

(21) Appl. No.: 14/005,640

(22) PCT Filed: Mar. 9, 2012
(86) PCT No.: PCT/JP2012/056052

§ 371 Date: Sep. 17, 2013

(30) Foreign Application Priority Data
Mar. 18, 2011 (JP) 2011-061663
Dec. 14, 2011 (JP) 2011-273874

(51) Int. Cl. G02F 1/1343

(52) U.S. Cl. CPC G02F 1/134363
USPC 349/42

(57) ABSTRACT

A liquid crystal driving method and a liquid crystal display apparatus that achieve a sufficiently fast response, and a sufficiently high transmittance, and reduces transmittance greatly during black image displaying. The liquid crystal driving method includes performing a driving operation to cause a potential difference between a first pair of electrodes during a subframe period, a driving operation to cause a potential difference between a second pair of electrodes, and a driving operation to cause no difference between all the electrodes of the first pairs of electrodes and the second pair of electrodes.

### BACKGROUND OF THE INVENTION

1. Field of the Invention

The present invention relates to liquid crystal driving methods and liquid crystal display apparatuses. More specifically, the present invention relates to a liquid crystal driving method and a liquid crystal display apparatus that display an image by applying a vertical electric field and an in-plane electric field with a plurality of electrodes.

2. Description of the Related Art

A liquid crystal driving method refers to a technique of moving liquid crystal molecules in a liquid crystal layer interposed between a pair of substrates by generating an electric field between the electrodes. The liquid crystal driving method changes optical characteristics of the liquid-crystal layer, in other words, causes on and off states by either allowing a light beam to be transmitted through the liquid-crystal layer or by not allowing the light beam to be transmitted through the liquid-crystal layer.

Liquid-crystal display apparatuses of various types featuring advantages including thin, light-weight, and low-power consumption designs are designed to perform liquid crystal driving and thus find a wide range of applications. For example, a variety of driving methods are devised and put into practical use in a personal computer, a television, on-board apparatuses including a car navigation system, and a display of a mobile information terminal such as a cell phone.

A variety of display methods (display modes) of liquid crystal display apparatuses have been developed in view of characteristics of liquid crystal, arrangements of electrodes, and substrate designs. Display modes in widespread use today mainly include a vertical alignment (VA) mode in which liquid crystal molecules having negative dielectric anisotropy are vertically aligned with respect to the surface of a substrate, an in-plane switching (IPS) mode in which an in-plane electric field is applied to a liquid-crystal layer with liquid crystal molecules having positive or negative dielectric anisotropy horizontally aligned with respect to the surface of a substrate, and a fringe field switching (FFS) mode. Several liquid crystal driving methods of each of these display modes have been disclosed.

For example, a liquid crystal display apparatus of the FFS driving mode is disclosed as a thin-film transistor liquid crystal display having a fast response and wide-view angle features. The liquid-crystal display apparatus includes a first substrate having a first common electrode layer, a second substrate having a pixel electrode layer and a second common electrode layer, liquid crystals interposed between the first substrate and the second substrate, and means that generates an electric field between the first common electrode of the first substrate and each of the pixel electrode and the second common electrode of the second substrate in order to provide a fast response to a fast input data transfer speed and a wide-view angle to a viewer (See Japanese Unexamined Patent Application Publication (Translation of PCT Application) No. 2006-523850, for example).

Also disclosed is another liquid crystal apparatus that applies an in-plane electric field with a plurality of electrodes. The liquid crystal display apparatus includes a liquid crystal layer containing liquid crystal molecules having positive dielectric anisotropy and interposed between a pair of opposed substrates. The liquid crystal display apparatus includes a first substrate and a second substrate as the opposed substrates. Each of the first substrate and the second substrate includes an electrode, and the electrodes are opposed to each other with the liquid crystal layer interposed therebetween and are configured to apply a vertical electric field on the liquid crystal layer. The second substrate includes a plurality of electrodes that apply an in-plane electric field to the liquid crystal layer (see Japanese Unexamined Patent Application Publication No. 2002-365657, for example).

In the FFS driving liquid crystal display apparatus, a fringe electric field is generated between an upper-layer slit electrode and a lower-layer planar electrode of a lower substrate during a rise time (a duration of time throughout which a display state changes from a dark state (black image displaying) to a light state (white image displaying)) and a vertical electric field is generated by a potential difference between the substrates during a fall time (a duration of time throughout which the display state changes from the light state (white display)) to the dark state (black image displaying). The liquid crystal molecules are thus rotated by these electric fields, thereby achieving a fast response. On the other hand, as described in Japanese Unexamined Patent Application Publication No. 2006-523850, only liquid crystal molecules in the vicinity of the slit electrodes are rotated when the fringe electric field is generated using the slit electrodes in the liquid crystal display apparatus having the liquid crystal molecules vertically aligned (see FIG. 62), and no sufficient transmittance results.

FIG. 60 is a sectional view of a liquid crystal display panel having an electrode structure of a related art FFS driving method on a lower substrate. FIG. 61 is a plan view of the liquid crystal display panel of FIG. 60. FIG. 62 illustrates simulation results of a director distribution, an electric field distribution, and a transmittance distribution of the liquid crystal display panel of FIG. 60. In a structure of the liquid crystal display panel of FIG. 60, a slit electrode is supplied with a constant voltage (for example, the constant voltage is 14 V. It is acceptable that a potential difference between the slit electrode and an opposite electrode 313 is a threshold value or above. The threshold value is intended to mean a voltage value that causes an electric field at which an optical change occurs in the liquid crystal layer, causing a change in a display state of the liquid crystal display apparatus), and opposite electrodes 313 and 323 are respectively arranged on the substrate having the slit electrode and the opposite substrate. The opposite electrodes 313 and 323 are supplied with 7 V. FIG. 62 illustrates the simulation results during the rise time, more specifically, the voltage distribution, the distribution of directors D, the transmittance distribution (solid line).

Japanese Unexamined Patent Application Publication No. 2002-365657 discloses that the liquid crystal display apparatus having a three-layer structure performs comb driving to increase a response speed. Japanese Unexamined Patent Application Publication No. 2002-365657 describes only liquid crystal apparatuses of twisted nematic (TN) mode as a display mode in practice, and does not disclose anything about a liquid crystal apparatus of vertical alignment that provides advantageous features including the wide viewing angle and high-contrast characteristics. Japanese Unexamined Patent Application Publication No. 2002-365657 also fails to describe an improvement in the transmittance and a relationship between the electrode structure and the transmittance.

### SUMMARY OF THE INVENTION

Preferred embodiments of the present invention provide a liquid crystal driving method and a liquid crystal display apparatus that achieve a sufficiently fast response, and a sufficiently high transmittance, and which greatly reduce transmittance during black image displaying.

The inventors of the present invention have studied a liquid crystal driving method of a vertically aligned liquid crystal display panel and a liquid crystal display apparatus that achieve a sufficiently fast response, and a sufficiently high transmittance, and reduces transmittance greatly during black image displaying, and focus attention on a technique that causes a potential difference between at least two pairs of electrodes to perform alignment control on liquid crystal molecules through an electric field during both a rise time and a fall time. The inventors have further studied the driving method that includes driving the liquid crystal during a period including a subframe period, the subframe period being a drive period extending until the liquid crystal is changed in state and restored back to an initial state thereof. The inventors have discovered that the creation of electric field states during the subframe period, respectively through a driving operation to cause a potential difference between a first pair of electrodes, and a driving operation to cause a potential difference between a second pair of electrodes, allow the two pairs of electrodes to appropriately perform switching from an electric field application state to an electric field application state (switching from an electric field applied state to another electric field applied state). In this way, with the two electric fields applied, the liquid crystal molecules are rotated and a liquid crystal display apparatus having a fast response feature results. Furthermore, the inventors have discovered that the execution of a driving operation during the subframe period to cause no potential difference between all the electrodes of the first pair of electrodes and the second pair of electrodes appropriately initializes the alignment of liquid crystal molecules in the vicinity of the electrode edges of the first pair of electrodes, and causes the transmittance to sufficiently decrease during black image displaying. Thus, preferred embodiments of the present invention are able to overcome the above-described problems. Preferred embodiments of the present invention include a feature in that the liquid crystal is driven by the two pairs of electrodes, and that the execution of the driving operation during the subframe period causes no potential difference between all the electrodes of the first pair of electrodes and the second pair of electrodes appropriately initializes the alignment of liquid crystal molecules. Preferred embodiments of the present invention are different from the prior art discussed above. Furthermore, although the problem of response speed becomes outstanding at a low temperature environment, preferred embodiments of the present invention overcome this problem, and further achieve sufficient transmittance.

More specifically, preferred embodiments of the present invention relate to a liquid crystal driving method to drive liquid crystal by causing a potential difference between at least two pairs of electrodes arranged on an upper substrate and a lower substrate. The liquid crystal driving method includes driving the liquid crystal during a period including a subframe period, the subframe period being a drive period extending until the liquid crystal is changed in state and restored back to an initial state thereof. The liquid crystal driving method includes performing a driving operation to cause a potential difference between the first pair of electrodes, a driving operation to cause a potential difference between the second pair of electrodes, and a driving operation to cause no potential difference between all the electrodes of the first pair of electrodes and the second pair of electrodes during the subframe period, with one pair of electrodes being a first pair and the other pair of electrodes different from the first pair being a second pair.

To “cause a potential difference between the first pair of electrodes” is to cause a potential difference between at least the first pair of electrodes. It is sufficient if the alignment of the liquid crystal is controlled by an electric field between the first pair of electrodes more than by an electric field between the second pair of electrodes. To “cause a potential difference between the second pair of electrodes” is to cause a potential difference between at least the second pair of electrodes. It is sufficient if the alignment of the liquid crystal is controlled by an electric field between the second pair of electrodes more than by an electric field between the first pair of electrodes. A reference to “at least two pairs of electrodes arranged on the upper substrate and the lower substrate” is a reference to at least two pairs of electrodes that are arranged on at least one of the upper substrate and the lower substrate.

The “driving operation to cause no potential difference between all the electrodes of the first pair of electrodes and the second pair of electrodes” (this driving operation is also referred to as an initialization process step in this description) corresponds to an operation in which no potential difference is caused between all the electrodes of the first pair of electrodes and the second pair of electrodes on condition that the effects of preferred embodiments of the present invention are provided. The liquid crystal molecules are restored back to an initial alignment by setting all the electrodes to be equipotential. In this way, the transmittance which remains raised unless the electrodes are set to be equipotential is sufficiently decreased to an initial black state (as denoted by an area enclosed by a broken line in FIG. 11, for example). The initialization process step is simply a driving operation that causes no potential difference between all the electrodes in practice. In one example of a preferred embodiment of the present invention, at least one electrode of a comb electrode pair may be kept floating with a TFT in an off state. In another example, a constant voltage is applied to at least one electrode of the comb electrode pair with all the TFTs in an on state. In yet another example of a preferred embodiment of the present invention, the TFTs connected to even-numbered lines or odd-numbered lines are set to be in the on state, and a constant voltage is applied to one electrode of the comb electrode pair on a per even-numbered line basis or on a per odd-numbered line basis. It is sufficient if these three driving operations are simply performed during the subframe period. A preferable order of the driving operations is described below.

In the liquid crystal driving method according to a preferred embodiment of the present invention, the driving operation to cause no potential difference between all the electrodes of the first pair of electrodes and the second pair of electrodes is preferably performed subsequent to the driving operation to cause a potential difference between the second pair of electrodes. In this way, the alignment state of the liquid crystal molecules, if not sufficiently initialized by the driving operation to cause the potential difference between the second pair of electrodes, is sufficiently initialized. The liquid crystal driving method according to a preferred embodiment of the present invention more preferably includes performing, in order, a first driving operation to cause a potential difference between the first pair of electrodes, a second driving operation to cause a potential difference between the second pair of electrodes, and a third driving operation to cause no potential difference between all the electrodes of the first pair of electrodes and the second pair of electrodes. The alignment state of the liquid crystal molecules, which may be insufficiently initialized because an equipotential plane fails to be horizontal between the first pairs of electrodes in the second driving operation, is sufficiently initialized.

The liquid crystal driving method according to a preferred embodiment of the present invention is preferably an active matrix driving method. The active matrix driving is performed using a plurality of bus lines including thin-film transistors, and includes inverting a potential change applied to an (N+1)-th bus line in polarity from a potential change applied to an N-th bus line. The reference to “inverting a potential change applied to an (N+1)-th bus line in polarity from a potential change applied to an N-th bus line” corresponds to a positive potential change and a negative potential change being applied with reference to a give potential. The absolute values of the potential changes are preferably approximately equal to each other.

In the liquid crystal driving method according to a preferred embodiment of the present invention, preferably, a first driving operation is to turn on thin-film transistors connected to an N-th bus line, a second driving operation is to turn on or off the thin-film transistors connected to the N-th bus line, and a third driving operation is preferably to turn or off the thin-film transistors connected to the N-th bus line. One of the preferred embodiments of the liquid crystal driving method of the present invention (such as a first preferred embodiment, a second preferred embodiment, a modification of the second preferred embodiment, and a third preferred embodiment to be discussed below) is the second driving operation to turn on the thin-film transistors connected to the N-th bus line. One of the preferred embodiments of the liquid crystal driving method of the present invention (such as the second preferred embodiment discussed below) is the second driving operation to turn off the thin-film transistors connected to the N-th bus line. To turn or off the thin-film transistors connected to the N-th bus line is preferably intended to mean that all or substantially all the thin-film transistors connected to the N-th bus line are turned on or off. Here N represents an even number or an odd number. By turning off the thin-film transistor, the electrode connected to the thin-film transistor can be set be floating, and the potential of the electrode can be set to be closer to the potential of a nearby electrode (for example, an electrode arranged on the same substrate as the substrate that is set to be floating). The bus lines include a gate bus line and a source bus line, for example.

In the active matrix driving with one-side electrodes of the second pairs of electrodes serving as an electrode common to each bus line, and connected to one-side electrodes of the first pairs of electrodes, a voltage applied to the electrode common to the N-th bus line is set to be different in level in an initial state from a voltage applied to the electrode common to the (N+1)-th bus line, and a constant voltage is applied to the other-side electrodes of the second pairs of electrodes. The potentials of the one-side electrodes of the second pairs of electrodes connected the one-side electrodes of the first pairs of electrodes, corresponding to the electrodes of the N-th bus line, may be in the initial state different from or equal to the potentials of the one-side electrodes of the second pairs of electrodes connected the one-side electrodes of the first pairs of electrodes, corresponding to the electrodes of the (N+1)-th bus line. More specifically, one of the preferred embodiments of the present invention is the active matrix driving with one-side electrodes of the second pairs of electrodes serving as the electrode common to each bus line, and connected to one-side electrodes of the first pairs of electrode, and the voltage applied to the electrode common to the N-th bus line is set to be different in the initial state from the voltage applied to the electrode common to the (N+1)-th bus line, and the constant voltage is applied to the other-side electrodes of the second pairs of electrodes. Also, one of the preferred embodiments of the present invention is the active matrix driving with one-side electrodes of the second pairs of electrodes serving as the electrode common to each bus line, and the voltage applied to the electrode common to the N-th bus line is set to be equal in the initial state to the voltage applied to the electrode common to the (N+1)-th bus line, and the constant voltage is applied to the other-side electrodes of the second pairs of electrodes.

In the active matrix driving method, the other-side electrodes of the second pairs of electrodes serve as an electrode common to each bus line, and a voltage applied to the electrode common to the N-th bus line is set to be different in an initial state from a voltage applied to the electrode common to the (N+1)-th bus line. For example, one of the preferred embodiments of the present invention is the active matrix driving method. In the active matrix method with one-side electrodes of the second pairs of electrodes serving as an electrode common to each bus line, and connected to one-side electrodes of the first pairs of electrode, a voltage applied to the electrode common to the N-th bus line is set to be different in an initial state from a voltage applied to the electrode common to the (N+1)-th bus line, and with the other-side electrodes of the second pairs of electrodes serving as an electrode common to each bus line, a voltage applied to the electrode common to the N-th bus line is set to be different in the initial state from a voltage applied to the electrode common to the (N+1)-th bus line.

The thin-film transistors connected to the N-th bus line and thin-film transistors connected to the (N+1)-th bus line are preferably turned on between the first driving operation and the second driving operation.

The first pair of electrodes is preferably a pair of comb electrodes, and more preferably, the two comb electrodes are opposed to each other in a plan view of the main surface side of the substrate. Since the in-plane electric field is appropriately generated between the comb electrodes, the liquid crystal layer has fast response and high transmittance features during the rise time if the liquid crystal layer contains the liquid crystal molecules having a positive dielectric anisotropy. If the liquid crystal layer contains the liquid crystal molecules having a negative dielectric anisotropy, the in-plane electric field rotates the liquid crystal molecules, thereby achieving the fast response at the fall time. The pair of comb electrodes preferably includes comb tooth portions that run side by side in a plan view of the main surface of the substrate. The comb tooth portions of the pair of comb electrodes are preferably generally in parallel or substantially in parallel to each other. In other words, each of the electrodes of the pair has preferably a plurality of slits run generally in parallel or substantially in parallel to each other. FIG. 15 and other figures schematically illustrate a pair of comb electrodes having a single comb tooth portion. Typically, each comb electrode includes two or more comb tooth portions.

The second pair of electrodes preferably gives rise to a potential difference between the substrates. In this way, a vertical electric field is generated between the substrates, causing the liquid crystal molecules to rotate, and achieving the fast response during the fall time in the liquid crystal layer having a positive dielectric anisotropy or during the rise time in the liquid crystal layer having a negative dielectric anisotropy. For example, during the fall time, the electric field generated between the upper substrate and the lower substrate rotates the liquid crystal molecules to be vertical to the main surface of the substrate, thereby achieving the fast response. Preferably, the first pair of electrodes is a pair of comb electrodes arranged one of the upper and lower substrates, and the second pair of electrodes is opposite electrodes respectively arranged on the upper and lower electrodes.

The opposite electrodes respectively arranged on the upper substrate and the lower substrate are preferably planar electrodes. In this way, the vertical electric field is appropriately generated. In this description, the planer electrode includes a set of electrically connected electrodes in a plurality of pixels. For example, the planar electrode includes a set of electrically connected electrodes in all the pixels, and a set of electrically connected electrodes in all the pixels in the same column. The term “planar” refers to any planar shape that is accepted as planar in the technical field of preferred embodiments of the present invention. The planar electrode may partially have an orientation anchoring structure such as a rib or a slit, or may have an orientation anchoring structure in the center of each pixel in a plan view, but preferably, the planar electrode has no orientation anchoring structure. In order to generate the in-plane electric field and the vertical electric field in a preferred fashion, electrodes on the side of the liquid crystal layer (upper layer electrodes) are preferably set to be the first pair of electrodes, and an electrode on the side opposite the liquid crystal layer (lower layer substrates) is preferably set to be one electrode of the second pair of electrodes. For example, one electrode of the second pair may be arranged on an insulating layer on a lower layer below the first pair of electrodes (a layer opposite the liquid crystal layer if viewed from the side of the second substrate). Furthermore, the one-side electrodes of the second pairs may be independent from pixel to pixel, but are preferably electrically connected across the pixels in the same column. If the one-side electrodes of the first pairs are electrically connected to the one-side electrodes of the second pairs with the one-side electrodes of the second pair commonly electrically connected across the pixels in the same pixel column, the one-side electrodes of the first pairs are automatically electrically connected across the pixels in the same column. This arrangement corresponds to one of the preferred embodiments of the present invention. The one-side electrode of the second pair is preferably at least planar where the one-side electrode of the second pair overlaps the other-side electrode of the second pair in a plan view of the main surface of the substrate.

FIG. 69 and FIG. 70 are schematic sectional views illustrating a preferred embodiment of a comb electrode related to a liquid crystal driving method of the present invention. As illustrated in FIG. 69, a pair of comb electrodes 417 and 419 may be arranged on the same layer. The pair of comb electrodes 417 and 419 may also be arranged on different layers as illustrated in FIG. 70 (see a pair of comb electrodes 517 and 519) as long as the effects of the preferred embodiments of the present invention are produced, but the pair of comb electrodes is preferably arranged on the same layer. Including the “pair of comb electrodes arranged on the same layer” corresponds to an arrangement in which each of the comb electrodes remains in contact with the common member (such as, for example, the insulating layer or the liquid crystal layer) on the side of the liquid crystal layer and/or on the side opposite the liquid crystal layer.

The liquid crystal preferably contains liquid crystal molecules that are aligned to be vertical to the substrate main surface during a no-voltage application period. The phrase “aligned to be vertical to the substrate main surface” corresponds to an alignment vertical to the substrate main surface that is accepted as vertically aligned to the substrate main surface in the technical field of the present invention, and includes a vertical or substantially vertical alignment. The liquid crystal preferably contains the liquid crystal molecules that are aligned to be vertical to the substrate main surface with an applied voltage less than a threshold value. The phrase “during the no-voltage application period” corresponds to a substantial no-voltage application that is typically accepted as no voltage application in the technical field of the preset invention. Such vertical alignment liquid crystal is advantageous because of wide viewing angle and high-contrast characteristics, and is finding more applications.

The electrodes of the first pair may be preferably different from each other in potential in a range equal to or above a threshold voltage. For example, the threshold voltage corresponds to a voltage value that gives rise to a transmittance of about 5% with a transmittance in a light state being about 100%. The phrase “different from each other in potential in the range equal to or above the threshold voltage” corresponds to when a driving operation with different potential levels is enabled at the threshold voltage or above, and in this way, the electric field applied to the liquid crystal is appropriately controlled. The upper limit of the preferably different potentials is about 20 V, for example. In the arrangement of the different potentials, the one electrode of the first pair is driven by a TFT, and the other electrode of the first pair is driven by another TFT or is electrically connected to a lower layer electrode below the other electrode of the first pair. Thus, the electrodes of the first pair have different potentials. If the first pair of electrodes is a pair of comb electrodes, the width of a comb tooth portion of the pair of comb electrodes is preferably about 2 μm or wider. The length between one comb tooth portion and a next comb tooth portion (referred to as a space in the description) is preferably from about 2 μm to about 7 μm, for example.

The term “pixel in the same column” corresponds to a pixel column that is arranged along a gate bus line in a plan view of the substrate main surface in the active matrix driving scheme. If at least the one-side electrodes of the second pairs are electrically connected across the pixels in the same column, the electrodes are supplied with a voltage to invert a potential change on the pixels corresponding to an even-numbered gate bus line at a time, or on the pixels corresponding to an odd-numbered gate bus line at a time. The in-line electric field is thus appropriately generated, achieving the fast response.

The liquid crystal is preferably aligned including a horizontal component with respect to the substrate main surface by setting a potential difference between the electrodes of the first pair to be higher than the threshold voltage. An “alignment in a horizontal direction” corresponds to an alignment in a horizontal direction that is accepted as the horizontal alignment in the technical field of the present invention. In this way, the fast response is achieved. If the liquid crystal contains the liquid crystal molecules having a positive dielectric anisotropy (positive-type liquid crystal molecules), the transmittance is increased. The liquid crystal layer preferably contains the liquid crystal molecules aligned in the horizontal direction with respect to the substrate main surface in a range equal to or above the threshold voltage.

The liquid crystal preferably contains the liquid crystal molecules having a positive dielectric anisotropy (i.e., a positive-type liquid crystal layer). The liquid crystal molecules having a positive dielectric anisotropy are aligned in a certain direction with an electric field applied. Alignment control of the liquid crystal is easy, and the liquid crystal has the fast response feature. The liquid crystal also preferably contains the liquid crystal molecules having a negative dielectric anisotropy (i.e., negative-type liquid crystal molecules). In this way, the transmittance is increased. From the standpoint of the fast response, the liquid crystal molecules are preferably liquid crystal molecules having or substantially having a positive dielectric anisotropy, and from the standpoint of the transmittance, the liquid crystal molecules are preferably liquid crystal molecules having or substantially having a negative dielectric anisotropy.

At least one of the upper substrate and the lower substrate includes an alignment layer on the side thereof facing the liquid crystal layer. The alignment layer is preferably a vertical alignment layer. The alignment layers include an alignment layer manufactured of an organic material or an inorganic material, an alignment layer manufactured of an optically active material, an alignment layer that is aligned by rubbing, among other alignment layers. Using an alignment layer, such as an alignment layer or an optical alignment layer, which needs no alignment process, the process of the liquid crystal display panel is facilitated, and costs in the process are reduced. The reliability and yield of the liquid crystal display panel are increased. If the rubbing process is performed, an impure substance such as, for example, a rubbing cloth may be included. The inclusion of the impure substance leads to pollution of the liquid crystal, or a point defect caused by a foreign substance, and non-uniform rubbing on the liquid crystal display panel causes a display uneveness. The liquid crystal display panel is free or substantially free from these problems. At least one of the upper substrate and the lower substrate preferably includes a polarizer on the side thereof opposite the liquid crystal layer. The polarizer is preferably a circularly polarizing plate. This arrangement further promotes a transmittance increasing effect. The polarizer is also preferably a linearly polarizing plate. This arrangement improves the viewing angle characteristics.

In the liquid crystal driving method of preferred embodiments of the present invention, a potential difference caused between the electrodes of the second pair (between the opposite electrodes respectively arranged on the upper substrate and the lower substrate) is preferably higher than a potential difference caused between the electrodes of the first pair (for example, between the pair of comb electrodes arranged on one of the upper substrate and the lower substrate) during the generation of the vertical electric field. For example, the potential of the opposite electrode on the upper substrate and the potential of the opposite electrode on the lower substrate are set to be about 7.5 V and about 0 V, respectively, and the potentials of the pair of comb electrodes are set to be about 0 V. The potential of the opposite electrode on the upper substrate and the potential of the opposite electrode on the lower substrate are set to be about 7.5 V and about 15 V, respectively, and the potentials of the pair of comb electrodes are set to be about 15 V. The potential of the opposite electrode on the upper substrate and the potential of the opposite electrode on the lower substrate are set to be about 0 V and about 15 V, respectively, and the potentials of the pair of comb electrodes are set to be about 15 V.

As described above, the driving method of preferred embodiments of the present invention preferably includes executing a driving operation to cause no or substantially no potential difference between all the electrodes of the first pair and the second pair (initialization process step) subsequent to the generation of the vertical electric field. With this arrangement, the alignment of the liquid crystal in the vicinity of an edge of at least one of the first pair of electrodes and the second pair of electrodes (such as, for example, a pair of comb electrodes) is controlled, and the transmittance is increased. The initialization process step is preferably performed subsequent to the generation of the vertical electric field. Another electric field may be generated subsequent to the generation of the vertical electric field, but the initialization process step is preferably performed immediately subsequent to the generation of the vertical electric field.

To generate the in-plane electric field, a potential difference is typically generated at least between the first pair of electrodes (for example, between the pair of comb electrodes arranged on one of the upper substrate and the lower substrate). For example, a potential difference generated between the first pair of electrodes is set to be higher than a potential difference generated between the second pair of electrodes (for example, between the opposite electrodes respectively arranged on the upper substrate and the lower substrate). The potential of the opposite electrode on the upper substrate and the potential of the opposite electrode on the lower substrate are set to be about 7.5 V and about 0 V, respectively, and the potentials of the pair of comb electrodes arranged on the lower substrate are set to be about 15 V and about 0 V, respectively. The potential of the opposite electrode on the upper substrate and the potential of the opposite electrode on the lower substrate are set to be about 7.5 V and about 7.5 V, respectively, and the potentials of the pair of comb electrodes arranged on the lower substrate are set to be about 15 V and about 0 V, respectively. The potential of the opposite electrode on the upper substrate and the potential of the opposite electrode on the lower substrate are set to be about 0 V and about 0 V, respectively, and the potentials of the pair of comb electrodes arranged on the lower substrate are set to be about 15 V and about 0 V, respectively. A potential difference generated between the first pair of electrodes may be set to be lower than a potential difference generated between the second pair of electrodes. To display a low gradation image through the in-plane electric field between the tooth portions, the potential of the opposite electrode on the upper substrate and the potential of the opposite electrode on the lower substrate may be set to be about 7.5 V and about 0 V, respectively, and the potentials of the pair of comb electrodes arranged on the lower substrate may be set to be about 10 V and about 5 V (the potential between the tooth portions being about 5 V), respectively.

A potential change is inverted by applying a voltage to lower layer electrodes (one-side electrodes of the second pair) commonly connected on a per even-numbered line basis and on a per odd-numbered line basis. The potential of the electrodes biased at a constant voltage may be an intermediate potential. If the potential of the electrodes biased at a constant voltage is considered to be about 0 V, it is interpreted that the voltage to be applied to the lower-layer electrodes is inverted in polarity on a per bus line basis.

The upper substrate and the lower substrate of the liquid crystal display panel of preferred embodiments of the present invention are a pair of substrates to hold a liquid crystal therebetween, and include an insulating substrate of glass, resin, or the like as a base, and is produced by arranging wirings, electrodes, and color filters on the insulating substrate. In the liquid crystal driving method of preferred embodiments of the present invention, at least one of the upper substrate and the lower substrate preferably includes a dielectric layer.

Preferably, at least one electrode of the first pair of electrodes is a pixel electrode, and the substrate including the first pair of electrodes is an active matrix substrate. The liquid crystal driving method of preferred embodiments of the present invention is applicable to, for example, any of transmissive, reflective, and semi-transmissive liquid crystal display apparatuses.

Preferred embodiments of the present invention also relate to a liquid crystal display apparatus that is driven using the liquid crystal driving method of the present invention. A preferred embodiment of the liquid crystal driving method of the liquid crystal apparatus of the present invention is identical or substantially identical to a preferred embodiment of the liquid crystal driving method of the preferred embodiments of the present invention described above. The liquid crystal display apparatuses include a display of, for example, each of a personal computer, a television, on-board apparatuses including a car navigation system, and a mobile information terminal such as a cell phone. The liquid crystal display apparatus is preferably applied to the on-board apparatuses, including the car navigation system, which may be used in a low-temperature environment.

The configuration of the liquid crystal driving method and the liquid crystal display apparatus of the preferred embodiments of the present invention include the elements described above as necessary components, and the use of other components in the configuration is optional. Other configuration of ordinary liquid crystal driving methods and liquid crystal display apparatuses may also be applied.

The preferred embodiments described above may be appropriately combined within the scope of the present invention.

According to the liquid crystal driving method and the liquid crystal display apparatus of the preferred embodiments of the present invention, the liquid crystal is driven by the first pair of electrodes and the second pair of electrodes, achieving a sufficiently fast response, and a sufficiently high transmittance, and reduces transmittance greatly during black image displaying.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic sectional view of a liquid crystal display panel of a first preferred embodiment of the present invention during the generation of an in-plane electric field.

FIG. 2 is a schematic sectional view of the liquid crystal display panel of the first preferred embodiment of the present invention during the generation of a vertical electric field.

FIG. 3 is a schematic sectional view of the liquid crystal display panel of the first preferred embodiment of the present invention during an initialization process step.

FIG. 4 is a schematic sectional view of the liquid crystal display panel of the first preferred embodiment of the present invention during the generation of the in-plane electric field.

FIG. 5 illustrates simulation results of the liquid crystal display panel of FIG. 4.

FIG. 6 is a schematic sectional view of the liquid crystal display panel of the first preferred embodiment of the present invention during the generation of the vertical electric field.

FIG. 7 illustrates simulation results of the liquid crystal display panel of FIG. 6.

FIG. 8 is a schematic sectional view of the liquid crystal display panel of the first preferred embodiment of the present invention during an initialization process step subsequent to the generation of the vertical electric field.

FIG. 9 illustrates simulation results of the liquid crystal display panel of FIG. 8.

FIG. 10 is a graph illustrating a comparison of response waveforms through simulation of comb driving and FFS driving.

FIG. 11 is a graph illustrating a measurement value of a drive response waveform and a rectangular waveform applied to each electrode in the first preferred embodiment of the present invention.

FIG. 12 is a graph illustrating a relationship between a maximum transmittance and a cell thickness d in the first preferred embodiment of the present invention.

FIG. 13 is a graph illustrating a relationship between a maximum transmittance and a space S in the first preferred embodiment of the present invention.

FIG. 14 is a schematic sectional view of the liquid crystal display panel of the first preferred embodiment of the present invention.

FIG. 15 is a plan view of a picture element in the liquid crystal display panel of the first preferred embodiment of the present invention.

FIG. 16 is an equivalent circuit diagram of the picture element in the liquid crystal display panel of the first preferred embodiment of the present invention.

FIG. 17 illustrates a potential change of each electrode in the liquid crystal display panel of the first preferred embodiment of the present invention.

FIG. 18 is a schematic sectional view illustrating each electrode at an N-th row of the liquid crystal display panel of the first preferred embodiment of the present invention during the generation of the in-plane electric field.

FIG. 19 is a schematic sectional view illustrating each electrode at the N-th row of the liquid crystal display panel of the first preferred embodiment of the present invention during the generation of the vertical electric field.

FIG. 20 is a schematic sectional view illustrating each electrode at the N-th row of the liquid crystal display panel of the first preferred embodiment of the present invention during the initialization process step subsequent to the generation of the vertical electric field.

FIG. 21 is a schematic sectional view illustrating each electrode at an (N+1)-th row of the liquid crystal display panel of the first preferred embodiment of the present invention during the generation of the in-plane electric field.

FIG. 22 is a schematic sectional view illustrating each electrode at the (N+1)-th row of the liquid crystal display panel of the first preferred embodiment of the present invention during the generation of the vertical electric field.

FIG. 23 is a schematic sectional view illustrating each electrode at the (N+1)-th row of the liquid crystal display panel of the first preferred embodiment of the present invention during the initialization process step subsequent to the generation of the vertical electric field.

FIG. 24 is a schematic sectional view of the liquid crystal display panel of a second preferred embodiment of the present invention.

FIG. 25 is a plan view of a picture element in the liquid crystal display panel of the second preferred embodiment of the present invention.

FIG. 26 is an equivalent circuit diagram of the picture element in the liquid crystal display panel of the second preferred embodiment of the present invention.

FIG. 27 illustrates a potential change of each electrode in the liquid crystal display panel of the second preferred embodiment of the present invention.

FIG. 28 is a schematic sectional view illustrating each electrode at an N-th row of the liquid crystal display panel of the second preferred embodiment of the present invention during the generation of an in-plane electric field.

FIG. 29 is a schematic sectional view illustrating each electrode at the N-th row of the liquid crystal display panel of the second preferred embodiment of the present invention during an initialization process step subsequent to the generation of the in-plane electric field.

FIG. 30 is a schematic sectional view illustrating each electrode at the N-th row of the liquid crystal display panel of the second preferred embodiment of the present invention during the generation of a vertical electric field.

FIG. 31 is a schematic sectional view illustrating each electrode at the N-th row of the liquid crystal display panel of the second preferred embodiment of the present invention during a initialization process step subsequent to the generation of the vertical electric field.

FIG. 32 is a schematic sectional view illustrating each electrode at an (N+1)-th row of the liquid crystal display panel of the second preferred embodiment of the present invention during the generation of the in-plane electric field.

FIG. 33 is a schematic sectional view illustrating each electrode at the (N+1)-th row of the liquid crystal display panel of the second preferred embodiment of the present invention during the initialization process step subsequent to the generation of the in-plane electric field.

FIG. 34 is a schematic sectional view illustrating each electrode at the (N+1)-th row of the liquid crystal display panel of the second preferred embodiment of the present invention during the generation of the vertical electric field.

FIG. 35 is a schematic sectional view illustrating each electrode at the (N+1)-th row of the liquid crystal display panel of the second preferred embodiment of the present invention during the initialization process step subsequent to the generation of the vertical electric field.

FIG. 36 is a schematic sectional view of the liquid crystal display panel of a modification of the second preferred embodiment of the present invention.

FIG. 37 is a plan view of a picture element in the liquid crystal display panel of the modification of the second preferred embodiment of the present invention.

FIG. 38 is an equivalent circuit diagram of the picture element in the liquid crystal display panel of the modification of the second preferred embodiment of the present invention.

FIG. 39 illustrates a potential change of each electrode in the liquid crystal display panel of the modification of the second preferred embodiment of the present invention.

FIG. 40 is a schematic sectional view illustrating each electrode at an N-th row of the liquid crystal display panel of the modification of the second preferred embodiment of the present invention during the generation of an in-plane electric field.

FIG. 41 is a schematic sectional view illustrating each electrode at the N-th row of the liquid crystal display panel of the modification of the second preferred embodiment of the present invention during the generation of a vertical electric field.

FIG. 42 is a schematic sectional view illustrating each electrode at the N-th row of the liquid crystal display panel of the modification of the second preferred embodiment of the present invention during an initialization process step subsequent to the generation of the vertical electric field.

FIG. 43 is a schematic sectional view illustrating each electrode at an (N+1)-th row of the liquid crystal display panel of the modification of the second preferred embodiment of the present invention during the generation of the in-plane electric field.

FIG. 44 is a schematic sectional view illustrating each electrode at the (N+1)-th row of the liquid crystal display panel of the modification of the second preferred embodiment of the present invention during the generation of the vertical electric field.

FIG. 45 is a schematic sectional view illustrating each electrode at the (N+1)-th row of the liquid crystal display panel of the modification of the second preferred embodiment of the present invention during an initialization process step subsequent to the generation of the vertical electric field.

FIG. 46 is a schematic sectional view of the liquid crystal display panel of a third preferred embodiment of the present invention.

FIG. 47 is a plan view of a picture element in the liquid crystal display panel of the third preferred embodiment of the present invention.

FIG. 48 is an equivalent circuit diagram of the picture element in the liquid crystal display panel of the third preferred embodiment of the present invention.

FIG. 49 illustrates a potential change of each electrode in the liquid crystal display panel of the third preferred embodiment of the present invention.

FIG. 50 is a schematic sectional view illustrating each electrode at an N-th row of the liquid crystal display panel of the third preferred embodiment of the present invention during the generation of an in-plane electric field.

FIG. 51 is a schematic sectional view illustrating each electrode at the N-th row of the liquid crystal display panel of the third preferred embodiment of the present invention during the generation of a vertical electric field.

FIG. 52 is a schematic sectional view illustrating each electrode at the N-th row of the liquid crystal display panel of the third preferred embodiment of the present invention during an initialization process step subsequent to the generation of the vertical electric field.

FIG. 53 is a schematic sectional view illustrating each electrode at an (N+1)-th row of the liquid crystal display panel of the third preferred embodiment of the present invention during the generation of the in-plane electric field.

FIG. 54 is a schematic sectional view illustrating each electrode at the (N+1)-th row of the liquid crystal display panel of the third preferred embodiment of the present invention during the generation of the vertical electric field.

FIG. 55 is a schematic sectional view illustrating each electrode at the (N+1)-th row of the liquid crystal display panel of the third preferred embodiment of the present invention during the initialization process step subsequent to the generation of the vertical electric field.

FIG. 56 is a schematic plan view illustrating a driving method of a preferred embodiment of the present invention.

FIG. 57 is a schematic plan view illustrating a driving operation of the liquid crystal display panel of a preferred embodiment of the present invention.

FIG. 58 is a schematic plan view illustrating the driving operation of the liquid crystal display panel of a preferred embodiment of the present invention.

FIG. 59 is a schematic plan view illustrating the driving operation of the liquid crystal display panel of a preferred embodiment of the present invention.

FIG. 60 is a schematic sectional view illustrating a liquid crystal display panel of a first comparative example during the generation of a fringe electric field.

FIG. 61 is a schematic plan view illustrating the liquid crystal display panel of the first comparative example.

FIG. 62 illustrates simulation results of the liquid crystal display panel of FIG. 60.

FIG. 63 illustrates simulation results of the liquid crystal display panel obtained when the vertical electric field is continuously applied with no initialization process step performed.

FIG. 64 illustrates simulation results of the liquid crystal display panel with the initialization process step performed.

FIG. 65 is a graph illustrating a response waveform obtained through simulation of comb driving in a TN mode of a third comparative example.

FIG. 66 illustrates simulation results of the liquid crystal display panel of the third comparative example.

FIG. 67 illustrates simulation results of the liquid crystal display panel of the third comparative example.

FIG. 68 illustrates simulation results of the liquid crystal display panel of the third comparative example.

FIG. 69 is a schematic sectional view of an example of a comb electrode related to the liquid crystal driving method of a preferred embodiment of the present invention.

FIG. 70 is a schematic sectional view of an example of the comb electrode related to the liquid crystal driving method of a preferred embodiment of the present invention.

FIG. 71 is a schematic sectional view of the liquid crystal display panel of a fourth preferred embodiment of the present invention.

FIG. 72 is a plan view of a picture element in the liquid crystal display panel of the fourth preferred embodiment of the present invention.

FIG. 73 is an equivalent circuit diagram of the picture element in the liquid crystal display panel of the fourth preferred embodiment of the present invention.

FIG. 74 illustrates a potential change of each electrode in the liquid crystal display panel of the fourth preferred embodiment of the present invention.

FIG. 75 is a schematic sectional view illustrating each electrode at an N-th row of the liquid crystal display panel of the fourth preferred embodiment of the present invention during the generation of an in-plane electric field.

FIG. 76 is a schematic sectional view illustrating each electrode at the N-th row of the liquid crystal display panel of the fourth preferred embodiment of the present invention during the generation of a vertical electric field.

FIG. 77 is a schematic sectional view illustrating each electrode at the N-th row of the liquid crystal display panel of the fourth preferred embodiment of the present invention during an initialization process step subsequent to the generation of the vertical electric field.

FIG. 78 is a schematic sectional view illustrating each electrode at an (N+1)-th row of the liquid crystal display panel of the fourth preferred embodiment of the present invention during the generation of the in-plane electric field.

FIG. 79 is a schematic sectional view illustrating each electrode at the (N+1)-th row of the liquid crystal display panel of the fourth preferred embodiment of the present invention during the generation of the vertical electric field.

FIG. 80 is a schematic sectional view illustrating each electrode at the (N+1)-th row of the liquid crystal display panel of the fourth preferred embodiment of the present invention during an initialization process step subsequent to the generation of the vertical electric field.

FIG. 81 is a schematic sectional view of the liquid crystal display panel of a fifth preferred embodiment of the present invention.

FIG. 82 is a plan view of a picture element in the liquid crystal display panel of the fifth preferred embodiment of the present invention.

FIG. 83 is an equivalent circuit diagram of the picture element in the liquid crystal display panel of the fifth preferred embodiment of the present invention.

FIG. 84 illustrates a potential change of each electrode in the liquid crystal display panel of the fifth preferred embodiment of the present invention.

FIG. 85 is a schematic sectional view illustrating each electrode at an N-th row of the liquid crystal display panel of the fifth preferred embodiment of the present invention during the generation of an in-plane electric field.

FIG. 86 is a schematic sectional view illustrating each electrode at the N-th row of the liquid crystal display panel of the fifth preferred embodiment of the present invention during an initialization process step subsequent to the generation of the in-plane electric field.

FIG. 87 is a schematic sectional view illustrating each electrode at the N-th row of the liquid crystal display panel of the fifth preferred embodiment of the present invention during the generation of a vertical electric field.

FIG. 88 is a schematic sectional view illustrating each electrode at the N-th row of the liquid crystal display panel of the fifth preferred embodiment of the present invention during an initialization process step subsequent to the generation of the vertical electric field.

FIG. 89 is a schematic sectional view illustrating each electrode at an (N+1)-th row of the liquid crystal display panel of the fifth preferred embodiment of the present invention during the generation of the in-plane electric field.

FIG. 90 is a schematic sectional view illustrating each electrode at the (N+1)-th row of the liquid crystal display panel of the fifth preferred embodiment of the present invention during an initialization process step subsequent to the generation of the in-plane electric field.

FIG. 91 is a schematic sectional view illustrating each electrode at the (N+1)-th row of the liquid crystal display panel of the fifth preferred embodiment of the present invention during the generation of the vertical electric field.

FIG. 92 is a schematic sectional view illustrating each electrode at the (N+1)-th row of the liquid crystal display panel of the fifth preferred embodiment of the present invention during an initialization process step subsequent to the generation of the vertical electric field.

FIG. 93 is a schematic sectional view of the liquid crystal display panel of a modification of the fifth preferred embodiment of the present invention.

FIG. 94 is a plan view of a picture element in the liquid crystal display panel of the modification of the fifth preferred embodiment of the present invention.

FIG. 95 is an equivalent circuit diagram of the picture element in the liquid crystal display panel of the modification of the fifth preferred embodiment of the present invention.

FIG. 96 illustrates a potential change of each electrode in the liquid crystal display panel of the modification of the fifth preferred embodiment of the present invention.

FIG. 97 is a schematic sectional view illustrating each electrode at an N-th row of the liquid crystal display panel of the modification of the fifth preferred embodiment of the present invention during the generation of an in-plane electric field.

FIG. 98 is a schematic sectional view illustrating each electrode at the N-th row of the liquid crystal display panel of the modification of the fifth preferred embodiment of the present invention during the generation of a vertical electric field.

FIG. 99 is a schematic sectional view illustrating each electrode at the N-th row of the liquid crystal display panel of the modification of the fifth preferred embodiment of the present invention during an initialization process step subsequent to the generation of the vertical electric field.

FIG. 100 is a schematic sectional view illustrating each electrode at an (N+1)-th row of the liquid crystal display panel of the modification of the fifth preferred embodiment of the present invention during the generation of the in-plane electric field.

FIG. 101 is a schematic sectional view illustrating each electrode at the (N+1)-th row of the liquid crystal display panel of the modification of the fifth preferred embodiment of the present invention during the generation of the vertical electric field.

FIG. 102 is a schematic sectional view illustrating each electrode at the (N+1)-th row of the liquid crystal display panel of the modification of the fifth preferred embodiment of the present invention during an initialization process step subsequent to the generation of the vertical electric field.

FIG. 103 is a schematic sectional view of a liquid crystal display panel of a sixth preferred embodiment of the present invention.

FIG. 104 is a graph illustrating a comparison of response waveforms through simulations of the presence or absence of a dielectric layer on an opposite electrode in accordance with a preferred embodiment of the present invention.

FIG. 105 is an equivalent circuit diagram of a picture element in the liquid crystal display panel of the sixth preferred embodiment of the present invention.

FIG. 106 is a schematic sectional view of each electrode at an N-th row of the liquid crystal display panel of the sixth preferred embodiment of the present invention during the generation of an in-plane electric field.

FIG. 107 is a schematic sectional view of each electrode at the N-th row of the liquid crystal display panel of the sixth preferred embodiment of the present invention during the generation of a vertical electric field.

FIG. 108 is a schematic sectional view of each electrode at the N-th row of the liquid crystal display panel of the sixth preferred embodiment of the present invention during an initialization process step subsequent to the generation of the vertical electric field.

FIG. 109 is a graph illustrating the transmittance with respect to time with the layer thickness of the dielectric layer varied in the sixth preferred embodiment of the present invention.

FIG. 110 is a graph illustrating transmittances at times T_{ON}, and T_{OFF3.6ms} and contrast ratio with respect to the layer thickness of the dielectric layer in the sixth preferred embodiment of the present invention.

FIG. 111 is a graph illustrating the transmittance with respect to time with the layer thickness of the dielectric layer varied in the sixth preferred embodiment of the present invention.

FIG. 112 is a graph illustrating transmittances at times T_{ON}, and T_{OFF3.6ms} and contrast ratios with respect to the specific dielectric constant of the dielectric layer in the sixth preferred embodiment of the present invention.

### DETAILED DESCRIPTION OF THE PREFERRED EMBODIMENTS

Preferred embodiments of the present invention are described further in detail below. The present invention is not limited to these preferred embodiments. In the following description, the term pixel refers to a picture element (e.g., a subpixel) unless otherwise noted. The term subframe is opposed to the term frame during which all the pixels (including RGB pixels) are used to display an image, and refers to time to display one color when continuous displaying of each color is performed in one frame using all or a portion of picture elements through field sequential (time-division) driving. In the description, the term subframe refers to a period for displaying. A planar electrode may partially have an orientation anchoring structure such as a rib or a slit as long as the planar electrode is accepted as planar in the technical field of the present invention. In principle, however, the planar electrode preferably has no orientation anchoring structure. A pair of substrates including a liquid crystal layer interposed therebetween is referred to as upper and lower substrates. The substrate on a display screen side is referred to as the upper substrate, and the substrate on the side opposite the display screen is referred to as the lower substrate. An electrode on the side of the display screen, among electrodes arranged on the substrates, is referred to as an upper layer electrode, and an electrode on the side opposite the display screen is referred to as a lower layer electrode. Furthermore, a circuit substrate of a preferred embodiment of the present invention (a second substrate) is referred to as a thin-film transistor (TFT) substrate or an array substrate because the circuit substrate has TFTs. In the present preferred embodiment, both during a rise time (an in-plane electric field applied) and during a fall time (a vertical electric file applied), the TFT is turned on so that a voltage is applied to at least one electrode of a pair of comb electrodes (pixel electrode).

In the following discussion of preferred embodiments of the present invention, members or portions having the same function are identified with the same symbol. In drawings, unless otherwise noted, a label (i) indicates the potential of one electrode of the comb electrodes on the topside of the lower substrate, a label (ii) indicates the potential of the other electrode of the comb electrodes on the topside of the lower substrate, a label (iii) indicates the potential of a planar electrode on the underside of the lower substrate, and a label (iv) indicates the potential of a planar electrode of the upper substrate. Two pairs of electrodes are preferably driven by (i) and (ii), and (iii) and (iv), respectively. Other methods may also provide effects of preferred embodiments of the present invention.

### First Preferred Embodiment

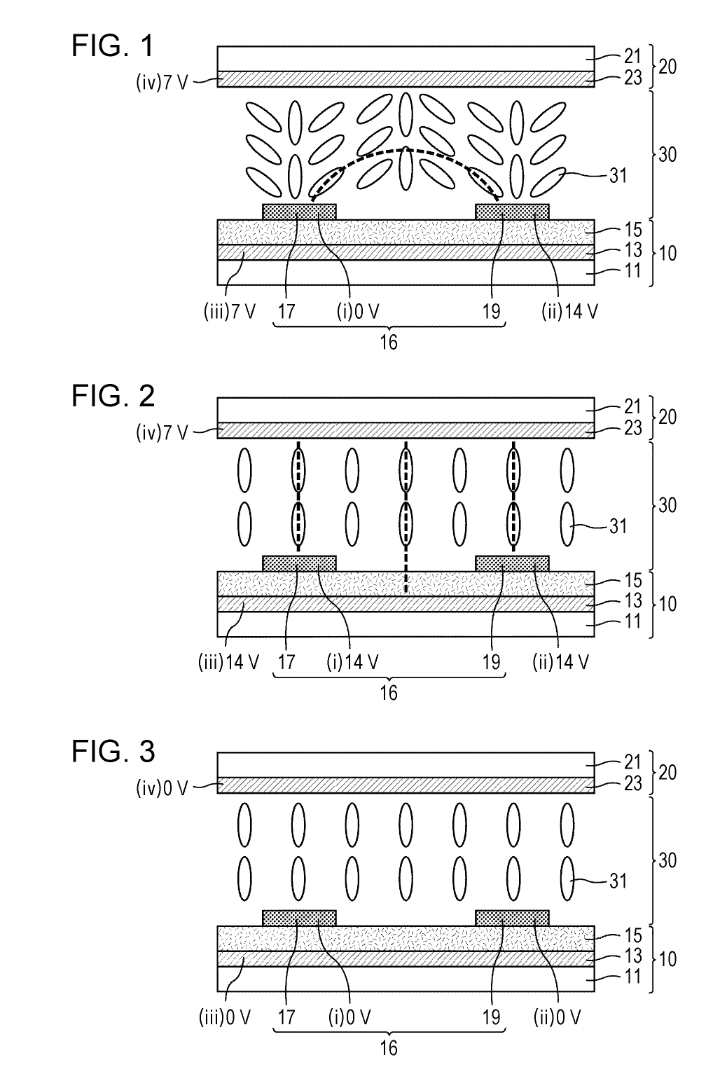

FIG. 1 is a schematic sectional view of a liquid crystal display panel of a first preferred embodiment of the present invention during the generation of an in-plane electric field. FIG. 2 is a schematic sectional view of the liquid crystal display panel of the first preferred embodiment during the generation of a vertical electric field. As illustrated in FIG. 1 and FIG. 2, a broken line indicates the direction of a generated electric field. The liquid crystal display panel of the first preferred embodiment preferably includes a vertically aligned three-layer electrode structure including liquid crystal molecules 31 as a positive-type liquid crystal (an upper layer electrode corresponding to a second layer on the lower substrate is a comb electrode). During the rise time, the in-plane electric field generated by a potential difference of about 14 V between a pair of comb electrodes 16 (preferably a comb electrode 17 having a potential of about 0 V and a comb electrode 19 having a potential of about 14 V) rotates the liquid crystal molecules to rotate as illustrated in FIG. 1. Then, there occurs no or substantially no potential difference between the substrates (an opposite electrode 13 arranged on the lower substrate 11 and having a potential of about 7 V and an opposite electrode 23 arranged on the upper substrate 21 and having a potential of about 7 V).

During the fall time, the vertical electric field generated by a potential difference of about 7 V between the substrates (between the opposite electrode 13, the comb electrode 17 and the comb electrode 19, each having a potential of about 14V, and the opposite electrode 23 having a potential of 7 V) rotates the liquid crystal molecules to rotate as illustrated in FIG. 2. Then, there occurs substantially no potential difference between the pair of the comb electrodes 16 (including the comb electrode 17 having a potential of about 14 V and the comb electrode 19 having a potential of about 14 V).

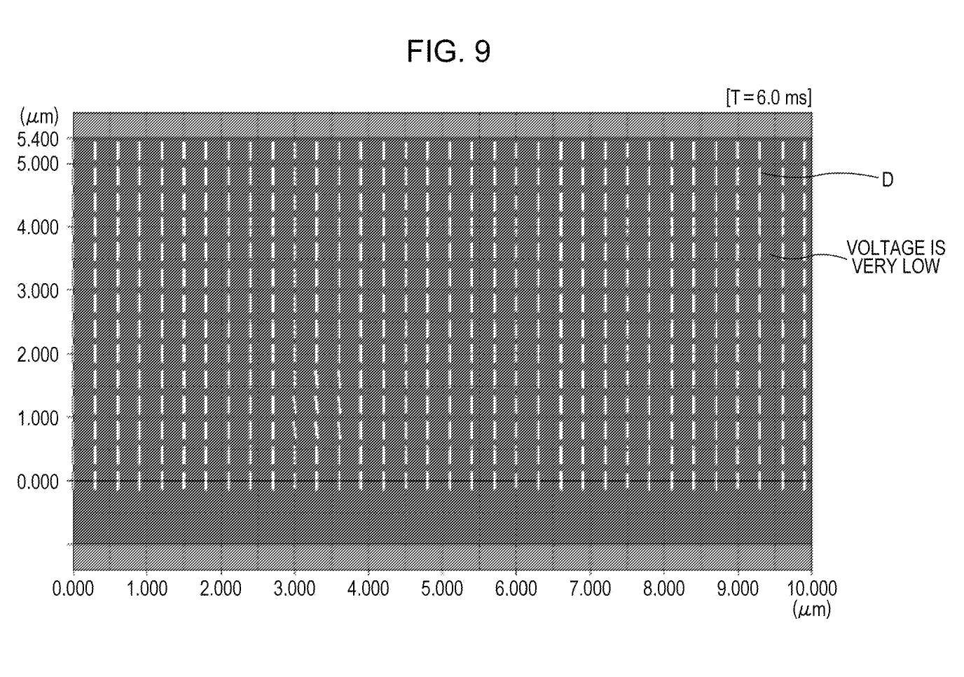

FIG. 3 is a schematic sectional view of the liquid crystal display panel of the first preferred embodiment during an initialization process step. During the initialization process step, substantially no potential difference is generated between all the electrodes of the first pair of electrodes and the second pair of electrodes as illustrated in FIG. 3. As illustrated in FIG. 3, about 0 V is applied to all the electrodes. It is sufficient if all the electrodes are substantially equipotential, and it is not necessary to apply exactly 0 V to all the electrodes. By setting all the electrodes to be equipotential, a period is permitted to restore the liquid crystal molecules back to an initial complete vertical alignment (such as is shown, for example, in FIG. 9). The transmittance, which is slightly raised with the vertical electric field remaining applied, can be reduced to an initial black state.

During both the rise time and the fall time, the electric field rotates the liquid crystal molecules, thereby achieving a high response. More specifically, during the rise time, the in-plane electric field between a pair of comb electrodes sets the liquid crystal molecules in an on state, thereby providing a high transmittance. During the fall time, the vertical electric field between the substrates sets the liquid crystal molecules in an on state, thereby achieving the fast response. Furthermore, the in-plane electric field of comb driving also increases transmittance. It is noted that the positive-type liquid crystal is preferably employed as a liquid crystal in the first preferred embodiment and subsequent preferred embodiments, but a negative-type liquid crystal may alternatively be used instead of the positive-type liquid crystal if so desired. If the negative-type liquid crystal is used, a potential difference between the substrates horizontally aligns the liquid crystal molecules, and a potential difference between a pair of comb electrodes vertically aligns the liquid crystal molecules. In the same manner as with the positive-type liquid crystal, the transmittance during the black image display is sufficiently reduced by aligning the liquid crystal molecules sufficiently in a vertical direction in the initialization process step. The transmittance performance becomes satisfactory in this way, and the fast response is achieved by rotating the liquid crystal molecules by the electric fields during the rise time and the fall time. A driving operation to cause a potential difference between the opposite electrodes respectively arranged on the upper substrate and the lower substrate, a driving operation to cause a potential difference between the pair of comb electrodes, and a driving operation to cause no potential difference between all the electrodes of the opposite electrodes and the pair of comb electrodes in that order are preferably performed in this case. A driving operation to cause a potential difference between a pair of comb electrodes, a driving operation to cause a potential difference between opposite electrodes respectively arranged on the upper substrate and the lower substrate, a driving operation to cause no potential difference between all the electrodes of the opposite electrodes and the pair of comb electrodes in that order are preferably performed, as described below, if the positive-type liquid crystal is used. In the description, labels (i) and (ii) indicate the potentials of the pair of comb electrodes, a label (iii) indicates the potential of the planar electrode on the lower layer substrate, and a label (iv) indicates the potential of the planar electrode of the upper layer substrate.

As illustrated in FIG. 1 and FIG. 2, the liquid crystal display panel of the first preferred embodiment preferably includes an array substrate 10, a liquid crystal layer 30, and an opposite layer 20 (preferably, for example, a color filter substrate) laminated in that order from the back side of the liquid crystal display panel to the viewing screen side thereof. The liquid crystal display panel of the first preferred embodiment vertically aligns the liquid crystal molecules when the potential difference between the comb electrodes is lower than a threshold voltage as illustrated in FIG. 2. As illustrated in FIG. 1, when the voltage difference between the comb electrodes is equal to or above the threshold voltage, the electric field generated between the comb electrodes 17 and 19 (the pair of the comb electrodes 16) as an upper layer electrode arranged on a glass substrate 11 (the lower substrate) tilts the liquid crystal molecules between the comb electrodes at a horizontal direction. The transmittance is thus controlled. An insulating layer 15 is sandwiched between the planar lower layer electrode (the opposite electrode 13) and the comb electrodes 17 and 19 (the pair of the comb electrodes 16). The insulating layer 15 may preferably be manufactured of, for example, an oxide film SiO₂, a nitride film SiN, an acrylic resin, or a combination thereof.

A polarizer, though not illustrated in FIG. 1 and FIG. 2, is preferably arranged on the sides of the two substrates opposite the liquid crystal layer. The polarizers may include, for example, a circularly polarizing plate and a linearly polarizing plate. An alignment layer is arranged on the side of each of the two substrates facing the liquid crystal layer. An organic alignment layer or an inorganic alignment layer may be acceptable as the alignment layer as long as the alignment layer vertically aligns the liquid crystal molecules with respect to the layer surface.

A voltage supplied via a video signal line is applied to the comb electrode 19 driving the liquid crystal via a thin-film transistor (TFT) at a timing when a scanning signal line is selected. In the present preferred embodiment, the comb electrode 17 and the comb electrode 19 are preferably arranged on the same layer. While arranging the comb electrode 17 and the comb electrode 19 at the same layer is preferable, it is also possible to arrange the comb electrode 17 and the comb electrode 19 at different layers as long as the effects of the preferred embodiments of the present invention, more specifically, the increase in the transmittance by applying the in-plane electric field in response to the potential difference between the comb electrodes, is achieved. The comb electrode 19 is preferably connected to a drain electrode that extends from the TFT via a contact hole. Note that the opposite electrodes 13 and 23 are planar in FIG. 1 and FIG. 2 and that the opposite electrodes 13 are commonly connected on each of the even-numbered line and the odd-numbered line of the gate bus lines. These electrodes are also referred to as a planar electrode in the description. The opposite electrodes 23 corresponding to all pixels are commonly connected.

The thin-film transistor is preferably an oxide semiconductor TFT (IGZO or the like) from the standpoint of the transmittance increasing effect. The oxide semiconductor exhibits a higher carrier mobility than amorphous silicon. In this way, an area occupied by the transistor per pixel is reduced, and an aperture ratio is increased. The light transmittance per pixel is increased. Therefore, the use of the oxide semiconductor TFT even more promotes the transmittance increasing effect as one of the effects of the present invention.

An electrode width of the comb electrodes L is about 2.4 μm in the present preferred embodiment and, preferably, is about 2 μm or wider, for example. An electrode spacing S between the comb electrodes is about 2.6 μm in the present preferred embodiment, and, preferably, is about 2 μm or wider, for example. Note that an upper limit of the electrode spacing is preferably about 7 μm. A ratio of the electrode width L to the electrode spacing (L/S) is preferably about 0.4 through about 3, for example. More preferably, the lower limit of the ratio is about 0.5, and the upper limit of the ratio is about 1.5.

A cell gap d is about 5.4 μm here, and is preferably within a range of from about 2 μm to about 7 μm. In the description, the cell gap d (a thickness of the liquid crystal layer) is preferably calculated by averaging the thickness of the whole area of the liquid crystal layer in the liquid crystal display panel.

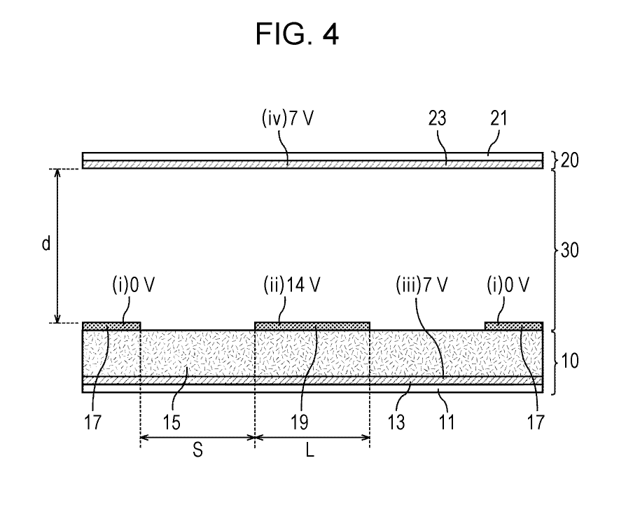

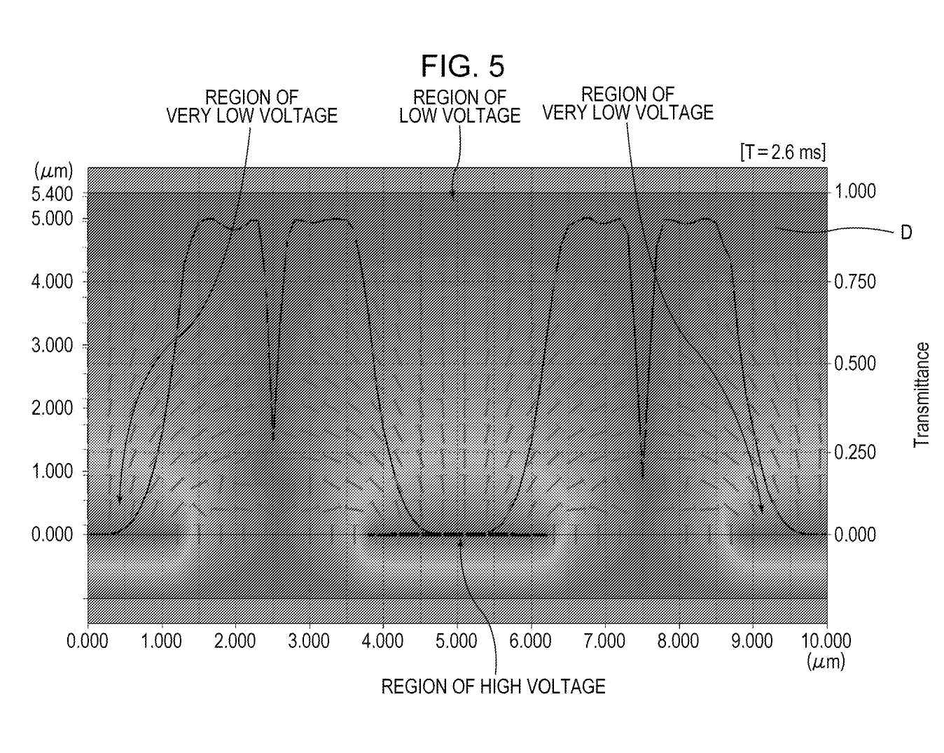

FIG. 4 is a schematic sectional view of the liquid crystal display panel of the first preferred embodiment during the generation of the in-plane electric field. In the driving operation of the comb driving of the first preferred embodiment, the in-plane electric field, generated between the pair of the comb electrodes 16 (including the comb electrode 17 having a potential of about 0 V and the comb electrode 19 having a potential of about 14 V), can rotate the liquid crystal molecules in a wide region between the pair of comb electrodes (see FIG. 4 and FIG. 5).

FIG. 5 illustrates simulation results of the liquid crystal display panel of FIG. 4. FIG. 5 illustrates the simulation results at 2.2 ms after a rise time of directors D, electric fields, and transmittance distribution (as illustrated in drawings (graphs) below, no driving is performed during a first 0.4 ms duration). A solid-line plot represents transmittance. The director D represents an alignment direction of the long axis of the liquid crystal molecule. In the simulation conditions, the cell thickness was 5.4 μm, and the comb tooth spacing was 2.6 μm.

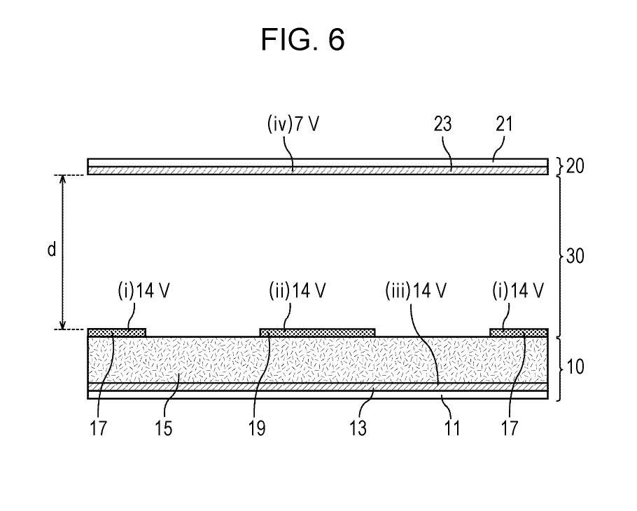

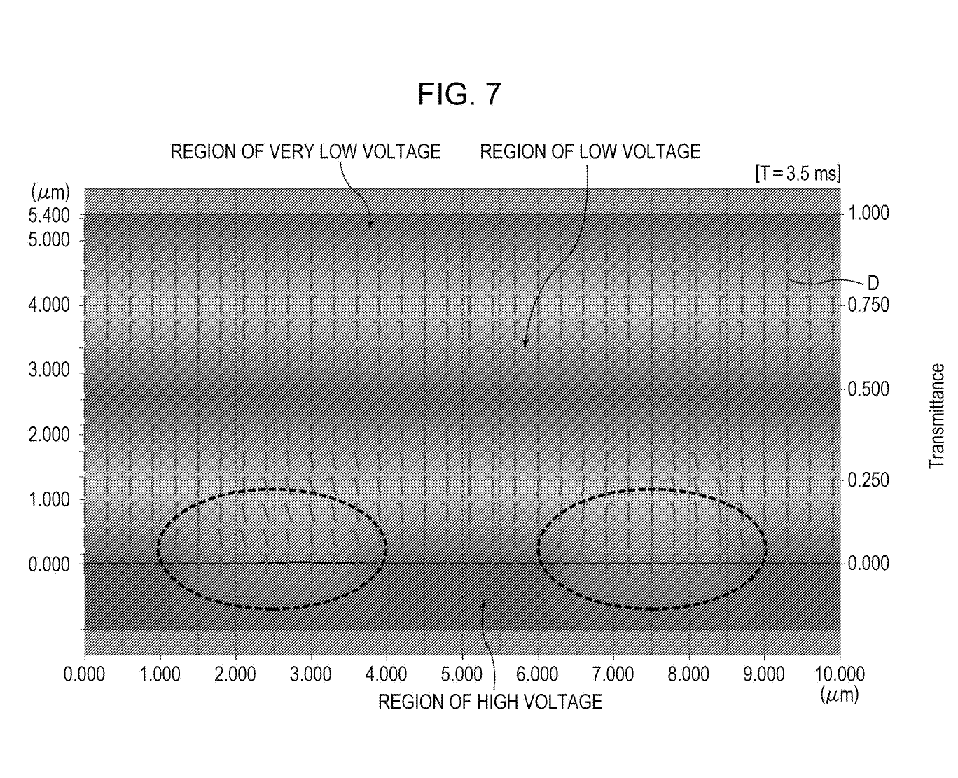

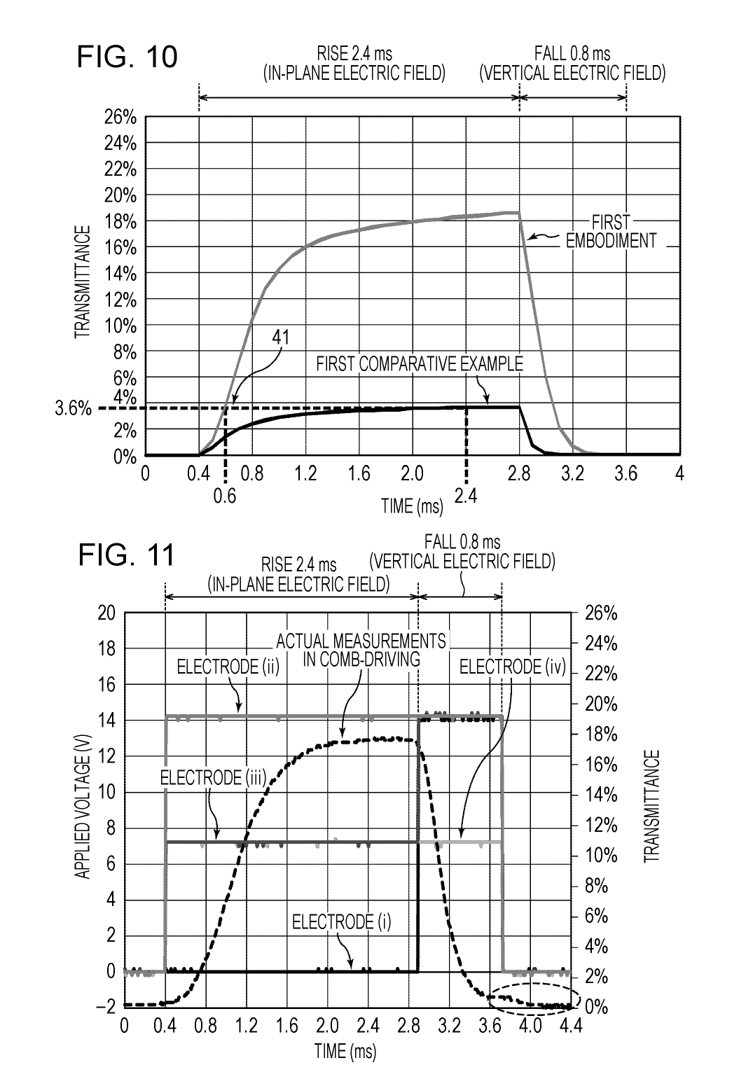

If the in-plane electric field of the comb driving is applied in the liquid crystal display panel of the first preferred embodiment, the liquid crystal molecules are rotated in a wide region between the comb electrodes, and a high transmittance was achieved (the transmittance was 18.6% (see FIG. 10) in simulation results, and the actual measurement transmittance was 17.7% (see FIG. 11 and other drawings)). On the other hand, no sufficient transmittance resulted in a first comparative example to be discussed below (the FFS driving in the related art literature). Note that FIG. 6 is a schematic sectional view of the liquid crystal display panel of the first preferred embodiment during the generation of the vertical electric field. The vertical electric field generated by a potential difference of about 7 V between the substrates (the opposite electrode 13, the comb electrode 17, and the comb electrode 19, each having a potential of about 14 V and the opposite electrode 23 having a potential of about 7 V) rotates the liquid crystal molecules. FIG. 7 illustrates simulation results of the liquid crystal display panel of FIG. 6. FIG. 7 illustrates the simulation results at 3.5 ms after the end point of the fall time (at a time point of 2.8 ms) of directors D, electric fields, and transmittance distribution. In regions enclosed by broken lines, an equipotential plane is not yet horizontal and the liquid crystal molecules are not completely vertical between the comb electrodes.

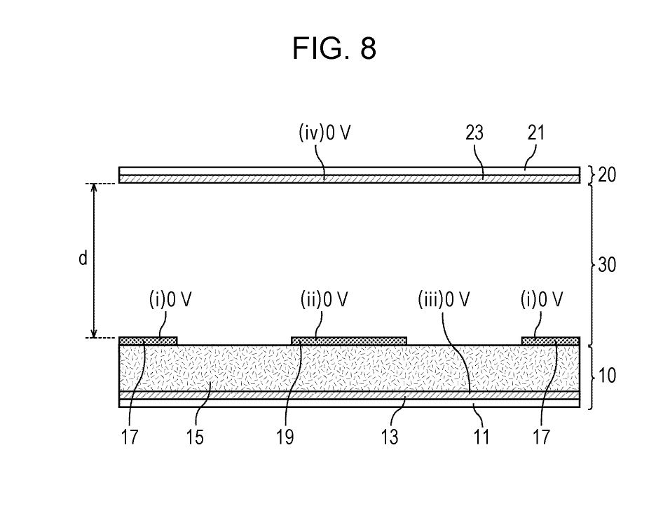

FIG. 8 is a schematic sectional view of the liquid crystal display panel of the first preferred embodiment during an initialization process step subsequent to the generation of the vertical electric field. FIG. 9 illustrates simulation results of the liquid crystal display panel of FIG. 8. All electrodes are set to be equipotential to give a period during which the liquid crystal molecules are sufficiently initialized to an original vertical alignment state. As illustrated in FIG. 8, all the electrodes of the first pair and the second pair are set to about 0 V. The potential of the electrodes is not limited to about 0 V. Instead, it is sufficient if all the electrodes are set to be equipotential (in order not to cause a substantial potential difference).

FIG. 10 is a graph illustrating a comparison of response waveforms through simulation of comb driving and FFS driving. Since no driving is performed for an initial duration of about 0.4 ms, a rise period (an in-plane electric field application period) is about 2.4 ms, and a fall period (a vertical electrical field application period) is about 0.8 ms. The fall period is followed by an alignment initialization period to set all the electrodes to be equipotential. The comb driving (the first preferred embodiment) is now compared with the FFS driving (the first comparative example) to be discussed below. In the simulation condition, the cell thickness was 5.4 μm, and the electrode spacing of the pair of comb electrodes was 2.6 μm.

A response speed is analyzed as below. The transmittance (18.6%) obtained through the comb driving of the first preferred embodiment is higher than the transmittance (3.6%) obtained through the FFS driving of the first comparative example. If a target of a transmittance of 3.6% is set in the comb driving of the first preferred embodiment, a faster response than the FFS driving is achieved using overdrive technique. More specifically, the liquid crystal is set to respond faster by applying a voltage higher than a rated voltage needed to achieve a transmittance of about 3.6% through the comb driving. The voltage applied is decreased to the rated voltage at the timing when the target transmittance is achieved. The response time at the rise is thus shortened. As illustrated in FIG. 10, for example, the applied voltage is lowered to the rated voltage at a 0.6 ms time point 41, thereby shortening the response time at the rise. The response time at the fall from the same transmittance remains the same as at the rise.

FIG. 11 is a graph illustrating a measurement value of a drive response waveform and a rectangular waveform applied to each electrode in the first preferred embodiment. In the same manner as the above-described simulation, an evaluation cell had a cell thickness of 5.4 μm, and an electrode spacing of 2.6 μm between the pair of comb electrodes. The measured temperature was 25° C.

The voltages were applied to the electrodes at the rise and fall as illustrated in FIG. 4 and FIG. 6 so that the in-plane electric field and the vertical electric field were respectively applied to the liquid crystal molecules. More specifically, the rise period corresponded to a comb driving of about 2.4 ms (the first preferred embodiment) between the pair of comb electrodes 17 and 19, and the fall period corresponded to a vertical electric field driving of about 0.8 ms between the pair of comb electrodes 17 and 19 and the opposite electrode 13, and the opposite electrode 23 (see FIG. 11 for an application voltage waveform of each electrode).

The actual measurement results were a maximum transmittance of 17.7% (opposed to a transmittance of 18.6% in simulation) which was higher than in the first comparative example to be discussed below (a transmittance of 3.6% in simulation). A transmittance of 10%-90% (with the maximum transmittance set to 100%) and a response speed of 0.9 ms were obtained at the rise, and a transmittance of 90%-10% (with the maximum transmittance set to 100%) and a response speed of 0.4 ms were obtained at the fall. A high speed performance was thus achieved at the rise and fall.

The inventors have studied and discovered a preferred comb tooth electrode width (L (Line)), comb electrode spacing (S (Space)), and cell width (d) for the vertical electric field application and the in-plane electric field application.

The transmittance increases in proportion to a decrease of the comb tooth electrode width L. However, if the comb tooth electrode width L is set to be too narrow, problems related to device manufacturing, such as, for example, leakage and open connection, arise. The comb tooth electrode width L is preferably about 2 μm or wider.

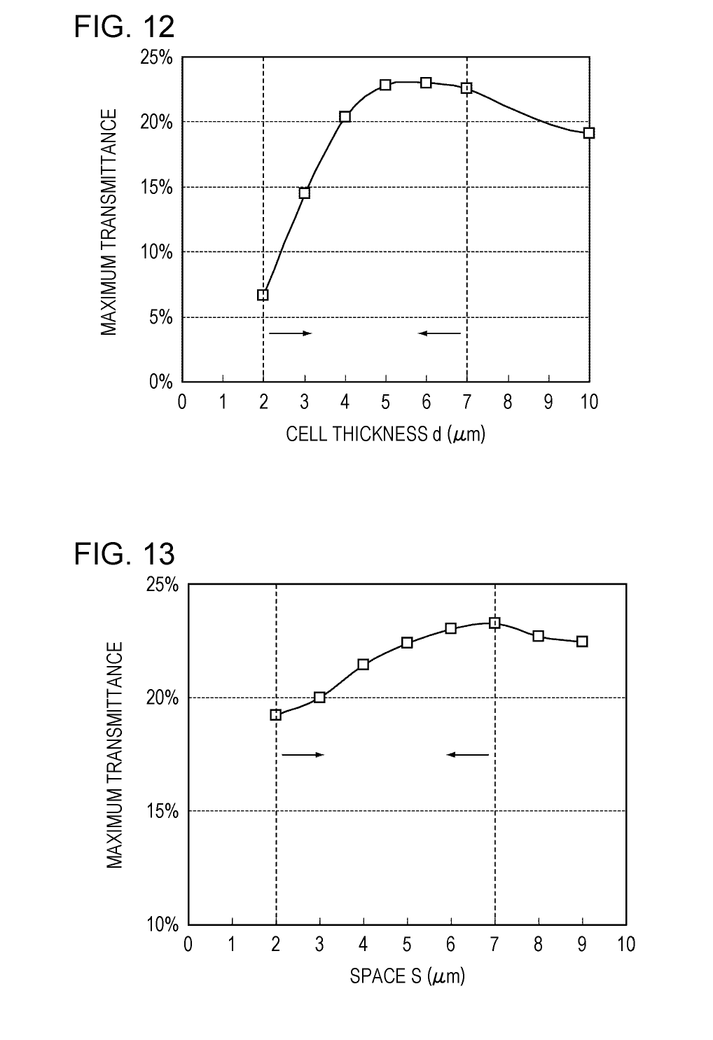

FIG. 12 is a graph illustrating a relationship between a maximum transmittance and a cell thickness d in the first preferred embodiment. FIG. 13 is a graph illustrating a relationship between a maximum transmittance and a space S in the first preferred embodiment. The response speed becomes low as the cell thickness d and the spacing S increases. From the standpoint of the response speed, the smaller the cell thickness d and the spacing S are, the better the response speed is. However, if the cell thickness d and the spacing S are too small, there is a possibility that problems related to device manufacturing, such as leakage and open connection, arise. For this reason, the cell thickness d and the spacing S are desirably about 2 μm or larger. Next, the maximum transmittance was simulated with the cell thickness d and the spacing D varied using LCD MASTER (see FIG. 12, FIG. 13, Table 1 and Table 2). The maximum transmittance increased as both the cell thickness d and the spacing S increased from 2 μm. When the cell thickness d and the spacing S exceeded 7 μm, the maximum transmittance greatly began to decrease. For this reason, the cell thickness d and the spacing S are desirably 7 μm or smaller. Therefore, both the cell thickness d and the spacing S are desirably 2 μm or larger and 7 μm or smaller.

TABLE 1

| Cell thickness (μm) | Maximum transmittance |
|---|---|
| 2 | 6.6% |
| 3 | 14.5% |
| 4 | 20.4% |
| 5 | 22.8% |
| 6 | 23.0% |
| 7 | 22.6% |
| 10 | 19.1% |
| 15 | 19.2% |

TABLE 2

| Space (μm) | Maximum transmittance |
|---|---|
| 2 | 19.2% |
| 3 | 20.0% |
| 4 | 21.4% |
| 5 | 22.4% |
| 6 | 23.0% |
| 7 | 23.3% |
| 8 | 22.7% |
| 9 | 22.5% |

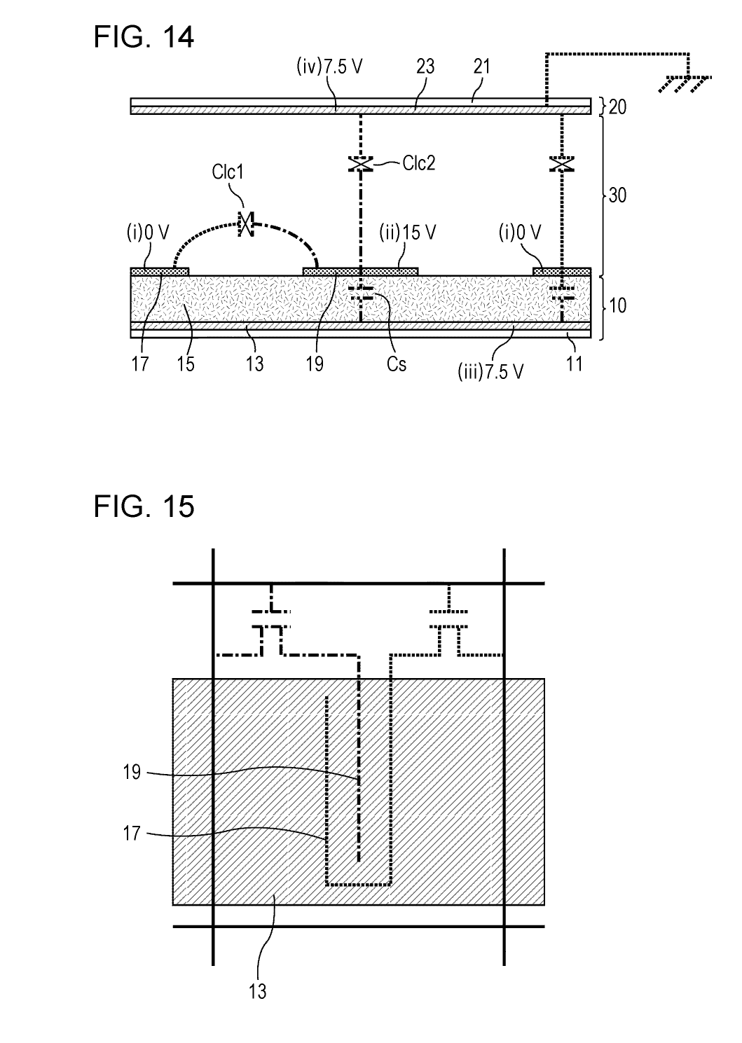

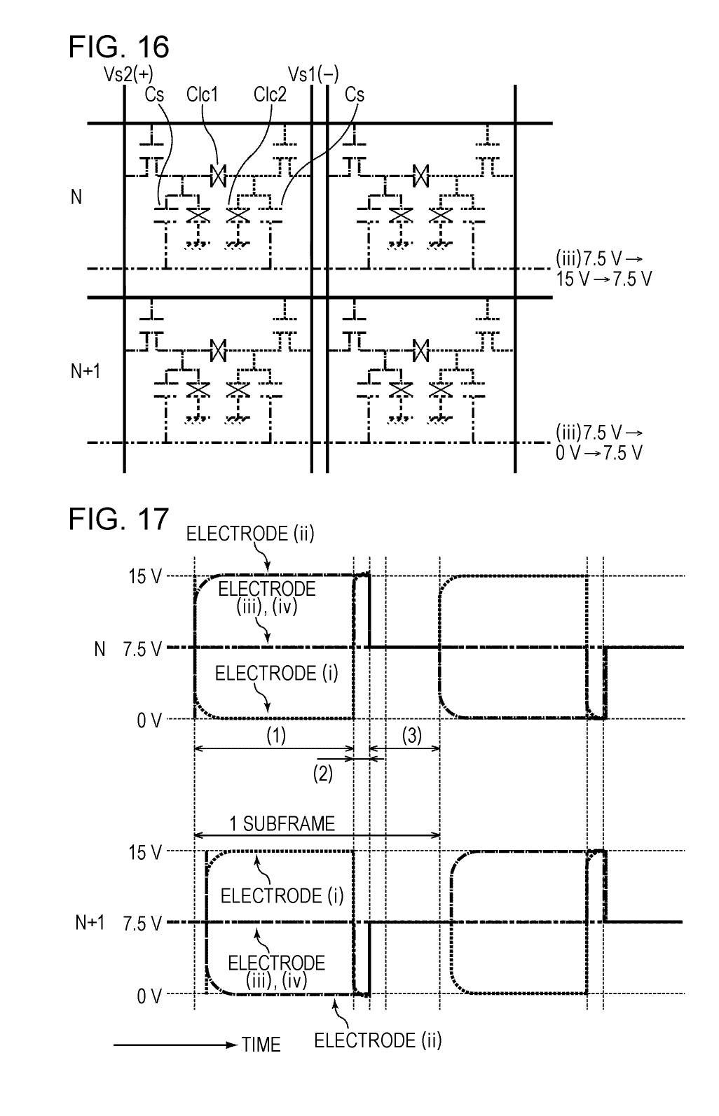

FIG. 14 is a schematic sectional view of the liquid crystal display panel of the first preferred embodiment. FIG. 15 is a plan view of a picture element in the liquid crystal display panel of the first preferred embodiment. FIG. 16 is an equivalent circuit diagram of the picture element in the liquid crystal display panel of the first preferred embodiment. FIG. 17 illustrates a potential change of each electrode in the liquid crystal display panel of the first preferred embodiment. In the driving method of each module of the first preferred embodiment, two TFTs are driven on a per picture element basis. As illustrated in FIG. 14 through FIG. 17, a chain line with two dots denotes a wiring electrically connected to a lower layer electrode on the lower substrate. A chain line with one dot denotes a wiring electrically connected to one comb electrode of the pair of comb electrodes on the lower substrate. A dotted line with narrower intervals denotes a wiring electrically connected to the other comb electrode of the pair of comb electrodes. A broken line with wider intervals denotes a wiring electrically connected to the electrode on the upper substrate. Each of the lower layer electrodes also preferably serves as a Cs electrode, and the lower layer electrodes are commonly connected on a per even-numbered line basis and on an odd-numbered line basis. As illustrated in FIG. 14, Cs denotes a storage capacitor defined by overlapping portions of the comb electrode and the Cs electrode, Clc1 denotes a liquid crystal capacitor arranged between the pair of comb electrodes, and Clc2 denotes a liquid crystal capacitor arranged between the electrodes of the pair of substrates.

In a picture element at an N-th row, a voltage applied to the lower layer electrode (iii) is about 7.5 V during light image displaying, then changes to 15 V during dark displaying (black image displaying), and becomes about 7.5 V in the initialization process step. In a picture element at an (N+1)-th row, a voltage applied to the lower layer electrode (iii) is about 7.5 V during the light image displaying, then changes to about 0 V during dark displaying (black image displaying), and then becomes about 7.5 V in the initialization process step. The N-th row may be an even-numbered line, and the (N+1)-th row may be an odd-numbered line. Alternatively, the N-th row may be an odd-numbered line, and the (N+1)-th row may be an even-numbered line. In the first preferred embodiment, a potential change is inverted by applying a voltage to the lower layer electrodes (iii) connected together on a per even-numbered line basis and on a per odd-numbered line basis. It is illustrated that the potential of the electrode supplied with a constant voltage is set to be about 7.5 V. However, since the potential may also be interpreted as 0 V or substantially 0 V, the N line and the (N+1) line are alternately polarity inverted to be driven.

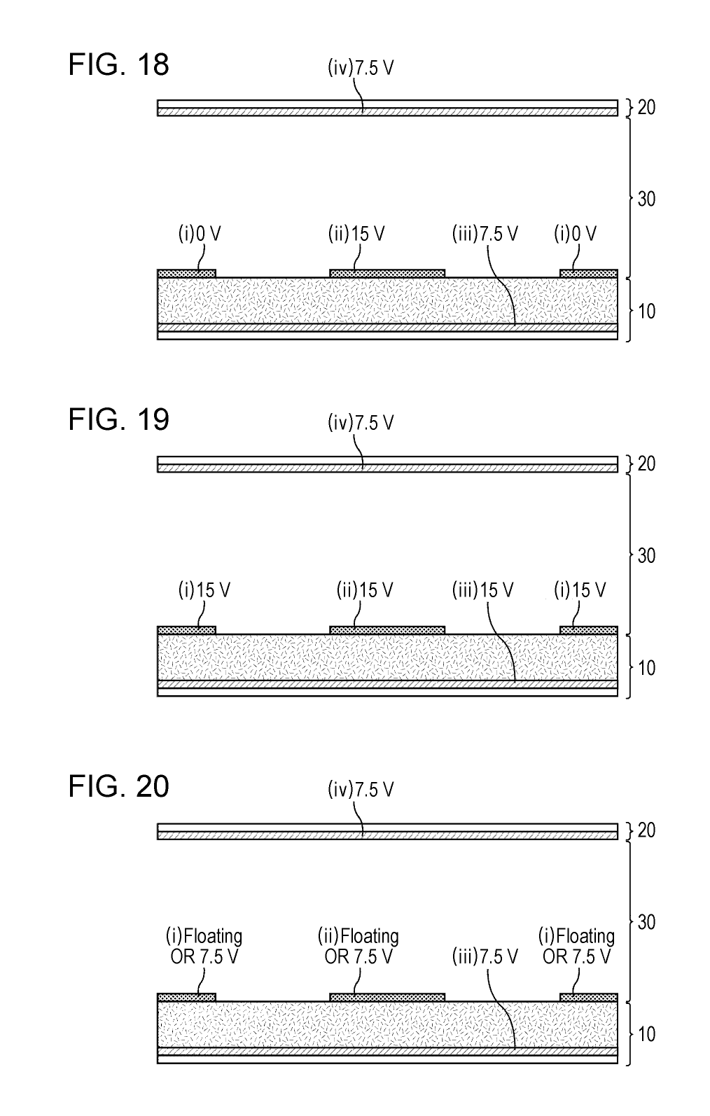

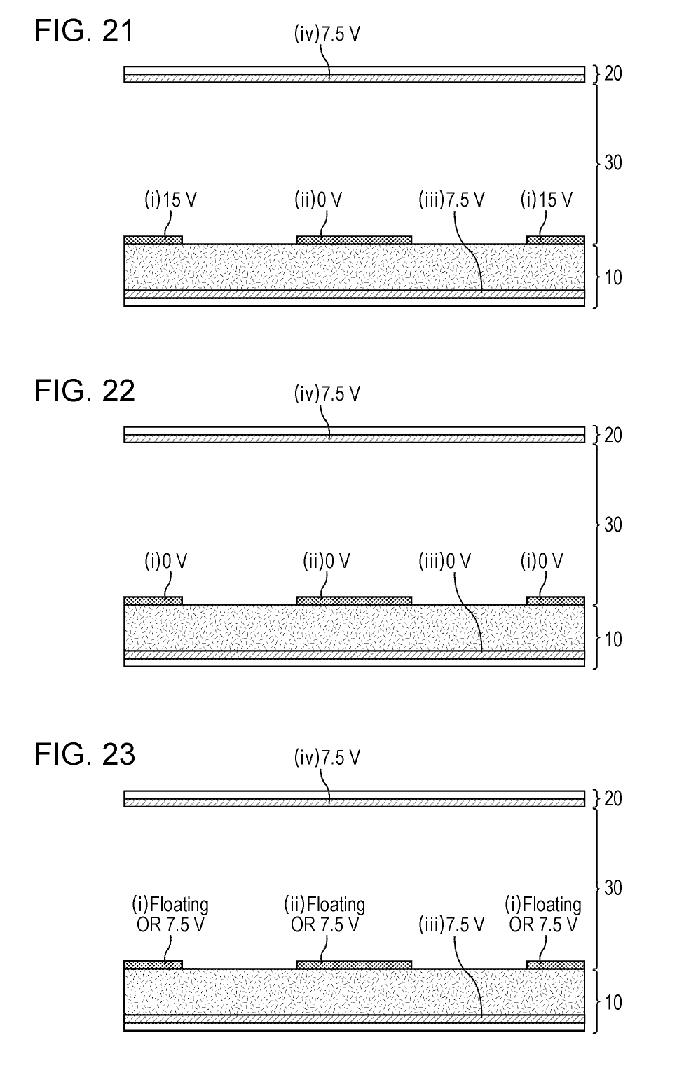

FIG. 18 is a schematic sectional view illustrating each electrode at an N-th row of the liquid crystal display panel of the first preferred embodiment during the generation of the in-plane electric field. FIG. 19 is a schematic sectional view illustrating each electrode at the N-th row of the liquid crystal display panel of the first preferred embodiment during the generation of the vertical electric field. FIG. 20 is a schematic sectional view illustrating each electrode at the N-th row of the liquid crystal display panel of the first preferred embodiment during the initialization process step subsequent to the generation of the vertical electric field. FIG. 21 is a schematic sectional view illustrating each electrode at an (N+1)-th row of the liquid crystal display panel of the first preferred embodiment during the generation of the in-plane electric field. FIG. 22 is a schematic sectional view illustrating each electrode at the (N+1)-th row of the liquid crystal display panel of the first preferred embodiment during the generation of the vertical electric field. FIG. 23 is a schematic sectional view illustrating each electrode at the (N+1)-th row of the liquid crystal display panel of the first preferred embodiment during the initialization process step subsequent to the generation of the vertical electric field.

FIG. 18 and FIG. 21 illustrate the liquid crystal driven by the in-plane electric field between the pair of comb electrodes. In FIG. 19 and FIG. 22, the vertical electric field is applied with both the comb electrodes and the lower layer electrode at about 15 V or about 0 V (TFTs turned on on a per even-numbered line basis and on a per odd-numbered line basis). In FIG. 20 and FIG. 23, each pair of comb electrodes is set to be floating with the TFTs at the N-th row turned off, or each pair of comb electrodes is set to about 7.5 V with all the TFTs turned on so that the liquid crystal is refreshed to the initial alignment (in the initialization process step) with the lower layer electrode set to about 7.5 V.

The liquid crystal display apparatus including the liquid crystal display panel of the first preferred embodiment may include a member (such as, for example, a light source) that a standard liquid crystal display apparatus includes. The same is true of the preferred embodiments described below.

### Second Preferred Embodiment

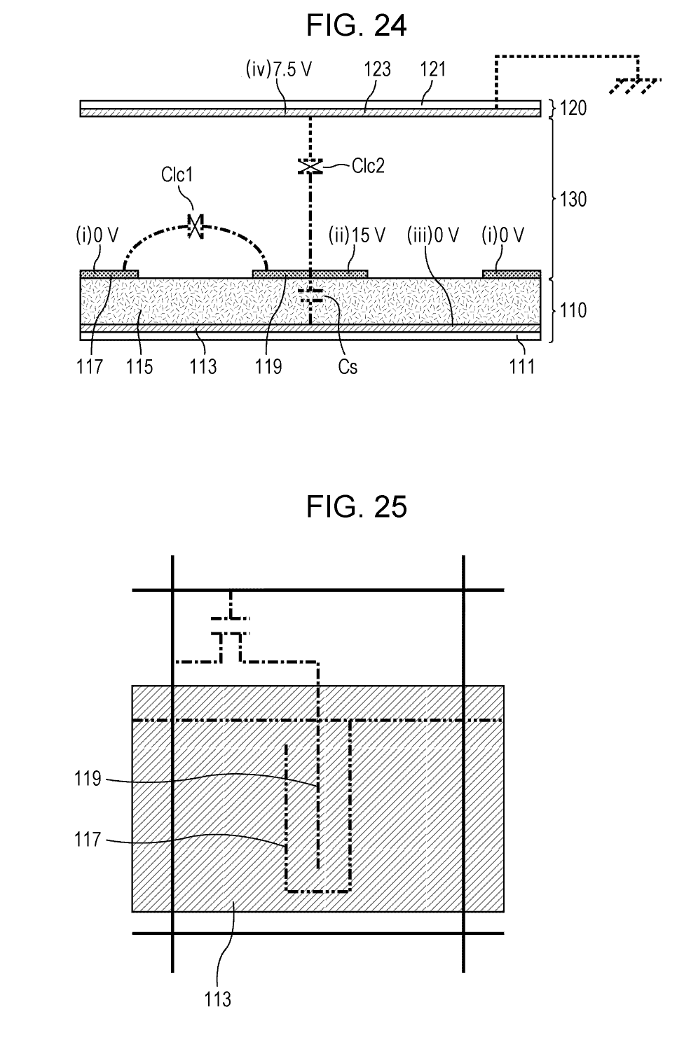

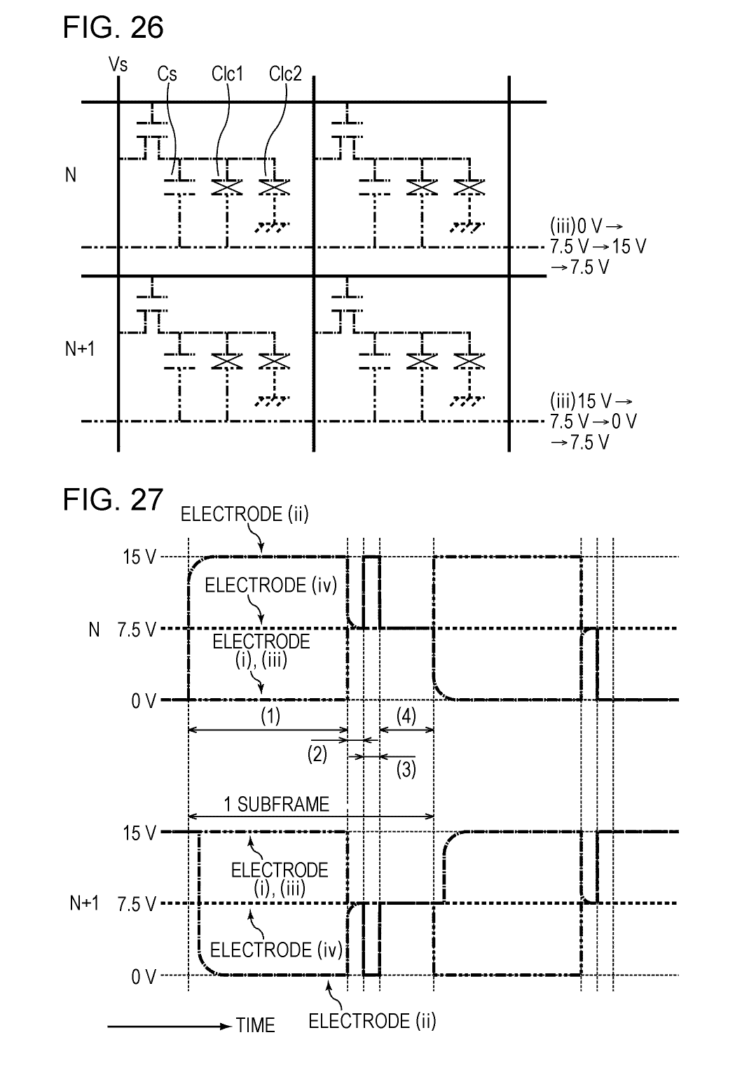

FIG. 24 is a schematic sectional view of the liquid crystal display panel of a second preferred embodiment of the present invention. FIG. 25 is a plan view of a picture element in the liquid crystal display panel of the second preferred embodiment. FIG. 26 is an equivalent circuit diagram of the picture element in the liquid crystal display panel of the second preferred embodiment. FIG. 27 illustrates a potential change of each electrode in the liquid crystal display panel of the second preferred embodiment. In the driving method of each module of the first preferred embodiment, one TFT is driven on a per picture element basis. As illustrated in FIG. 24 through FIG. 27, a chain line with two dots denotes a wiring electrically connected to a lower layer electrode on the lower substrate. A chain line with one dot denotes a wiring electrically connected to one comb electrode of the pair of comb electrodes on the lower substrate. A wiring electrically connected to the other comb electrode of the pair of comb electrodes is denoted by the chain line with two dots because the other comb electrode of the pair of comb electrodes on the lower substrate is electrically connected to the lower layer electrode of the lower substrate. A broken line denotes a wiring electrically connected to the electrode on the upper substrate. Each of the lower layer electrodes also preferably serves as a Cs electrode, and the lower layer electrodes are commonly connected on a per even-numbered line basis and on a per odd-numbered line basis.

In a picture element at an N-th row, a voltage applied to the lower layer electrode (iii) is about 0 V during the light image displaying, and then changes to about 15 V with the vertical electric field applied during the dark displaying (black image displaying) after becoming about 7.5 V in the initialization process step (all TFTs turned on). In the initialization process step subsequent to the vertical electric field application, the voltage applied to the lower electrode (iii) is about 7.5 V. In a picture element at an (N+1)-th row, a voltage applied to the lower layer electrode (iii) is about 7.5 V during the light image displaying, then changes to about 0 V with the vertical electric field applied during the dark displaying (black image displaying) after becoming about 7.5 V in the initialization process step (all TFTs turned on). In the initialization process step subsequent to the vertical electric field application, the voltage applied to the lower electrode (iii) is about 7.5 V. The N-th row may be an even-numbered line, and the (N+1)-th row may be an odd-numbered line. Alternatively, the N-th row may be an odd-numbered line, and the (N+1)-th row may be an even-numbered line. In the second preferred embodiment, a potential change is inverted by applying a voltage to the lower layer electrodes (iii) connected together on a per even-numbered line basis and on a per odd-numbered line basis. It is illustrated that the potential of the electrode supplied with a constant voltage is set to be about 7.5 V. However, since the potential may also be interpreted as 0 V or substantially 0 V, the N line and the (N+1) line are alternately polarity inverted to be driven.

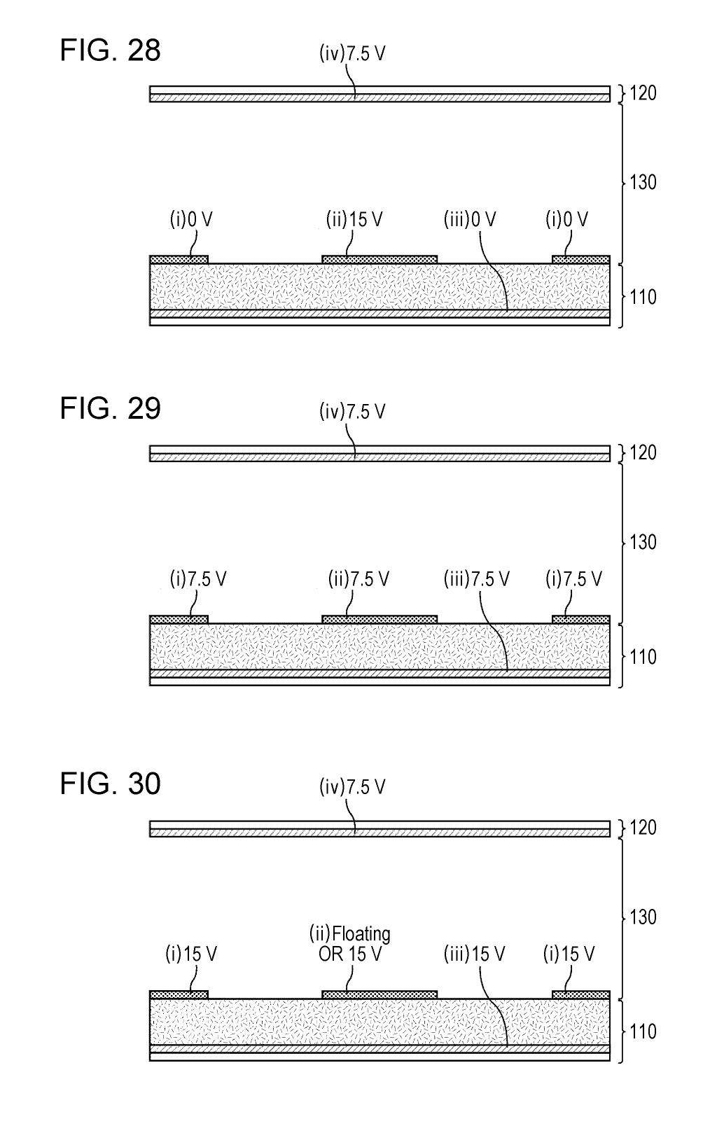

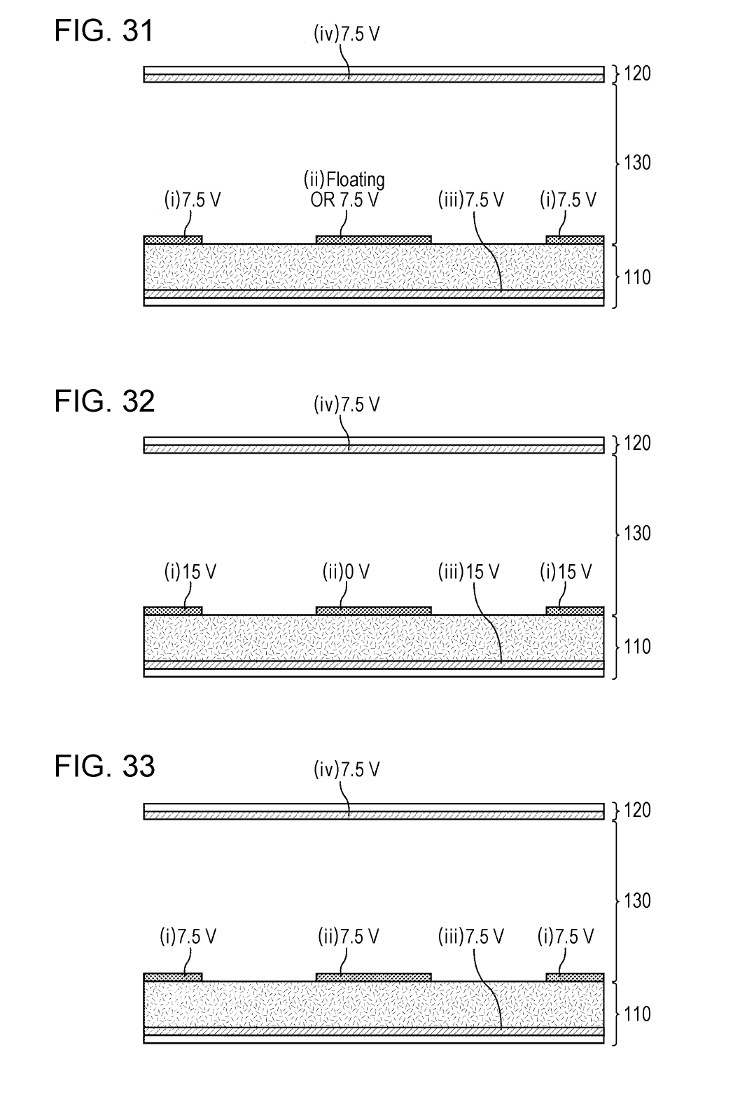

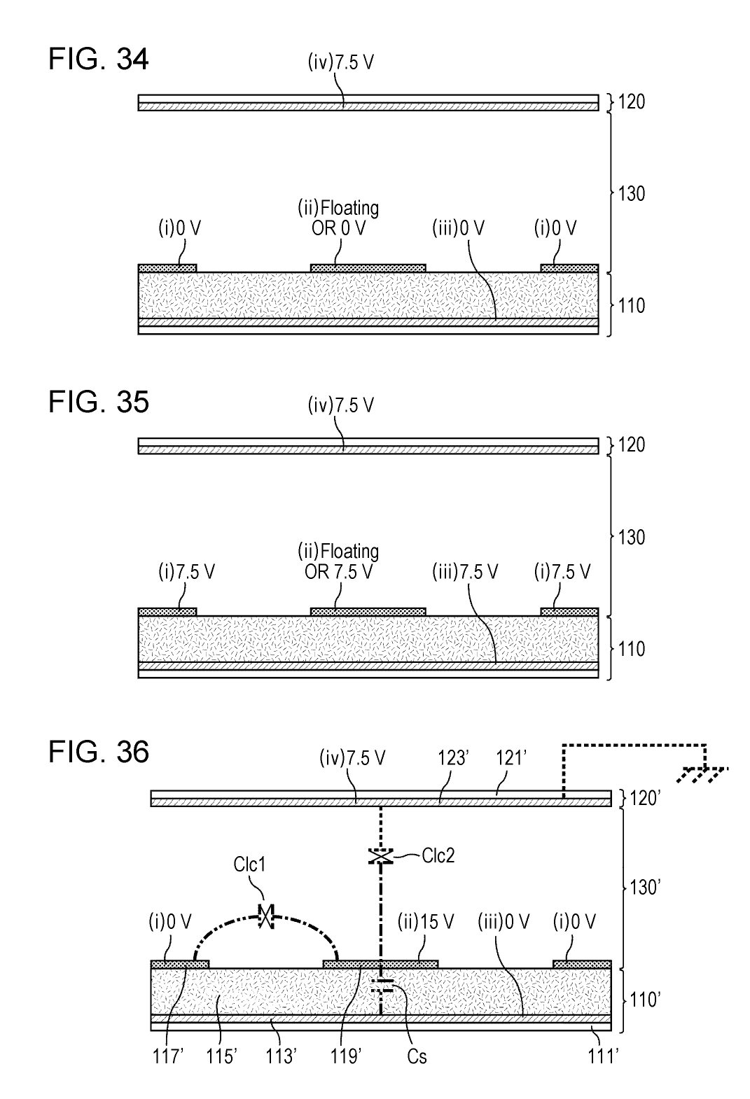

FIG. 28 is a schematic sectional view illustrating each electrode at an N-th row of the liquid crystal display panel of the second preferred embodiment during the generation of an in-plane electric field. FIG. 29 is a schematic sectional view illustrating each electrode at the N-th row of the liquid crystal display panel of the second preferred embodiment during an initialization process step subsequent to the generation of the in-plane electric field. FIG. 30 is a schematic sectional view illustrating each electrode at the N-th row of the liquid crystal display panel of the second preferred embodiment during the generation of a vertical electric field. FIG. 31 is a schematic sectional view illustrating each electrode at the N-th row of the liquid crystal display panel of the second preferred embodiment during the initialization process step subsequent to the generation of the vertical electric field. FIG. 32 is a schematic sectional view illustrating each electrode at an (N+1)-th row of the liquid crystal display panel of the second preferred embodiment during the generation of the in-plane electric field. FIG. 33 is a schematic sectional view illustrating each electrode at the (N+1)-th row of the liquid crystal display panel of the second preferred embodiment during the initialization process step subsequent to the generation of the in-plane electric field. FIG. 34 is a schematic sectional view illustrating each electrode at the (N+1)-th row of the liquid crystal display panel of the second preferred embodiment during the generation of the vertical electric field. FIG. 35 is a schematic sectional view illustrating each electrode at the (N+1)-th row of the liquid crystal display panel of the second preferred embodiment during the initialization process step subsequent to the generation of the vertical electric field.

As illustrated in FIG. 28 and FIG. 32, the liquid crystal is driven by the in-plane electric field between the pair of comb electrodes. As illustrated in FIG. 29 and FIG. 33, all the TFTs are turned on so that all the electrodes are reset to about 7.5 V. As illustrated in FIG. 30 and FIG. 34, the TFT is turned off to set one comb electrode of the pair of comb electrodes to be floating, or all the TFTs are turned on on a per even-numbered line basis and on a per odd-numbered line basis to set one comb electrode of the pair of comb electrodes to about 15 V or about 0 V, and the lower layer electrode is set to about 15 V or about 0 V. The vertical electric field is thus applied. As illustrated in FIG. 31 and FIG. 35, the TFT is turned off to set one comb electrode of the pair of comb electrodes to be floating, or all the TFTs are turned on to set the pair of comb electrodes to about 7.5 V, and the lower layer electrode is set to about 7.5 V. The liquid crystal is thus refreshed to the initial alignment (in the initialization process step). The other reference numerals in the drawings related to the second preferred embodiment result from adding 1 in hundreds place to the corresponding reference numerals in the first preferred embodiment.

### Modification of Second Preferred Embodiment

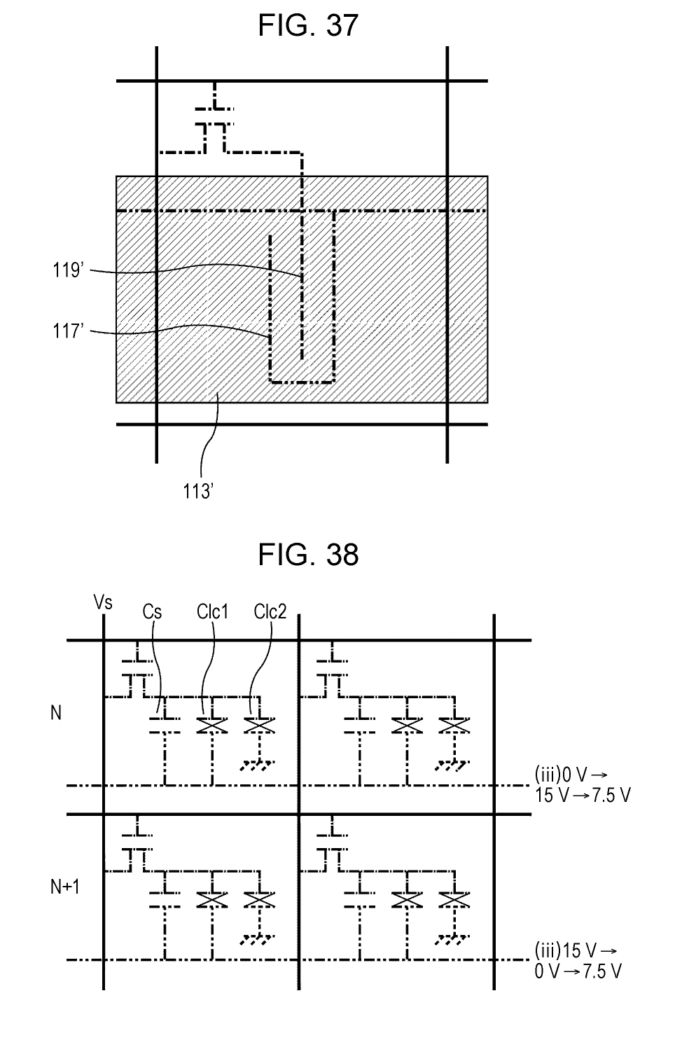

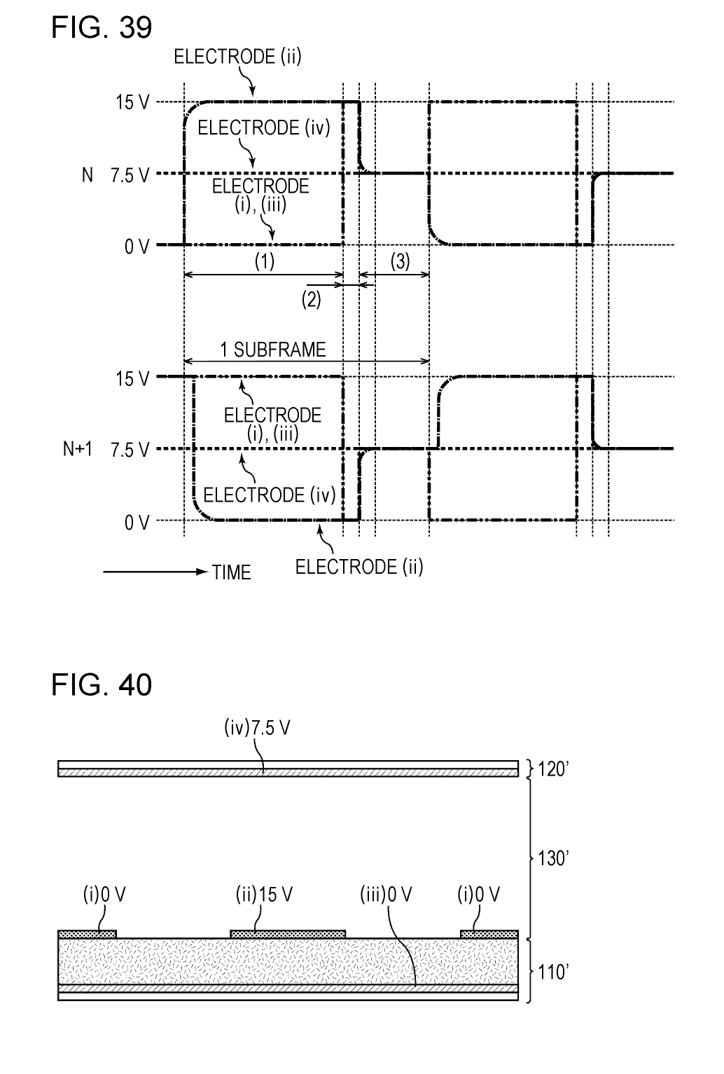

FIG. 36 is a schematic sectional view of the liquid crystal display panel of a modification of the second preferred embodiment of the present invention. FIG. 37 is a plan view of a picture element in the liquid crystal display panel of the modification of the second preferred embodiment. FIG. 38 is an equivalent circuit diagram of the picture element in the liquid crystal display panel of the modification of the second preferred embodiment. FIG. 39 illustrates a potential change of each electrode in the liquid crystal display panel of the modification of the second preferred embodiment. In the driving method of each module of the modification of the second preferred embodiment, one TFT is driven on a per picture element basis. As illustrated in FIG. 36 through FIG. 39, a chain line with two dots denotes a wiring electrically connected to a lower layer electrode on the lower substrate. A chain line with one dot denotes a wiring electrically connected to one comb electrode of the pair of comb electrodes on the lower substrate. A wiring electrically connected to the other comb electrode of the pair of comb electrodes is denoted by the chain line with two dots because the other comb electrode of the pair of comb electrodes on the lower substrate is electrically connected to the lower layer electrode of the lower substrate. A broken line denotes a wiring electrically connected to the electrode on the upper substrate. Each of the lower layer electrodes preferably also serves as a Cs electrode, and the lower layer electrodes are commonly connected on a per even-numbered line basis and on a per odd-numbered line basis. In a picture element at an N-th row, a voltage applied to the lower layer electrode (iii) is about 0 V during the light image displaying, changes to about 15 V with the vertical electric field applied during the dark displaying (black image displaying), and then changes to about 7.5 V in the initialization process step during the dark displaying (black image displaying). In a picture element at an (N+1)-th row, a voltage applied to the lower layer electrode (iii) is 15 V during the light image displaying, changes to about 0 V with the vertical electric field applied during the dark displaying (black image displaying), and then changes to about 7.5 V in the initialization process step during the dark displaying (black image displaying). The N-th row may be an even-numbered line, and the (N+1)-th row may be an odd-numbered line. Alternatively, the N-th row may be an odd-numbered line, and the (N+1)-th row may be an even-numbered line. In the modification of the second preferred embodiment, a potential change is inverted by applying a voltage to the lower layer electrodes (iii) connected together on a per even-numbered line basis and on a per odd-numbered line basis. It is illustrated that the potential of the electrode supplied with a constant voltage is set to be about 7.5 V. However, since the potential may also be interpreted as 0 V or substantially 0 V, the N line and the (N+1) line are alternately polarity inverted to be driven.

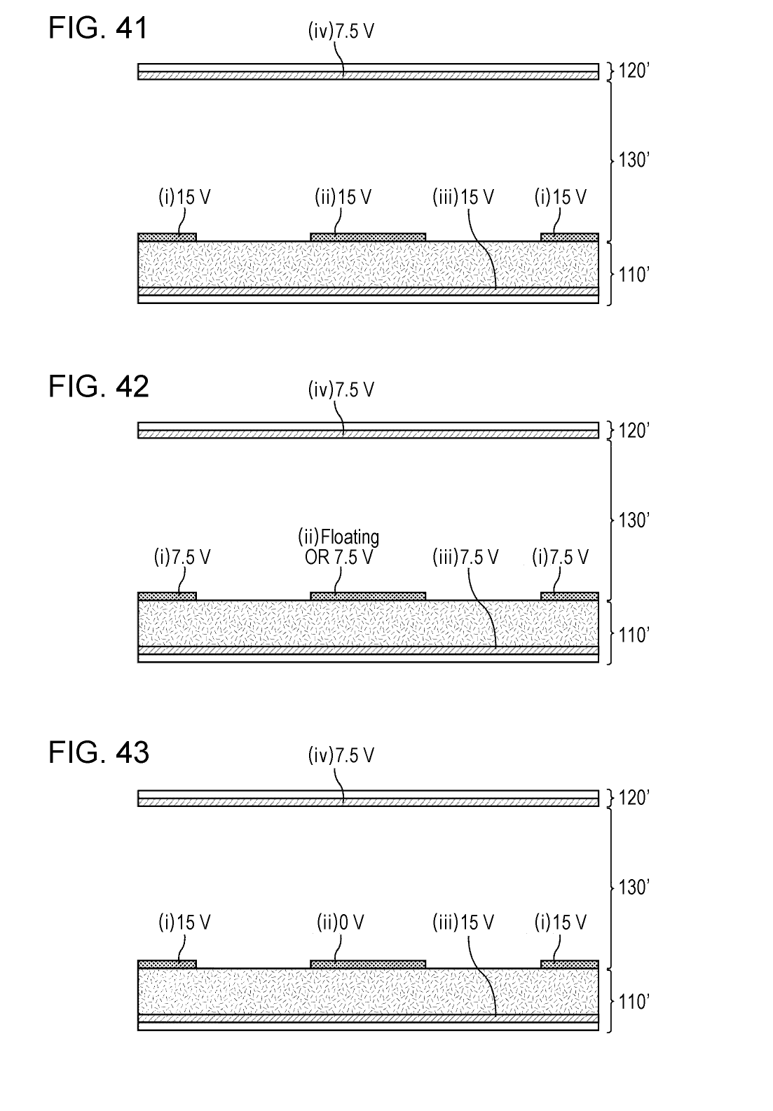

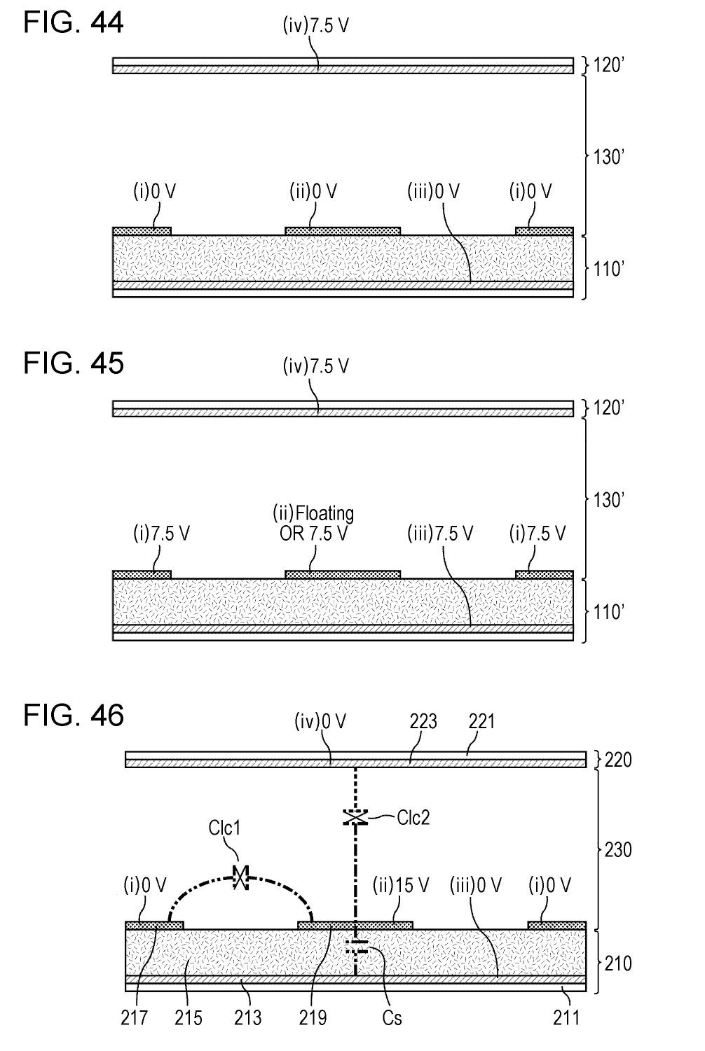

FIG. 40 is a schematic sectional view illustrating each electrode at an N-th row of the liquid crystal display panel of the modification of the second preferred embodiment during the generation of an in-plane electric field. FIG. 41 is a schematic sectional view illustrating each electrode at the N-th row of the liquid crystal display panel of the modification of the second preferred embodiment during the generation of a vertical electric field. FIG. 42 is a schematic sectional view illustrating each electrode at the N-th row of the liquid crystal display panel of the modification of the second preferred embodiment during an initialization process step subsequent to the generation of the vertical electric field. FIG. 43 is a schematic sectional view illustrating each electrode at an (N+1)-th row of the liquid crystal display panel of the modification of the second preferred embodiment during the generation of the in-plane electric field. FIG. 44 is a schematic sectional view illustrating each electrode at the (N+1)-th row of the liquid crystal display panel of the modification of the second preferred embodiment during the generation of the vertical electric field. FIG. 45 is a schematic sectional view illustrating each electrode at the (N+1)-th row of the liquid crystal display panel of the modification of the second preferred embodiment during an initialization process step subsequent to the generation of the vertical electric field.

As illustrated in FIG. 40 and FIG. 43, the liquid crystal is driven by the in-plane electric field between the pair of comb electrodes. As illustrated in FIG. 41 and FIG. 44, the TFTs are turned on on a per even-numbered line basis and on a per odd-numbered line basis so that the vertical electric field is applied with the comb electrodes and the lower layer electrode set to about 15 V or about 0 V. As illustrated in FIG. 42 and FIG. 45, the TFT is turned off to set one comb electrode of the pair of comb electrodes to be floating, or all the TFTs are turned on to set the pair of comb electrodes to about 7.5 V, and the lower layer electrode is set to about 7.5 V. The liquid crystal is thus refreshed to the initial alignment (in the initialization process step). The other reference numerals in the drawings related to the second preferred embodiment result from adding 1 in hundreds place to the corresponding reference numerals and then suffixing the corresponding reference numerals with an apostrophe (′) in the first preferred embodiment.

### Third Preferred Embodiment

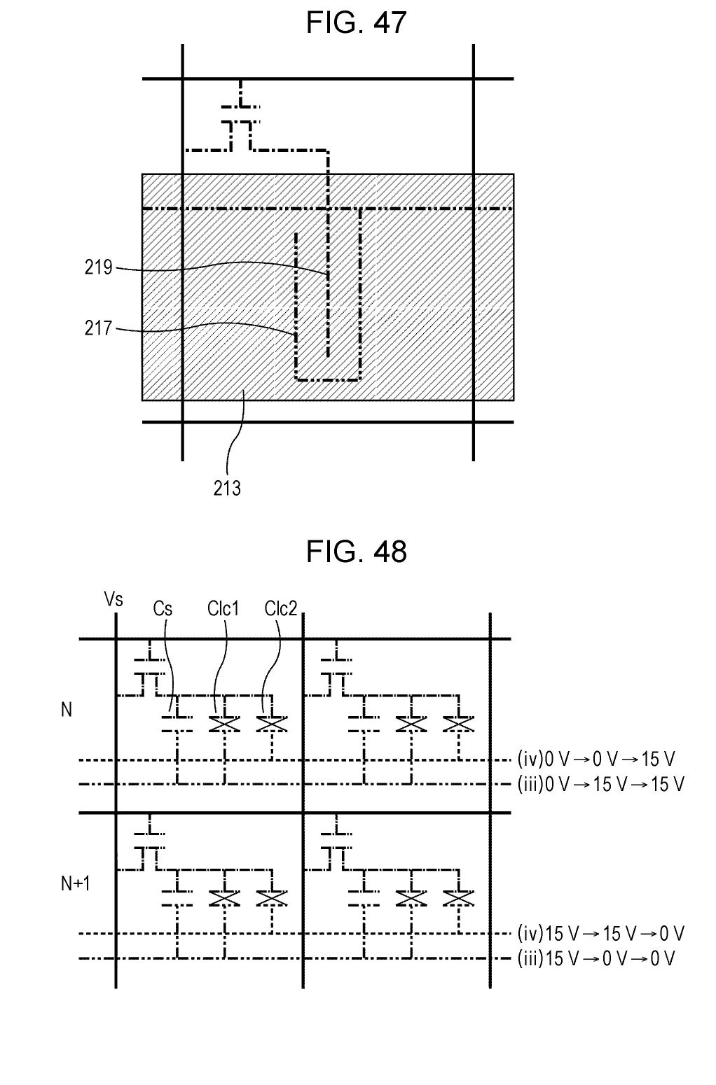

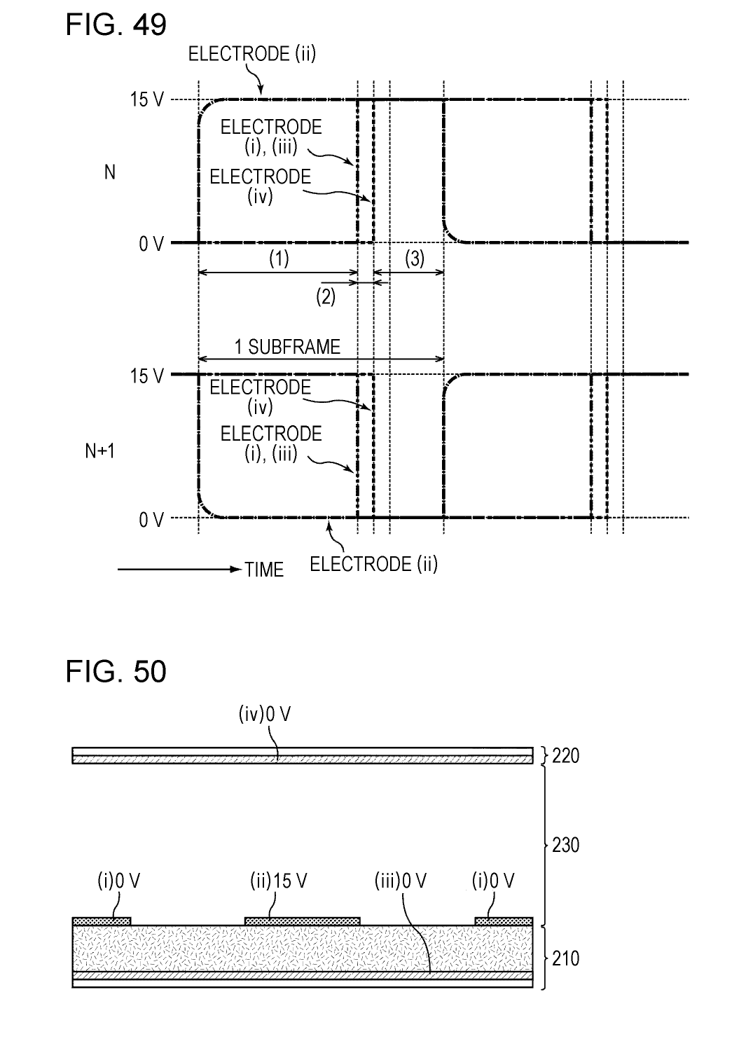

FIG. 46 is a schematic sectional view of the liquid crystal display panel of a third preferred embodiment of the present invention. FIG. 47 is a plan view of a picture element in the liquid crystal display panel of the third preferred embodiment. FIG. 48 is an equivalent circuit diagram of the picture element in the liquid crystal display panel of the third preferred embodiment. FIG. 49 illustrates a potential change of each electrode in the liquid crystal display panel of the third preferred embodiment. In the driving method of each module of the third preferred embodiment, one TFT is driven on a per picture element basis. As illustrated in FIG. 46 through FIG. 49, a chain line with two dots denotes a wiring electrically connected to a lower layer electrode on the lower substrate. A chain line with one dot denotes a wiring electrically connected to one comb electrode of the pair of comb electrodes on the lower substrate. A wiring electrically connected to the other comb electrode of the pair of comb electrodes is denoted by the chain line with two dots because the other comb electrode of the pair of comb electrodes on the lower substrate is electrically connected to the lower layer electrode of the lower substrate. A broken line denotes a wiring electrically connected to the electrode on the upper substrate. Each of the lower layer electrodes also preferably serves as a Cs electrode, and the lower layer electrodes are commonly connected on a per even-numbered line basis and on a per odd-numbered line basis. In the third preferred embodiment, the opposite electrodes on the opposite substrate are connected together on a per even-numbered line basis and on a per odd-numbered line basis.

In a picture element at an N-th row, a voltage applied to the lower layer electrode (iii) is about 0 V during the light image displaying, then changes to about 15 V during the dark displaying (black image displaying) with the vertical electric field applied, and becomes about 15 V in the initialization process step. In a picture element at an (N+1)-th row, a voltage applied to the lower layer electrode (iii) is about 15 V during the light image displaying with the vertical electric field applied, then changes to about 0 V during the dark displaying (black image displaying), and then becomes about 0 V in the initialization process step during the dark displaying (black image displaying). In a picture element at the N-th row, a voltage applied to the opposite electrode (iv) on the side of the opposite substrate is about 0 V during the light image displaying, then remains about 0 V during the dark displaying (black image displaying) with the vertical electric field applied, and then becomes about 15 V in the initialization process step resulting in potential reversal. In a picture element at the (N+1)-th row, a voltage applied to the opposite electrode (iv) on the side of the opposite substrate is about 15 V during the light image displaying, then remains about 15 V during dark displaying (black image displaying) with the vertical electric field applied, and then becomes about 0 V in the initialization process step resulting in potential reversal. The N-th row may be an even-numbered line, and the (N+1)-th row may be an odd-numbered line. Alternatively, the N-th row may be an odd-numbered line, and the (N+1)-th row may be an even-numbered line. A voltage is applied to the lower layer electrodes and the opposite electrodes on the side of the opposite substrate connected together on a per even-numbered line basis and on a per odd-numbered line basis, thereby reversing the potential change.

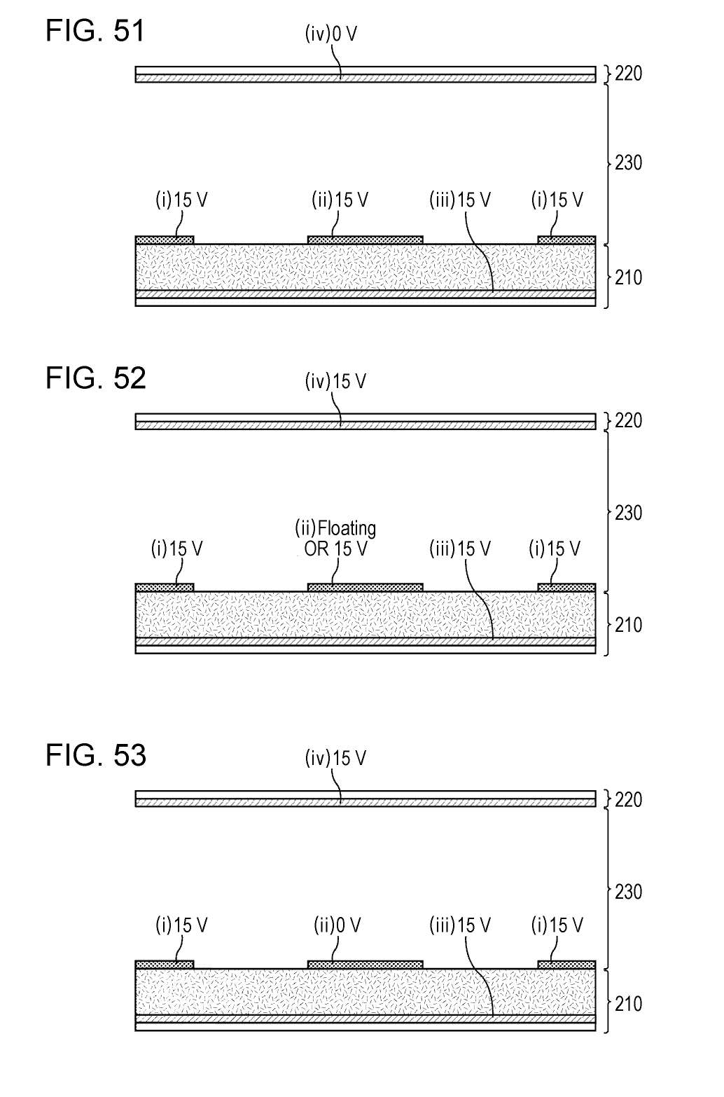

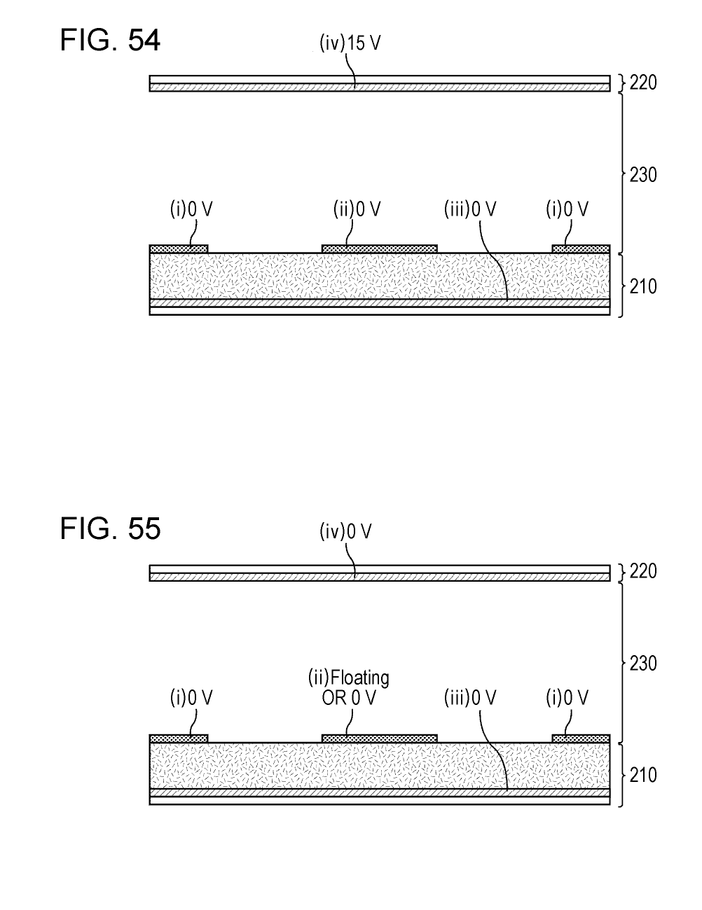

FIG. 50 is a schematic sectional view illustrating each electrode at an N-th row of the liquid crystal display panel of the third preferred embodiment during the generation of an in-plane electric field. FIG. 51 is a schematic sectional view illustrating each electrode at the N-th row of the liquid crystal display panel of the third preferred embodiment during the generation of a vertical electric field. FIG. 52 is a schematic sectional view illustrating each electrode at the N-th row of the liquid crystal display panel of the third preferred embodiment during an initialization process step subsequent to the generation of the vertical electric field. FIG. 53 is a schematic sectional view illustrating each electrode at an (N+1)-th row of the liquid crystal display panel of the third preferred embodiment during the generation of the in-plane electric field. FIG. 54 is a schematic sectional view illustrating each electrode at the (N+1)-th row of the liquid crystal display panel of the third preferred embodiment during the generation of the vertical electric field. FIG. 55 is a schematic sectional view illustrating each electrode at the (N+1)-th row of the liquid crystal display panel of the third preferred embodiment during the initialization process step subsequent to the generation of the vertical electric field.

As illustrated in FIG. 50 and FIG. 53, the liquid crystal is driven by the in-plane electric field between the pair of comb electrodes. As illustrated in FIG. 51 and FIG. 54, the TFTs are turned on on a per even-numbered line basis and on a per odd-numbered line basis to set the comb electrodes and the lower layer electrode together to about 15 V or about 0 V and to set the opposite electrode on the side of the opposite substrate to about 0 V or about 15 V to apply the vertical electric field. As illustrated in FIG. 52 and FIG. 55, the TFT is turned off to set one comb electrode of the pair of comb electrodes to be floating, or the TFTs are turned on a per even-numbered line basis and on a per odd-numbered line basis to set one comb electrode of the comb electrodes to about 15 V or about 0 V. The opposites electrode on the side of the opposite substrate and the lower layer electrode are set about 15 V or about 0 V. The liquid crystal is thus refreshed to the initial alignment (in the initialization process step). The other reference numerals in the drawings related to the third preferred embodiment result from adding 2 in hundreds place to the corresponding reference numerals in the first preferred embodiment. The liquid crystal display panels of the first through third preferred embodiments are easy to manufacture, and provide the fast response and high transmittance. During the black image displaying, the transmittance may be sufficiently lowered in the liquid crystal display panels.

The above-described TFT driving method is preferably performed during a period including a subframe period as a driving period extending until the liquid crystal is reverted back to the initial state. During the subframe period, the TFT driving method includes a driving operation to cause a potential difference between a pair of comb electrodes, a driving operation to cause a potential difference, higher than the potential difference between the pair of comb electrodes, between the opposite electrodes, and a driving operation to cause substantially no potential difference between all the electrodes of the pair of comb electrodes and the pair of opposite electrodes. In the preferred embodiment, the driving operation to cause no or substantially no potential difference between all the electrodes of the pair of comb electrodes and the pair of opposite electrodes subsequent to the driving operation to cause the potential difference, higher than the potential difference between the pair of comb electrodes, between the opposite electrodes. The alignment of the liquid crystal molecules is thus appropriately controlled, and the transmittance is sufficiently lowered during the black image displaying.

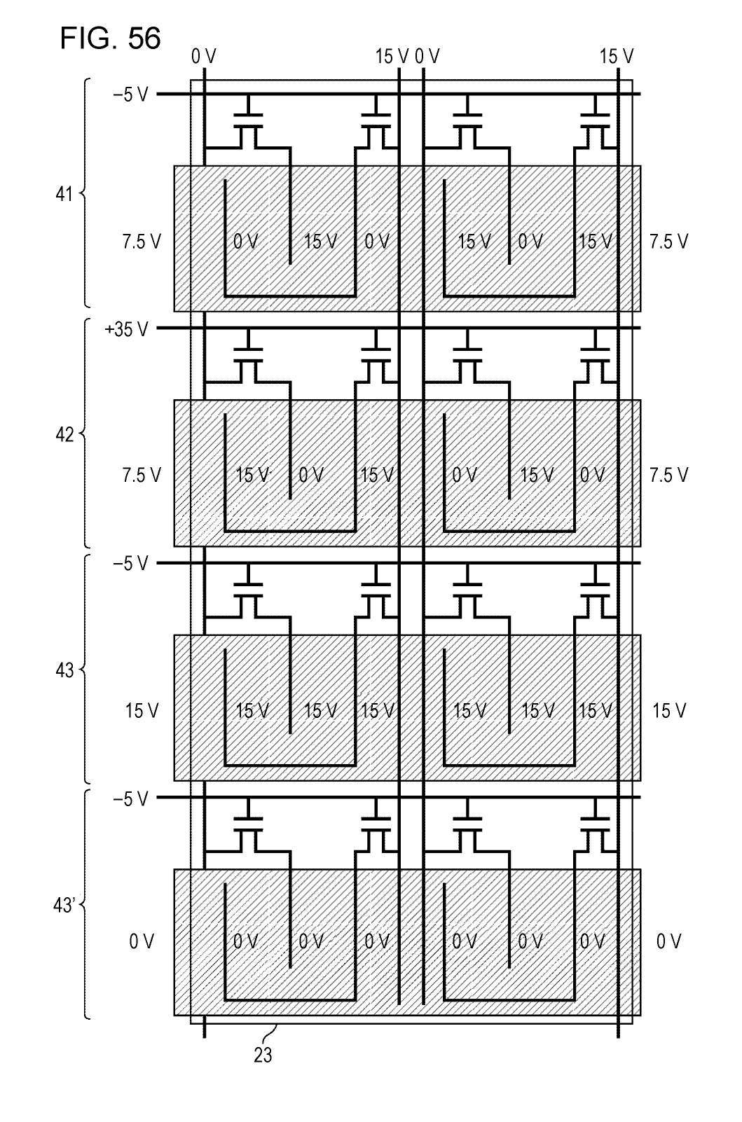

FIG. 56 is a schematic plan view illustrating a driving method of a preferred embodiment of the present invention. FIG. 56 illustrates a white image that is being written in the liquid crystal display panel. The voltages applied to the vertical lines connected to the sources of the TFTs are alternately inverted to write a white image. To write a black image, the voltages applied to the sources of the TFTs are not alternately inverted. As illustrated in FIG. 56, the gate bus lines are also alternately supplied with different voltages (two values of about +35 V and about −5 V). The lower layer electrodes are also alternately supplied with different voltages (three values of about 7.5 V, about 15 V, and about 0 V). As illustrated in FIG. 56, a white image (intermediate tone of gradation) has been written on pixels along the top bus line, and a white displaying is thus maintained (image maintained 41). The lower layer electrode is continuously supplied with about 7.5 V. The gate bus line is at a voltage of about 35 V on the pixels along a second bus line from the top, and a white image (intermediate tone of gradation) has been written (image written 42). The lower layer electrode is also supplied with about 7.5 V. A black image is written and maintained on the pixels along a third bus line from the top (black image maintained 43). The lower layer electrode is supplied with 15 V. A black image has been written and maintained on the pixels along a fourth bus line from the top (black image maintained 43′). The lower layer electrode is supplied with 0 V. The opposite electrodes 23 always remains at 7.5 V.

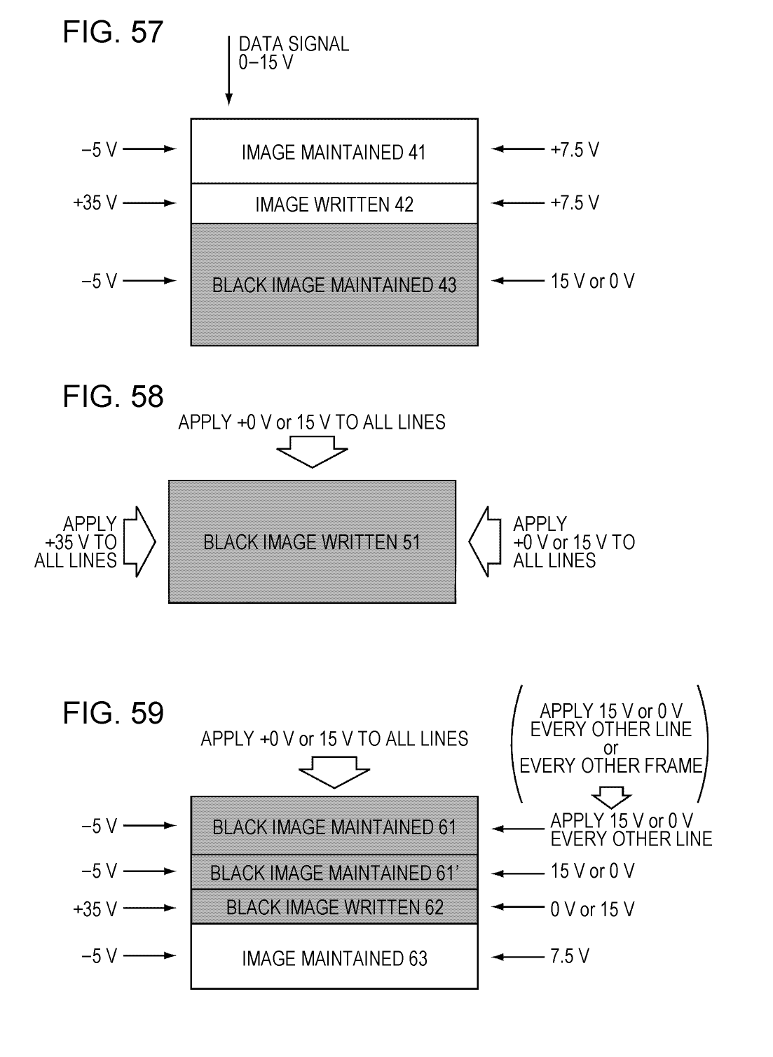

FIG. 57 is a schematic plan view illustrating a driving operation of the liquid crystal display panel of the present invention. FIG. 58 is a schematic plan view illustrating the driving operation of the liquid crystal display panel of the present invention. FIG. 59 is a schematic plan view illustrating the driving operation of the liquid crystal display panel of the present invention.

FIG. 57 illustrates a concept of the whole display panel on which the image writing of FIG. 56 is performed. In the image maintained 41, a data signal is applied and maintained. In the image written 42, the gate bus line is supplied with about 35 V, the lower layer electrode is supplied with about 7.5 V, and the data signal is applied. In the black image maintained 43, the image writing is not yet performed.

FIG. 58 and FIG. 59 illustrate concepts of the whole display panel on which the black image writing is performed. As illustrated in FIG. 58, a black image is written on the lines without voltage alternating. In this way, a write speed becomes higher. As illustrated in FIG. 59, the alternating application of voltage is performed as the image writing, and thus a black image is written. The lower layer electrodes may be alternately supplied with about 15 V and about 0 V on a line-by-line basis or on a frame-by-frame basis.

The electrode structure of the TFT substrate and the opposite substrate in the liquid crystal display panel and the liquid crystal display apparatus of the present invention is preferably checked through, for example, a microscopic observation using an SEM (Scanning Electrode Microscope) or the like.

### First Comparative Example

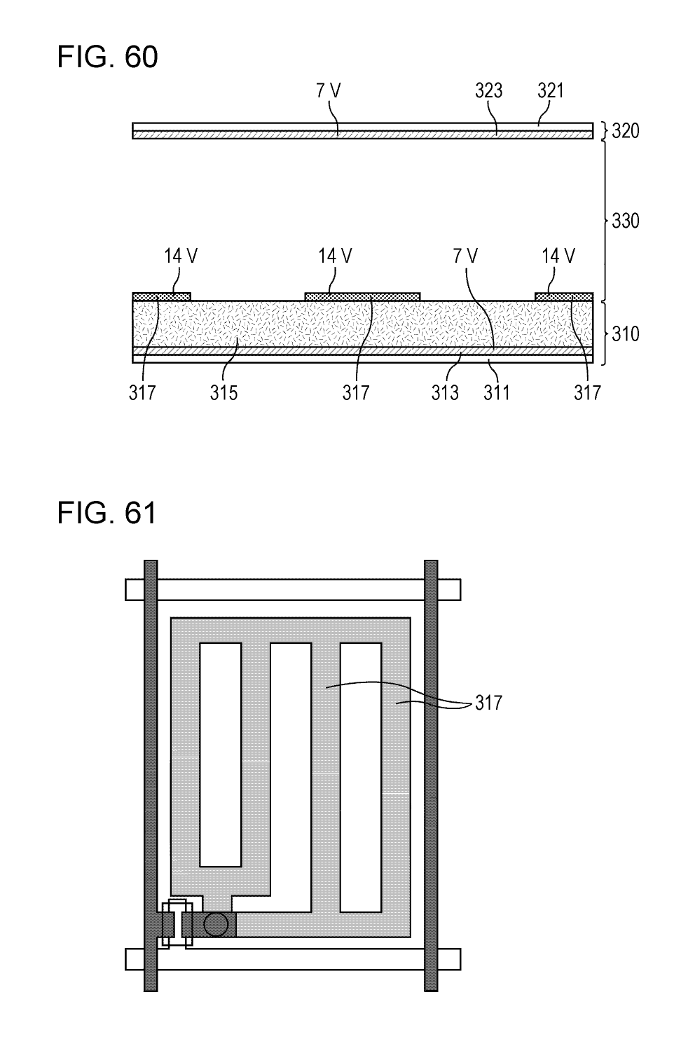

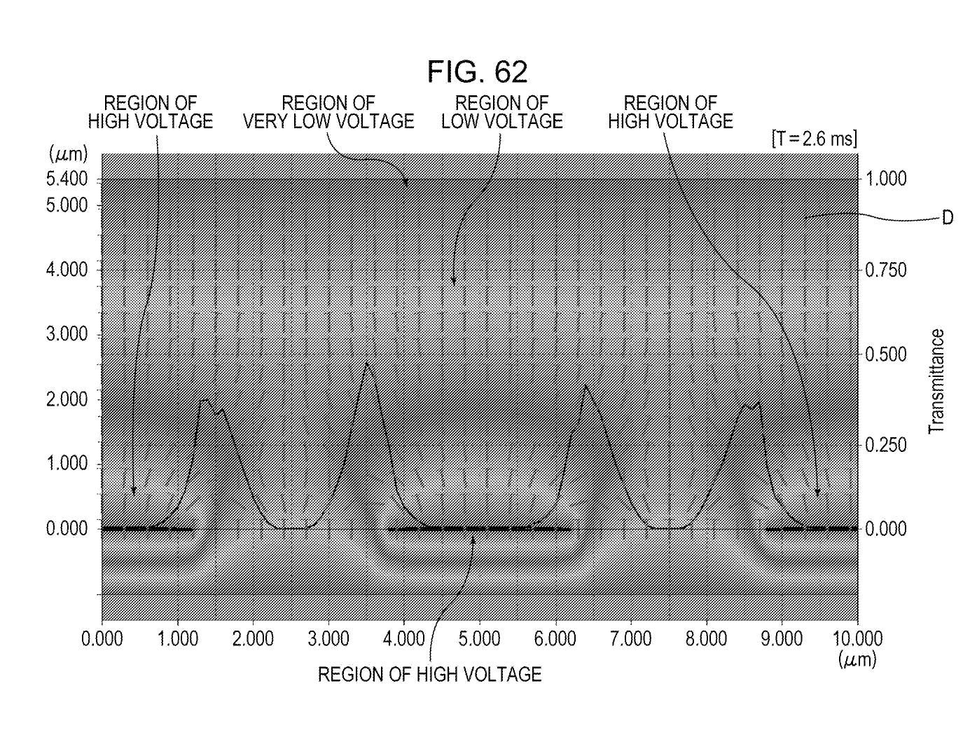

FIG. 60 is a schematic sectional view illustrating a liquid crystal display panel of a first comparative example during the generation of a fringe electric field. FIG. 61 is a schematic plan view illustrating the liquid crystal display panel of the first comparative example. FIG. 62 illustrates simulation results of the liquid crystal display panel of FIG. 60. The liquid crystal display panel of the first comparative example generates the fringe electric field through the FFS driving in the same way as in Japanese Unexamined Patent Application Publication No. 2006-523850. FIG. 62 illustrates simulation results of a director, electric field, and transmittance distribution (a cell thickness of 5.4 μm and a comb tooth spacing of 2.6 μm). The reference numerals of the first comparative example of FIG. 60 result from adding 3 in hundreds place to the corresponding reference numerals in the first preferred embodiment.

As illustrated, a slit electrode 317 is set to 14 V, and a planar opposite electrode 323 is set to 7 V. Alternatively, for example, the slit electrode 317 is set to 5 V, and the planar opposite electrode 323 is set to 0 V. In the display of the FFS driving of Japanese Unexamined Patent Application Publication No. 2006-523850 (in which a slit electrode is used instead of the pair of comb electrodes), liquid crystal molecules are rotated using the fringe electric field generated between an upper layer electrode and a lower layer electrode on the lower substrate. Since only the liquid crystal molecules in the vicinity of the slit electrode rotate, the transmittance in simulation was as low as 3.6%. Increasing the transmittance to a level described with reference to the preferred embodiment was difficult (see FIG. 62).

### Second Comparative Example

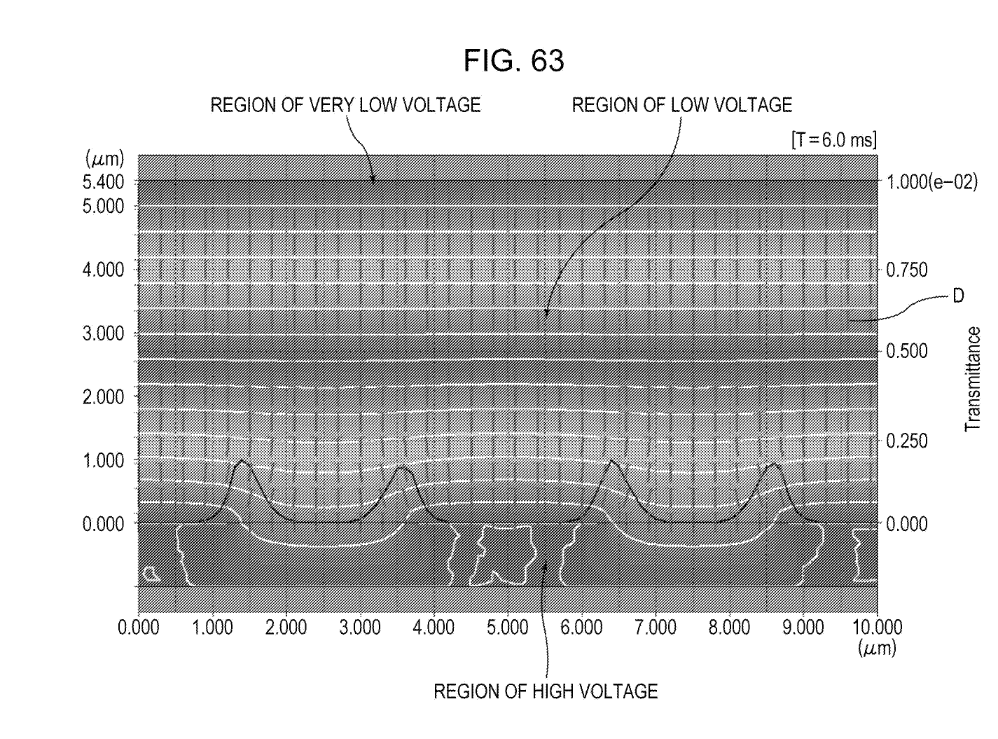

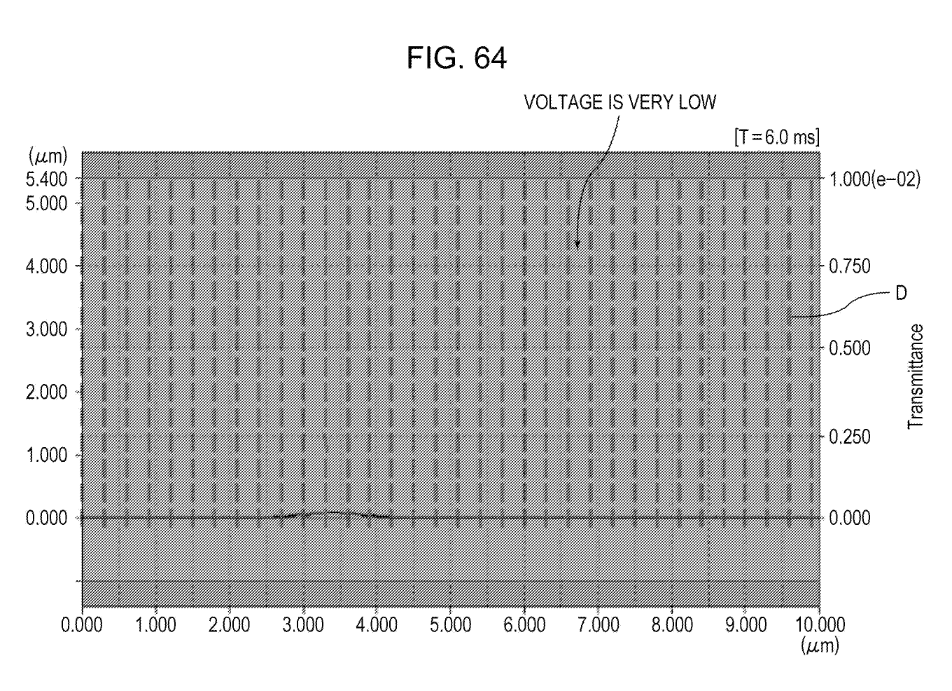

In a second comparative example, a simulation was performed to study a state of transmittance raised during the black image displaying with the initialization process step of the present invention not performed. FIG. 63 illustrates simulation results of the liquid crystal display panel obtained when the vertical electric field is continuously applied with no initialization process step performed. If the vertical electric field is continuously applied with no initialization process step performed, molecules in the vicinity of the comb electrodes persistently remain unaligned with the vertical direction, causing the transmittance to be raised. The transmittance was then 0.02%, and a contrast ratio between the light image displaying and the dark displaying was 861. FIG. 64 illustrates simulation results of the liquid crystal display panel with the initialization process step performed. With the initialization process step performed, molecules in the vicinity of the comb electrodes revert back to an initial vertical alignment, causing the transmittance to be sufficiently lowered. The transmittance was then 0.01%, and a contrast ratio between the light image displaying and the dark displaying was 2020.

### Third Comparative Example

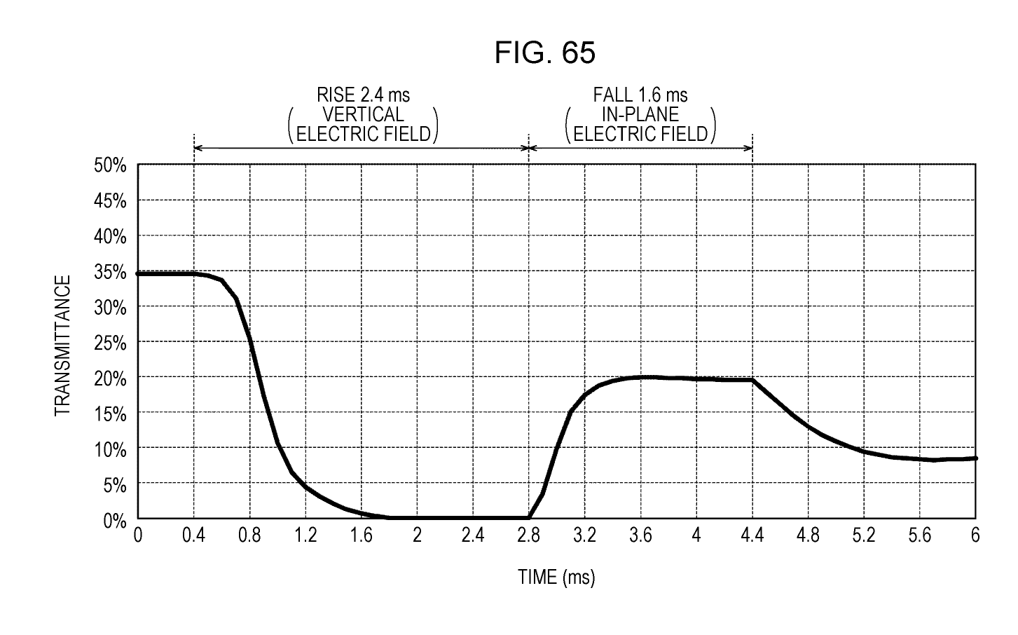

FIG. 65 is a graph illustrating a response waveform obtained through simulation of comb driving in a TN mode of a third comparative example. Since no driving is performed for an initial duration of 0.4 ms, a rise period (a vertical electric field period) is 2.4 ms, and a fall period (an in-plane electric field) is 1.6 ms.

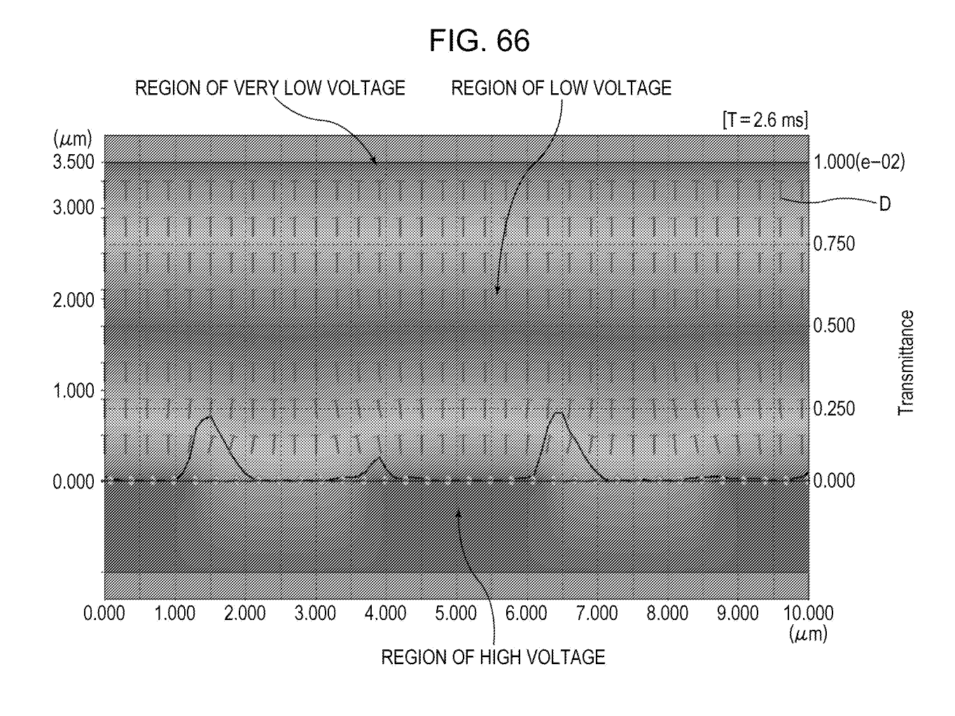

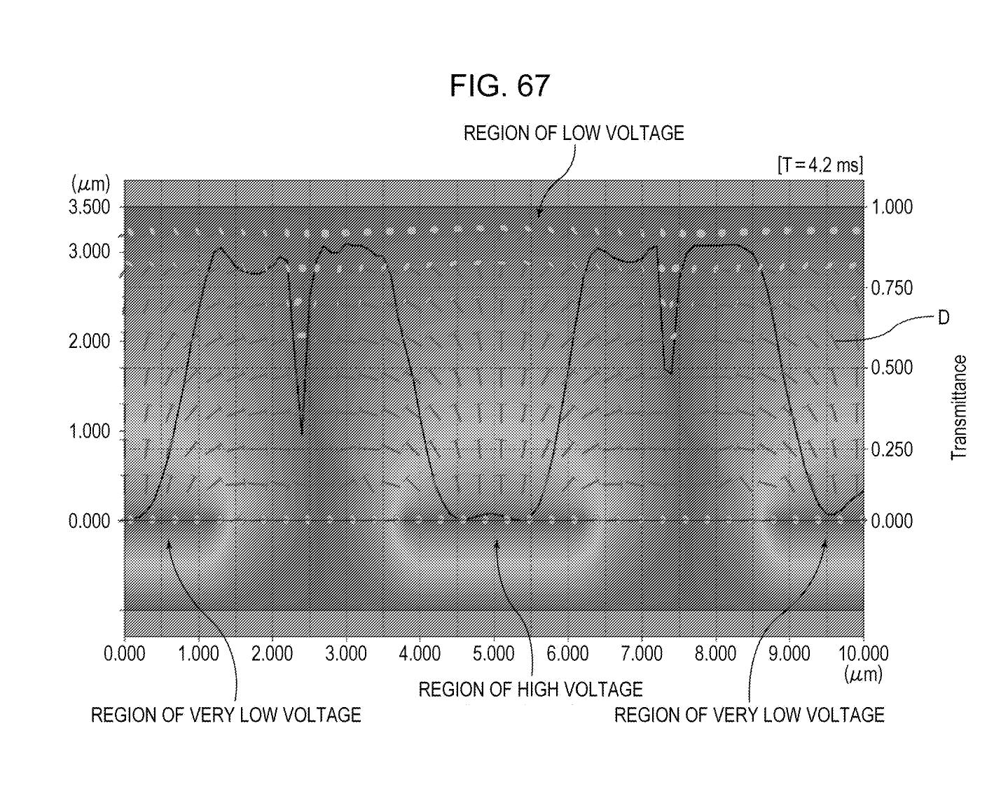

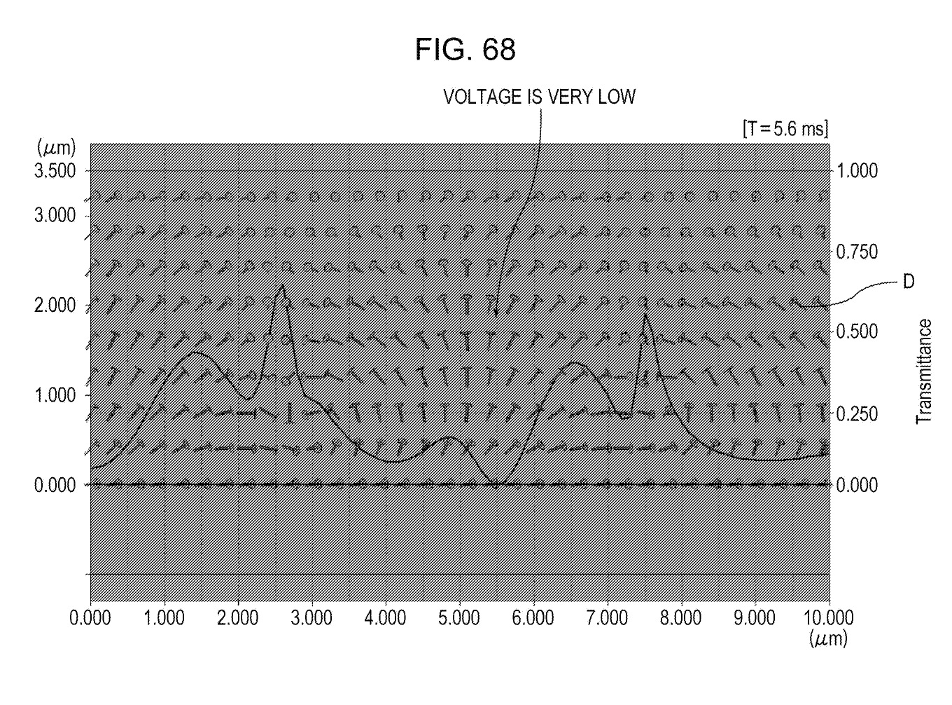

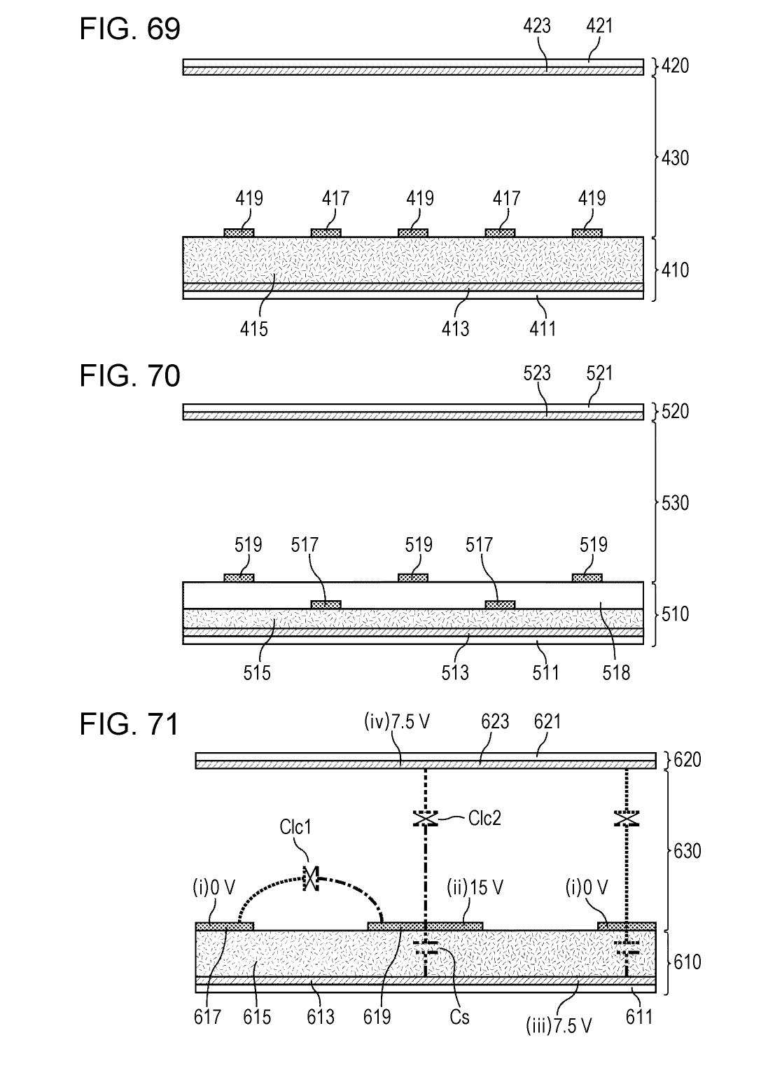

FIG. 66 through FIG. 68 illustrates simulation results of the liquid crystal display panel of the third comparative example. More specifically, FIG. 66 illustrates the simulation results of the director D, the electric field, and the transmittance distribution at a time point of 2.6 ms. FIG. 67 illustrates the simulation results of the director D, the electric field, and the transmittance distribution at a time point of 4.2 ms. FIG. 68 illustrates the simulation results of the director D, the electric field, and the transmittance distribution at a time point of 5.6 ms. As illustrated in FIG. 65, no driving is performed for the initial duration of 0.4 ms. A plot of a solid line denotes the transmittance. The director D denotes an alignment direction of the long axis of the liquid crystal molecules. In the third comparative example, the comb electrode and TN mode described in Japanese Unexamined Patent Application Publication No. 2002-365657 were used. A simulation performed using LCD MASTER 2D revealed that the third comparative example failed to provide the effect of fast response. The simulation condition was a cell thickness of 5.4 μm and a comb tooth spacing of 2.6 μm. As illustrated in FIG. 66, the liquid crystal molecules respond vertically to the vertical electric field at the time point of 2.6 ms. Although liquid crystal molecules between comb electrodes are horizontally aligned in response to the in-plane electric field at the time point of 4.2 ms as illustrated in FIG. 67, liquid crystal molecules above comb electrode do not respond and thus remain vertically aligned by the vertical electric field between the lower substrate and the upper substrate. Since the alignment of the liquid crystal molecules is disturbed by the in-plane electric field, the liquid crystal molecules will not be aligned to the initial alignment at time point of 5.6 ms even if the initialization process step is performed as illustrated in FIG. 68. The results of the third comparative example revealed that the use of the comb electrode and TN mode described in Japanese Unexamined Patent Application Publication No. 2002-365657 fails to achieve the effect of the fast response.

In preferred embodiments of the present invention, the opposite substrates on the opposite substrate are commonly connected and set to only about 7.5 V during driving. In the following preferred embodiment, the voltage applied to the opposite electrode is changed to about 0 V (or about 15 V) during the vertical electric field application (2 TFT driving and 1 TFT driving are described). In another preferred embodiment of the present invention, a dielectric layer (also referred to as, for example, an overcoat layer or an OC layer) is arranged on the opposite substrate to increase the transmittance. The liquid crystal display panel of the preferred embodiments to be discussed below is also easy to manufacture, and achieves the fast response and high transmittance, and a sufficiently low transmittance during the black image displaying.

### Fourth Preferred Embodiment

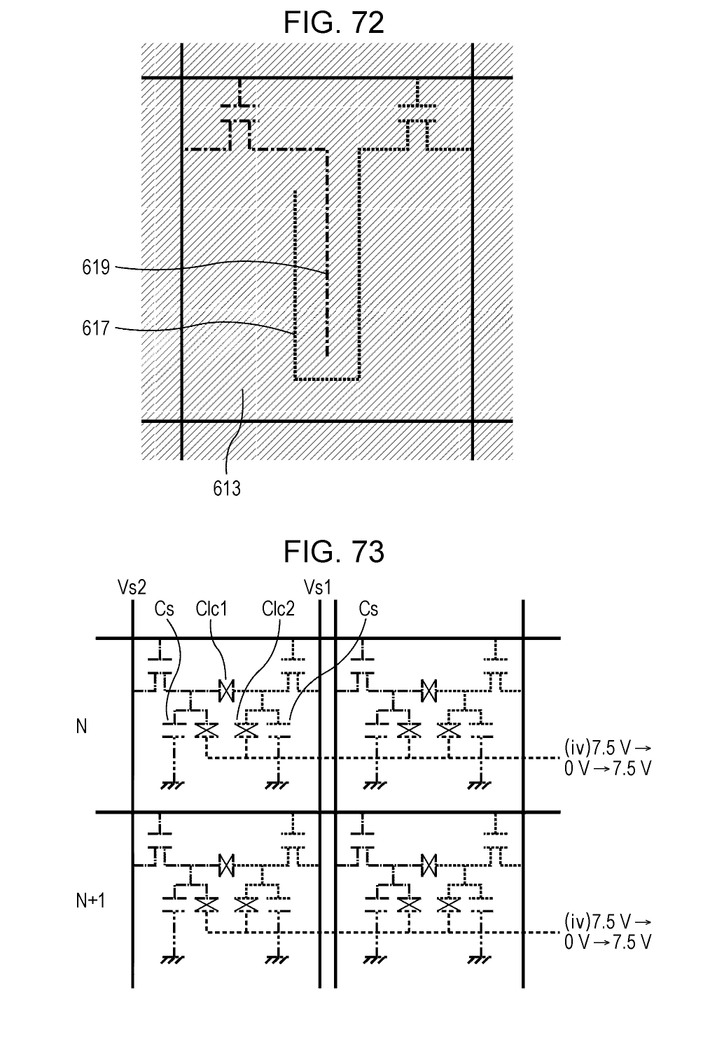

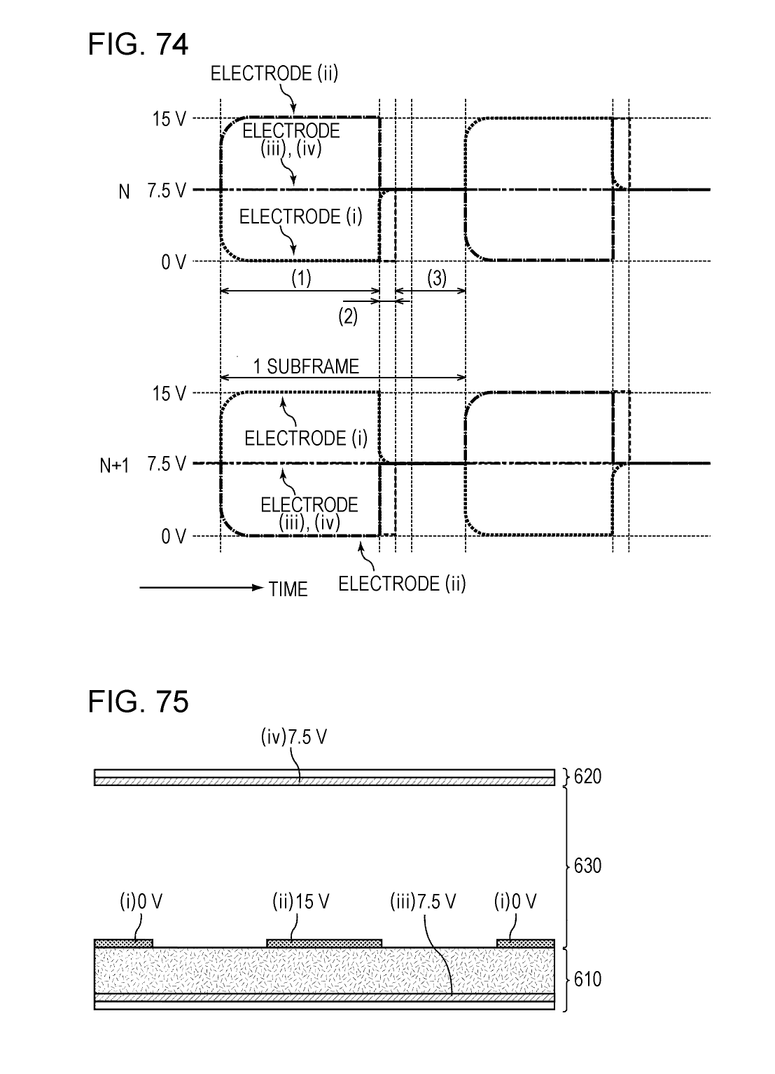

FIG. 71 is a schematic sectional view of the liquid crystal display panel of a fourth preferred embodiment of the present invention. FIG. 72 is a plan view of a picture element in the liquid crystal display panel of the fourth preferred embodiment. FIG. 73 is an equivalent circuit diagram of the picture element in the liquid crystal display panel of the fourth preferred embodiment. FIG. 74 illustrates a potential change of each electrode in the liquid crystal display panel of the fourth preferred embodiment. In the driving method of each module of the fourth preferred embodiment, two TFTs are preferably driven on a per picture element basis. As illustrated in FIG. 71 through FIG. 74, a chain line with two dots denotes a wiring electrically connected to a lower layer electrode on the lower substrate. A chain line with one dot denotes a wiring electrically connected to one comb electrode of the pair of comb electrodes on the lower substrate. A dotted line with narrower intervals denotes a wiring electrically connected to the other comb electrode of the pair of comb electrodes on the lower substrate. A broken line with wider intervals denotes a wiring electrically connected to the electrode on the upper substrate. Each of the lower layer electrodes also preferably serves as a Cs electrode, and the lower layer electrodes on all the pixels are connected together. As illustrated in FIG. 71, Cs denotes a storage capacitor defined by overlapping portions of the comb electrode and the Cs electrode, Clc1 denotes a liquid crystal capacitor arranged between the pair of comb electrodes, and Clc2 denotes a liquid crystal capacitor arranged between the electrodes of the pair of substrates.

In a picture element at an N-th row, a voltage applied to the opposite electrode (iv) on the opposite substrate is about 7.5 V during the light image displaying, then changes to about 0 V during the dark displaying (black image displaying), and becomes about 7.5 V in the initialization process step. In a picture element at an (N+1)-th row, a voltage applied to the opposite electrode (iv) on the opposite substrate is about 7.5 V during the light image displaying, then changes to about 0 V during the dark displaying (black image displaying), and then becomes about 7.5 V in the initialization process step. The N-th row may be an even-numbered line, and the (N+1)-th row may be an odd-numbered line. Alternatively, the N-th row may be an odd-numbered line, and the (N+1)-th row may be an even-numbered line. In the fourth preferred embodiment, the vertical electric field is applied by changing a voltage applied to the opposite electrodes (iv) of the opposite substrate to which all the pixels are connected to together during a period (2) of FIG. 74 (in the first preferred embodiment, the opposite electrodes are preferably a common electrode and are fixed to about 7.5 V). It is illustrated that the potential of the electrode supplied with a constant voltage is set to be about 7.5 V. However, since the potential may also be interpreted as 0 V or substantially 0 V, the N line and the (N+1) line are alternately polarity inverted to be driven.

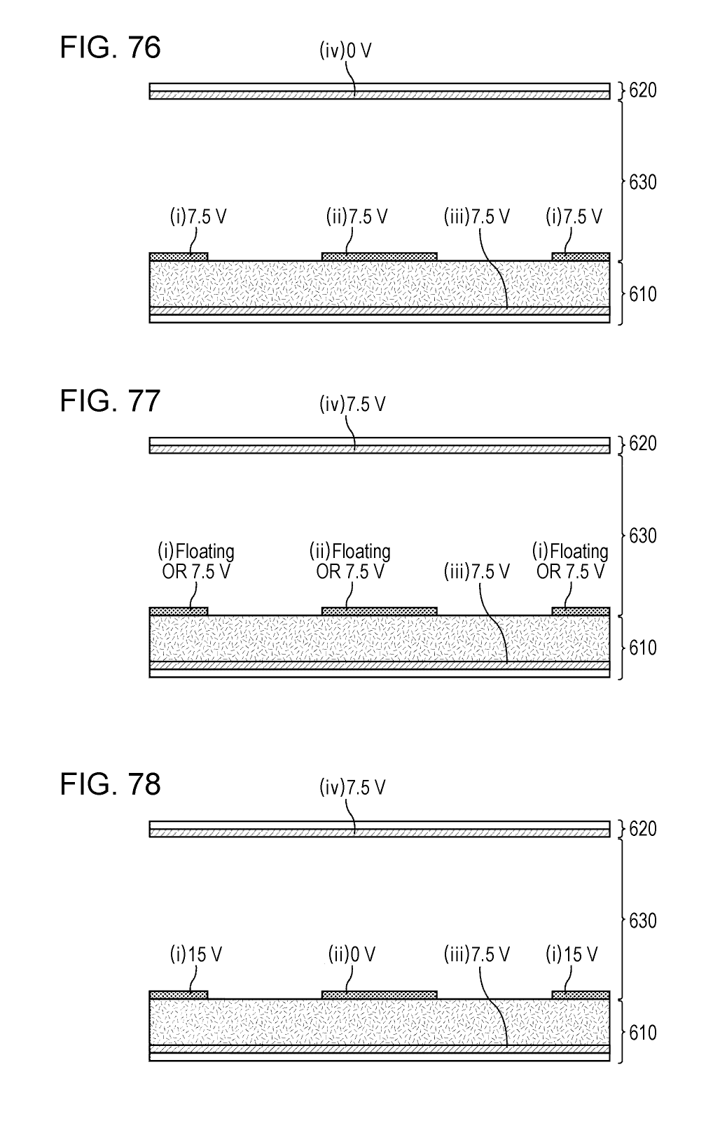

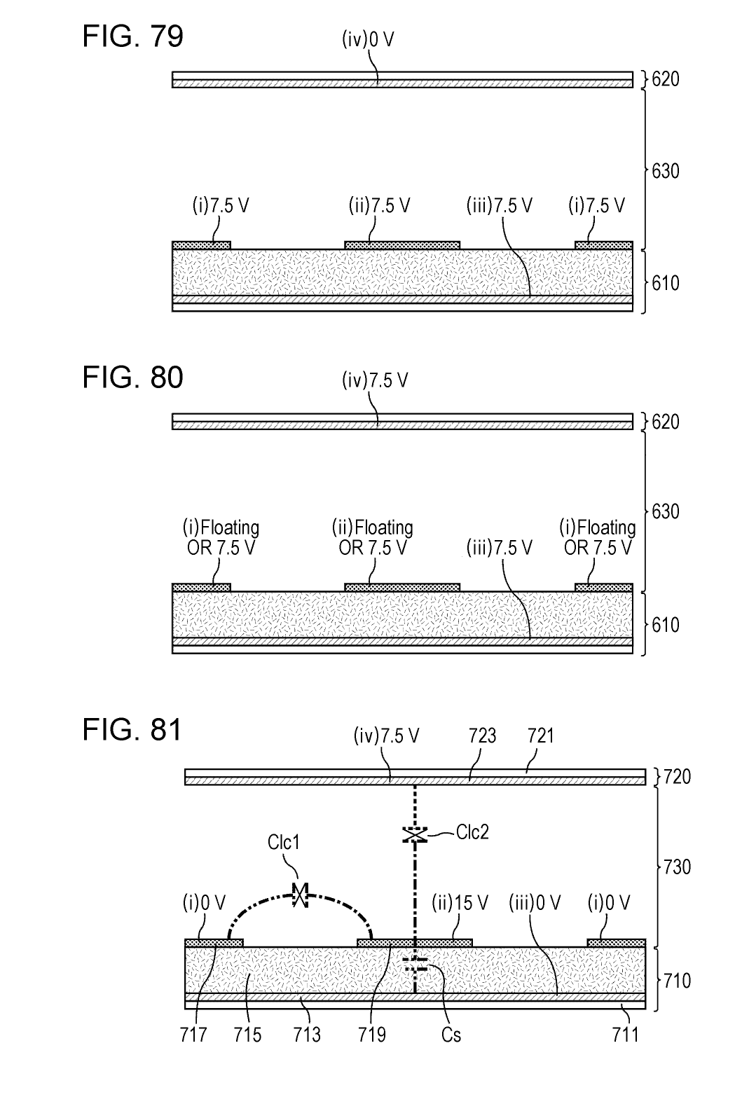

FIG. 75 is a schematic sectional view illustrating each electrode at an N-th row of the liquid crystal display panel of the fourth preferred embodiment during the generation of an in-plane electric field. FIG. 76 is a schematic sectional view illustrating each electrode at the N-th row of the liquid crystal display panel of the fourth preferred embodiment during the generation of a vertical electric field. FIG. 77 is a schematic sectional view illustrating each electrode at the N-th row of the liquid crystal display panel of the fourth preferred embodiment during an initialization process step subsequent to the generation of the vertical electric field. FIG. 78 is a schematic sectional view illustrating each electrode at an (N+1)-th row of the liquid crystal display panel of the fourth preferred embodiment during the generation of the in-plane electric field. FIG. 79 is a schematic sectional view illustrating each electrode at the (N+1)-th row of the liquid crystal display panel of the fourth preferred embodiment during the generation of the vertical electric field. FIG. 80 is a schematic sectional view illustrating each electrode at the (N+1)-th row of the liquid crystal display panel of the fourth preferred embodiment during an initialization process step subsequent to the generation of the vertical electric field.

As illustrated in FIG. 75 and FIG. 78, the liquid crystal is driven by the in-plane electric field between the pair of comb electrodes. As illustrated in FIG. 76 and FIG. 79, the comb electrodes and the lower layer electrode are together set to about 7.5 V, and the opposite electrode on the opposite substrate is set to about 0 V to apply the vertical electric field. As illustrated in FIG. 77 and FIG. 80, all the electrodes are set to about 7.5 V (the pair of comb electrodes may be set to floating) to refresh the liquid crystal molecules to the initial alignment (in the initialization process step). The other reference numerals in the drawings related to the fourth preferred embodiment result from adding 6 in hundreds place to the corresponding reference numerals in the first preferred embodiment.

In the fourth preferred embodiment, the voltage applied to the opposite electrode connected together to all the pixels is preferably changed to apply the vertical electric field. In this way, an electrode as the opposite electrode and the lower layer electrode commonly connected to all the pixels can be driven in a preferred fashion. More specifically, each of the opposite electrode and the lower layer electrode may be a planar electrode common to all the pixels or may be common to each even-numbered line basis and each odd-numbered line, such as a scanning line. If the planar electrode common to all the pixels is used, elements can be simplified.

Note that (1) dot inversion driving was preferably performed with the in-plane electric field applied, and (2) frame inversion driving is preferably performed with the vertical electric field applied.

### Fifth Preferred Embodiment

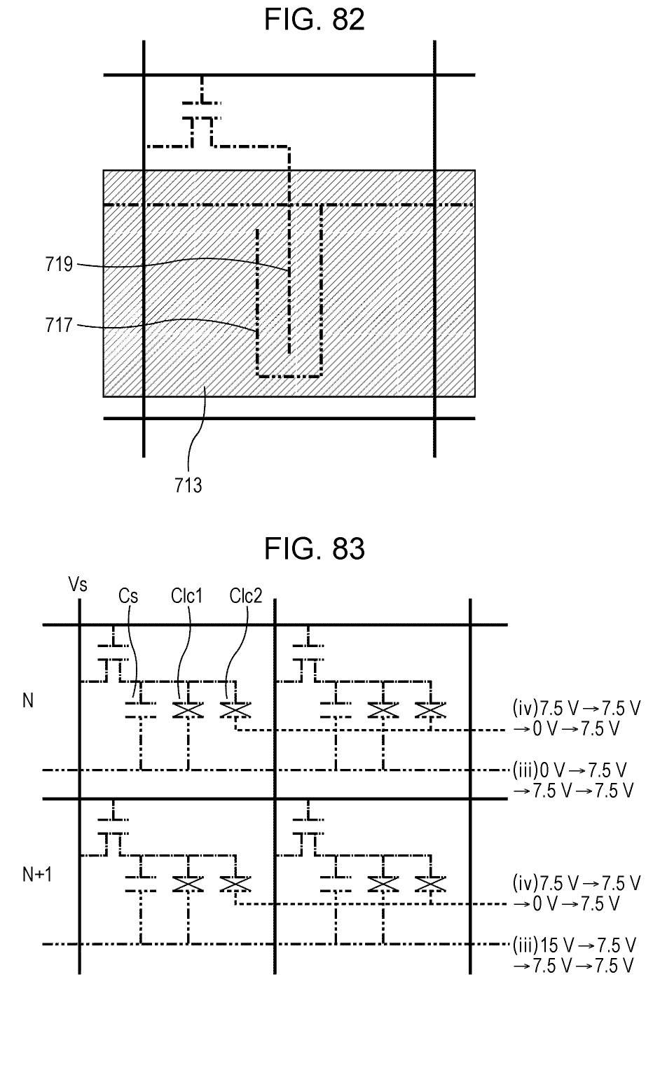

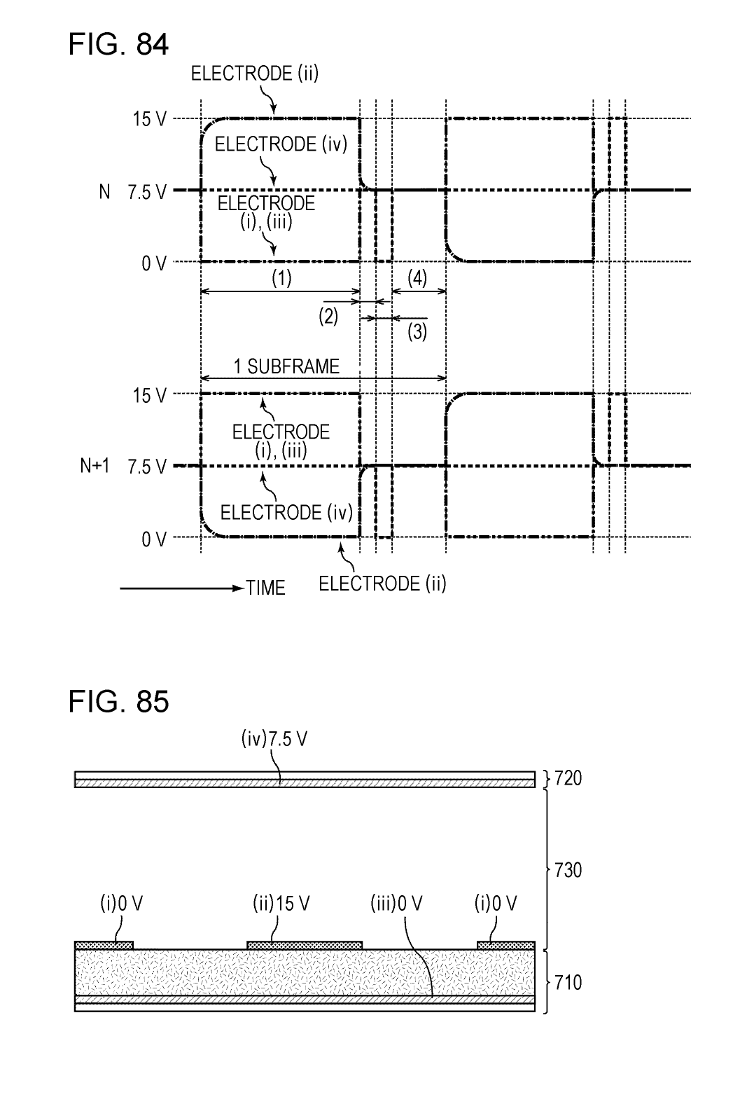

FIG. 81 is a schematic sectional view of the liquid crystal display panel of a fifth preferred embodiment of the present invention. FIG. 82 is a plan view of a picture element in the liquid crystal display panel of the fifth preferred embodiment. FIG. 83 is an equivalent circuit diagram of the picture element in the liquid crystal display panel of the fifth preferred embodiment. FIG. 84 illustrates a potential change of each electrode in the liquid crystal display panel of the fifth preferred embodiment. In the driving method of each module of the fifth preferred embodiment, one TFT is driven on a per picture element basis. As illustrated in FIG. 81 through FIG. 84, a chain line with two dots denotes a wiring electrically connected to a lower layer electrode on the lower substrate. A chain line with one dot denotes a wiring electrically connected to one comb electrode of the pair of comb electrodes on the lower substrate. A wiring electrically connected to the other comb electrode of the pair of comb electrodes is denoted by the chain line with two dots because the other comb electrode of the pair of comb electrodes on the lower substrate is electrically connected to the lower layer electrode of the lower substrate. A broken line denotes a wiring electrically connected to the electrode on the upper substrate. Each of the lower layer electrodes also preferably serves as a Cs electrode, and the lower layer electrodes are commonly connected on a per even-numbered line basis and on a per odd-numbered line basis.

In a picture element at an N-th row, a voltage applied to the lower layer electrode (iii) is about 0 V during the light image displaying, and then changes to about 7.5 V with the vertical electric field applied during the dark displaying (black image displaying) after becoming about 7.5 V in the initialization process step (all TFTs turned on). The voltage applied to the lower layer electrode (iii) is about 7.5 V in the initialization process step subsequent to the application of the vertical electric field. A voltage applied to the opposite electrode (iv) on the side of the opposite substrate is about 7.5 V during the light image displaying, and then changes to about 0 V with the vertical electric field applied during dark displaying (black image displaying) after becoming about 7.5 V in the initialization process step (all TFTs turned on). The voltage applied to the opposite electrode (iv) is about 7.5 V in the initialization process step subsequent to the application of the vertical electric field. In a picture element at an (N+1)-th row, a voltage applied to the lower layer electrode (iii) is about 15 V during the light image displaying, and then changes to about 7.5 V with the vertical electric field applied during the dark displaying (black image displaying) after becoming about 7.5 V in the initialization process step (all TFTs turned on). The voltage applied to the lower layer electrode (iii) is about 7.5 V in the initialization process step subsequent to the application of the vertical electric field. The voltage applied to the opposite electrode (iv) on the side of the opposite substrate is about 7.5 V during the light image displaying, and then changes to about 0 V with the vertical electric field applied during the dark displaying (black image displaying) after becoming about 7.5 V in the initialization process step (all TFTs turned on). The voltage applied to the opposite electrode (iv) is about 7.5 V in the initialization process step subsequent to the application of the vertical electric field. The N-th row may be an even-numbered line, and the (N+1)-th row may be an odd-numbered line. Alternatively, the N-th row may be an odd-numbered line, and the (N+1)-th row may be an even-numbered line. In the fifth preferred embodiment, the vertical electric field is controlled by applying a voltage to the opposite electrode commonly connected to all the pixels. It is illustrated that the potential of the electrode supplied with a constant voltage is set to be about 7.5 V. However, since the potential may also be interpreted as 0 V or substantially 0 V, the N line and the (N+1) line are alternately polarity inverted to be driven.

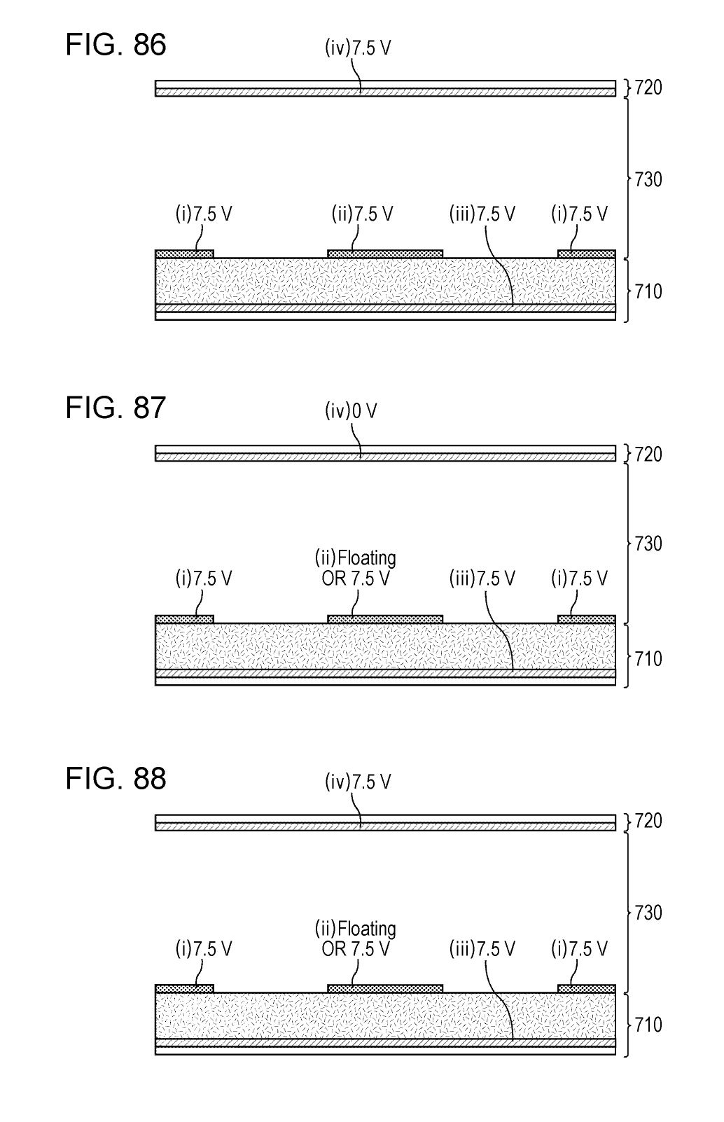

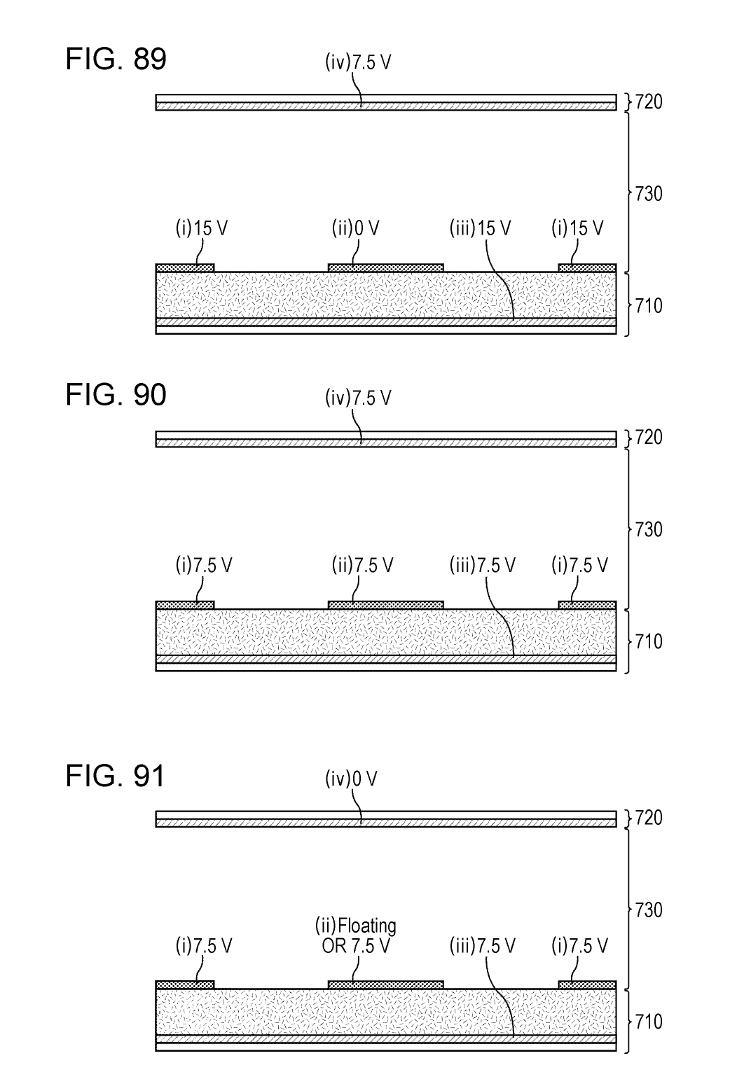

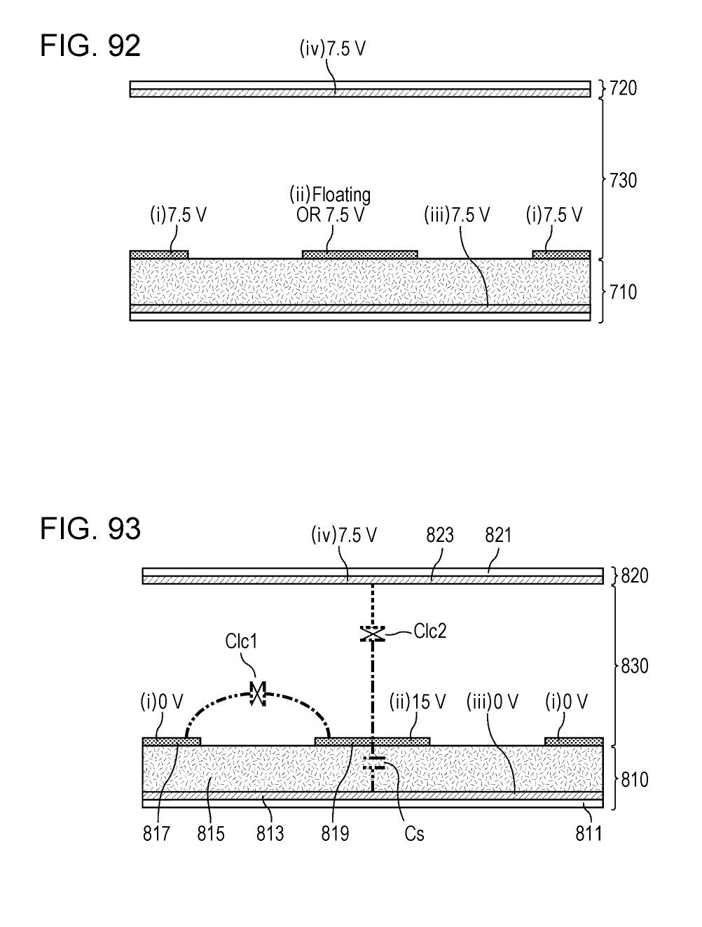

FIG. 85 is a schematic sectional view illustrating each electrode at an N-th row of the liquid crystal display panel of the fifth preferred embodiment during the generation of an in-plane electric field. FIG. 86 is a schematic sectional view illustrating each electrode at the N-th row of the liquid crystal display panel of the fifth preferred embodiment during an initialization process step subsequent to the generation of the in-plane electric field. FIG. 87 is a schematic sectional view illustrating each electrode at the N-th row of the liquid crystal display panel of the fifth preferred embodiment during the generation of a vertical electric field. FIG. 88 is a schematic sectional view illustrating each electrode at the N-th row of the liquid crystal display panel of the fifth preferred embodiment during an initialization process step subsequent to the generation of the vertical electric field. FIG. 89 is a schematic sectional view illustrating each electrode at an (N+1)-th row of the liquid crystal display panel of the fifth preferred embodiment during the generation of the in-plane electric field. FIG. 90 is a schematic sectional view illustrating each electrode at the (N+1)-th row of the liquid crystal display panel of the fifth preferred embodiment during an initialization process step subsequent to the generation of the in-plane electric field. FIG. 91 is a schematic sectional view illustrating each electrode at the (N+1)-th row of the liquid crystal display panel of the fifth preferred embodiment during the generation of the vertical electric field. FIG. 92 is a schematic sectional view illustrating each electrode at the (N+1)-th row of the liquid crystal display panel of the fifth preferred embodiment during an initialization process step subsequent to the generation of the vertical electric field.

As illustrated in FIG. 85 and FIG. 90, the liquid crystal is preferably driven by the in-plane electric field between the pair of comb electrodes. As illustrated in FIG. 86 and FIG. 90, all the TFTs are turned on, resetting all the electrodes to about 7.5 V. As illustrated in FIG. 87 and FIG. 91, the electrode on the lower substrate is set to about 7.5 V, and the opposite electrode on the opposite substrate is set to about 0 V to apply the vertical electric field (the TFT of one comb electrode of the comb electrodes is turned off to cause the one comb electrode of the comb electrodes to be floating). As illustrated in FIG. 88 and FIG. 92, all the electrodes are set to about 7.5 V (the TFT of one comb electrode of the comb electrodes is turned off to cause the one comb electrode of the comb electrodes to be floating) to refresh the liquid crystal molecules to the initial alignment (in the initialization process step). The other reference numerals in the drawings related to the fifth preferred embodiment result from adding 7 in hundreds place to the corresponding reference numerals in the first preferred embodiment.

Note that (1) dot inversion driving was preferably performed with the in-plane electric field applied, and (2) frame inversion driving is preferably performed with the vertical electric field applied.

In the fourth preferred embodiment, each of the opposite electrode and the lower layer electrode may be a planar electrode common to all the pixels or may be common to each even-numbered line basis and each odd-numbered line, such as, for example, a scanning line. In the fifth preferred embodiment, the lower layer electrodes are used to perform line inversion driving, and thus typically serve as an electrode common to each even-numbered line basis and each odd-numbered line along a bus line, such as a scanning line. On the other hand, the opposite electrode (iv) on the opposite substrate preferably serves as an electrode common to all the pixels in the fifth preferred embodiment. Alternatively, the opposite electrode (iv) on the opposite substrate may serve as an electrode common to each even-numbered line basis and each odd-numbered line.

### Modification of Fifth Preferred Embodiment

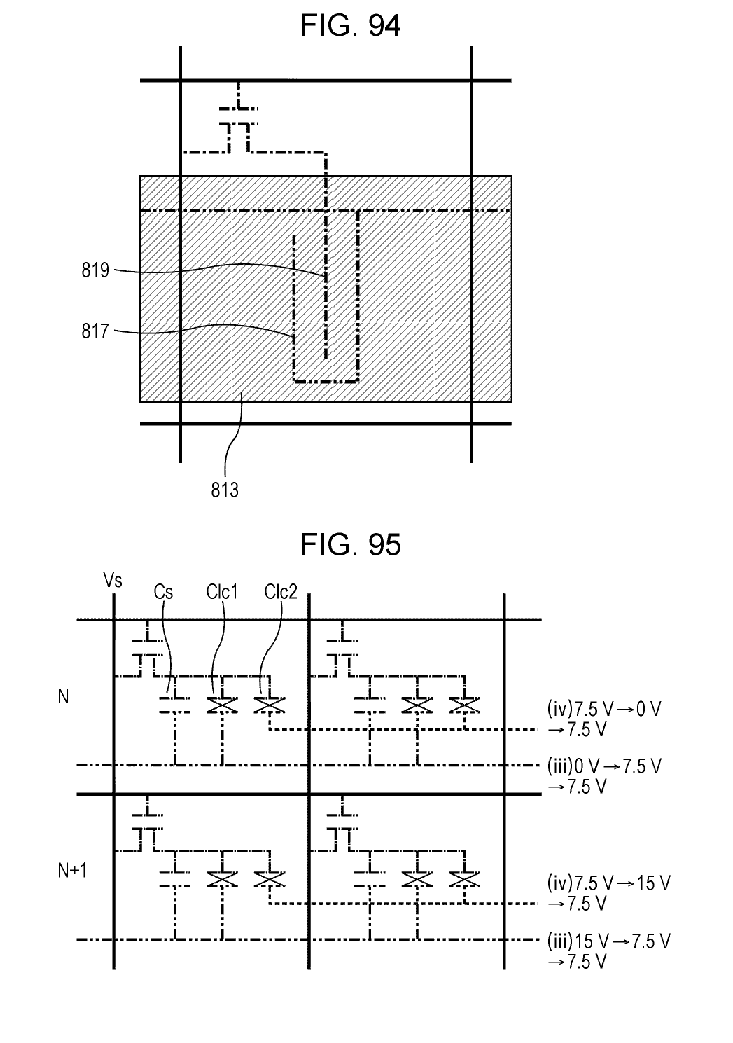

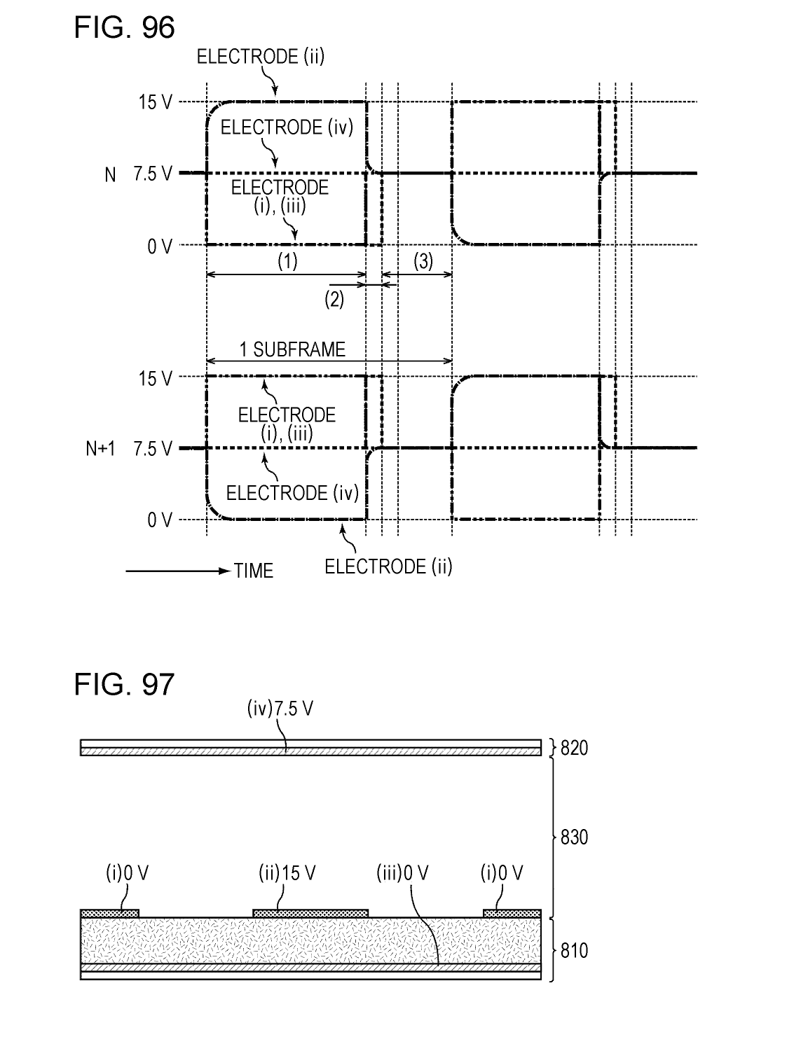

FIG. 93 is a schematic sectional view of the liquid crystal display panel of a modification of the fifth preferred embodiment of the present invention. FIG. 94 is a plan view of a picture element in the liquid crystal display panel of the modification of the fifth preferred embodiment. FIG. 95 is an equivalent circuit diagram of the picture element in the liquid crystal display panel of the modification of the fifth preferred embodiment. FIG. 96 illustrates a potential change of each electrode in the liquid crystal display panel of the modification of the fifth preferred embodiment. In the driving method of each module of the modification of the fifth preferred embodiment, one TFT is driven on a per picture element basis. As illustrated in FIG. 93 through FIG. 96, a chain line with two dots denotes a wiring electrically connected to a lower layer electrode on the lower substrate. A chain line with one dot denotes a wiring electrically connected to one comb electrode of the pair of comb electrodes on the lower substrate. A wiring electrically connected to the other comb electrode of the pair of comb electrodes on the lower substrate is denoted by the chain line with two dots because the other comb electrode of the pair of comb electrodes on the lower substrate is electrically connected to the lower layer electrode of the lower substrate. A broken line denotes a wiring electrically connected to the electrode on the upper substrate. Each of the lower layer electrodes also preferably serves as a Cs electrode, and the lower layer electrodes are commonly connected on a per even-numbered line basis and on a per odd-numbered line basis. In a picture element at an N-th row, a voltage applied to the lower layer electrode (iii) is about 0 V during the light image displaying, then changes to about 7.5 V with the vertical electric field applied during the dark displaying (black image displaying), and then becomes about 7.5 V in the initialization process step during the dark displaying (black image displaying). A voltage applied to the opposite electrode (iv) on the side of the opposite substrate is about 7.5 V during the light image displaying, changes to about 0 V during the dark displaying (black image displaying), and then becomes about 7.5 V in the initialization process step. In a picture element at an (N+1)-th row, a voltage applied to the lower layer electrode (iii) is about 15 V during the light image displaying, then changes to about 7.5 V with the vertical electric field applied during the dark displaying (black image displaying), and then becomes about 7.5 V in the initialization process step during the dark displaying (black image displaying). The voltage applied to the opposite electrode (iv) on the side of the opposite substrate is about 7.5 V during the light image displaying, then changes to about 15 V during dark displaying (black image displaying), and then becomes about 7.5 V in the initialization process step. The N-th row may be an even-numbered line, and the (N+1)-th row may be an odd-numbered line. Alternatively, the N-th row may be an odd-numbered line, and the (N+1)-th row may be an even-numbered line. In the modification of the fifth preferred embodiment, the vertical electric field is defined by applying a voltage to the opposite electrode connected to all the pixels. In the modification of the fifth preferred embodiment, voltages are applied to the lower layer electrode commonly connected on a per even-numbered line basis and on a per odd-numbered line basis, and the opposite electrodes on the side of the opposite substrate commonly connected on a per even-numbered line basis and on a per odd-numbered line basis to change the potentials thereon. In the driving by the modification of the fifth preferred embodiment, the opposite electrodes (iv) on the side of the opposite are commonly connected to all the pixels instead of being connected on a per even-numbered line basis and on a per odd-numbered line basis. In such a case, the voltage applied to the electrode (iv) of FIG. 96 is about 0 V at both the N-th line and the (N+1)-th line during a period (2), but the potential change of each of the other electrodes remains unchanged from the modification of the fifth preferred embodiment. It is illustrated that the potential of the electrode supplied with a constant voltage is set to be about 7.5 V. However, since the potential may also be interpreted as 0 V or substantially 0 V, the N line and the (N+1) line are alternately polarity inverted to be driven.

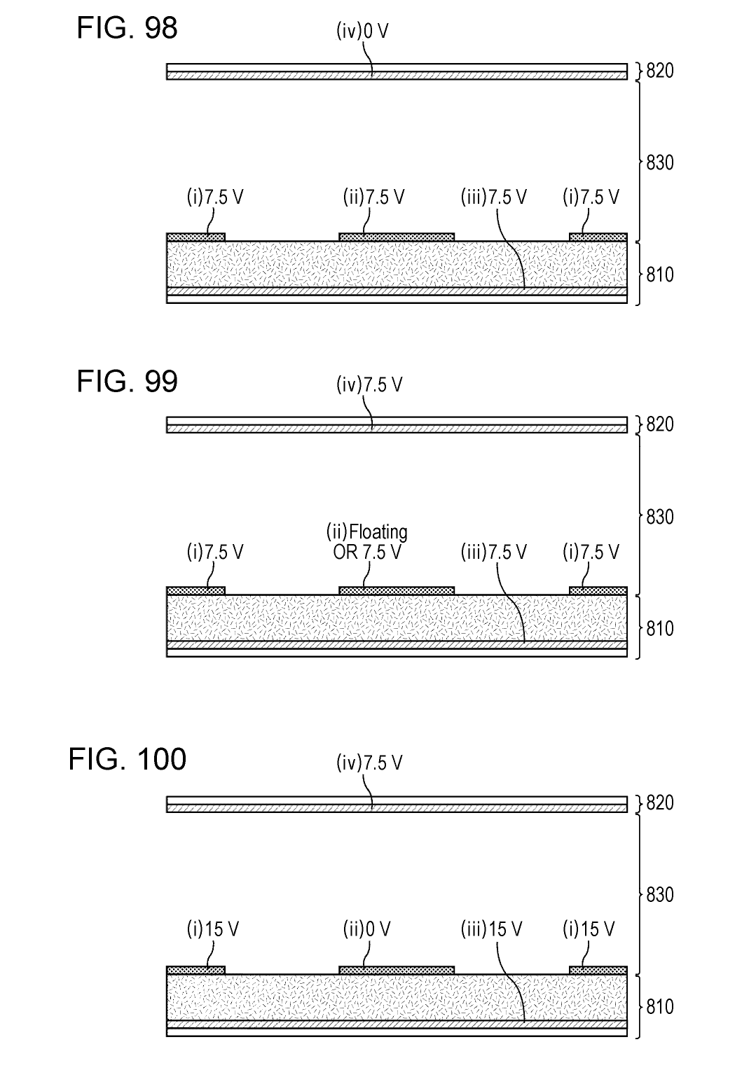

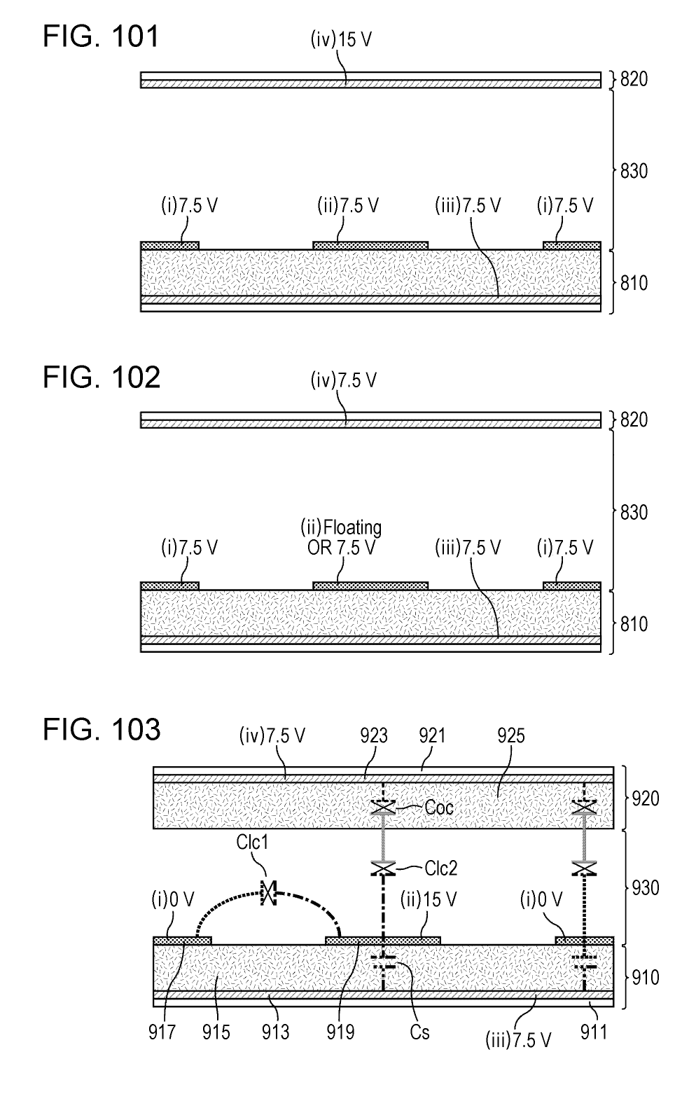

FIG. 97 is a schematic sectional view illustrating each electrode at an N-th row of the liquid crystal display panel of the modification of the fifth preferred embodiment during the generation of an in-plane electric field. FIG. 98 is a schematic sectional view illustrating each electrode at the N-th row of the liquid crystal display panel of the modification of the fifth preferred embodiment during the generation of a vertical electric field. FIG. 99 is a schematic sectional view illustrating each electrode at the N-th row of the liquid crystal display panel of the modification of the fifth preferred embodiment during an initialization process step subsequent to the generation of the vertical electric field. FIG. 100 is a schematic sectional view illustrating each electrode at an (N+1)-th row of the liquid crystal display panel of the modification of the fifth preferred embodiment during the generation of the in-plane electric field. FIG. 101 is a schematic sectional view illustrating each electrode at the (N+1)-th row of the liquid crystal display panel of the modification of the fifth preferred embodiment during the generation of the vertical electric field. FIG. 102 is a schematic sectional view illustrating each electrode at the (N+1)-th row of the liquid crystal display panel of the modification of the fifth preferred embodiment during an initialization process step subsequent to the generation of the vertical electric field.

As illustrated in FIG. 97 and FIG. 100, the liquid crystal is preferably driven by the in-plane electric field between the pair of comb electrodes. As illustrated in FIG. 98 and FIG. 101, the comb electrodes and the lower layer electrode are set to about 7.5 V, and the opposite electrode on the opposite substrate is set to about 0 V or about 15 V to apply the vertical electric field. As illustrated in FIG. 99 and FIG. 102, all the electrodes are set to about 7.5 V to refresh the liquid crystal molecules to the initial alignment (in the initialization process step) (the TFT of one comb electrode of the comb electrodes may be turned off to cause the one comb electrode of the comb electrodes to be floating). The other reference numerals in the drawings related to the modification of the fifth preferred embodiment result from adding 8 in hundreds place to the corresponding reference numerals in the first preferred embodiment.

### Sixth Preferred Embodiment

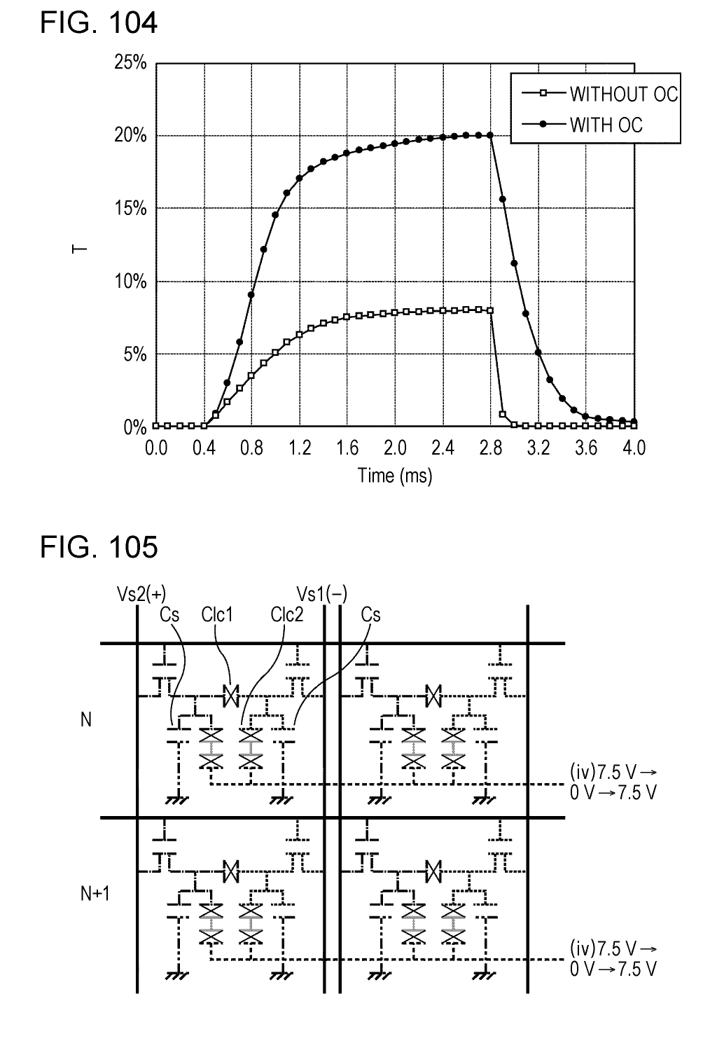

FIG. 103 is a schematic sectional view of the liquid crystal display panel of a sixth preferred embodiment of the present invention. FIG. 104 is a graph illustrating a comparison of response waveforms through simulations of the presence or absence of a dielectric layer on an opposite electrode. FIG. 105 is an equivalent circuit diagram of a picture element in the liquid crystal display panel of the sixth preferred embodiment. In the driving method of each module of the fourth preferred embodiment, two TFTs are driven on a per picture element basis. As illustrated in FIG. 103 through FIG. 105, a chain line with two dots denotes a wiring electrically connected to a lower layer electrode on the lower substrate. A chain line with one dot denotes a wiring electrically connected to one comb electrode of the pair of comb electrodes on the lower substrate. A dotted line with narrower intervals denotes a wiring electrically connected to the other comb electrode of the pair of comb electrodes on the lower substrate. A broken line with wider intervals denotes a wiring electrically connected to the electrode on the upper substrate. Each of the lower layer electrodes also preferably serves as a Cs electrode, and the lower layer electrodes are commonly connected to all the pixels. As illustrated in FIG. 103, Cs denotes a storage capacitor defined by overlapping portions of the comb electrode and the Cs electrode, Clc1 denotes a liquid crystal capacitor arranged between the pair of comb electrodes, and Clc2 denotes a liquid crystal capacitor arranged between the electrodes of the pair of substrates. Coc denotes a capacitor of the dielectric layer similarly arranged between the electrodes of the pair of substrates.

In a picture element at the N-th row, a voltage applied to the opposite electrode (iv) on the side of the opposite substrate is about 7.5 V during the light image displaying, changes to about 0 V during the dark displaying (black image displaying), and then becomes about 7.5 V in the initialization process step. In a picture element at an (N+1)-th row, a voltage applied to the opposite electrode (iv) on the side of the opposite substrate is about 7.5 V during the light image displaying, then changes to about 0 V during the dark displaying (black image displaying), and then becomes about 7.5 V in the initialization process step. The N-th row may be an even-numbered line, and the (N+1)-th row may be an odd-numbered line. Alternatively, the N-th row may be an odd-numbered line, and the (N+1)-th row may be an even-numbered line.

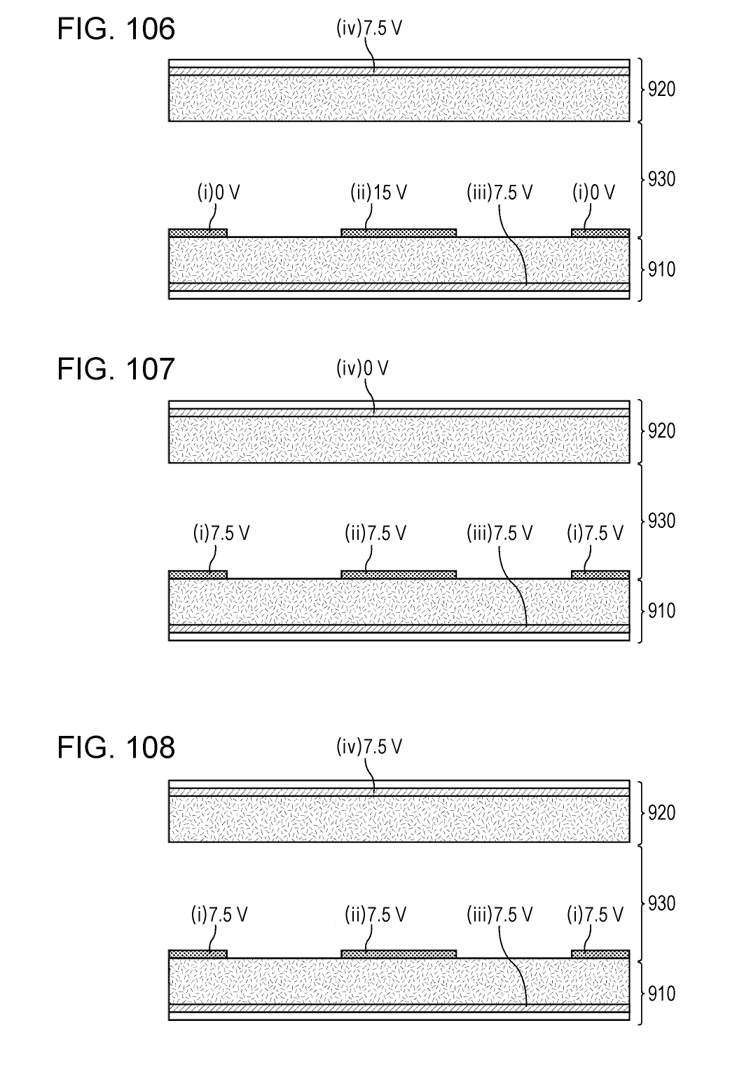

FIG. 106 is a schematic sectional view of each electrode at an N-th row of the liquid crystal display panel of the sixth preferred embodiment during the generation of an in-plane electric field. FIG. 107 is a schematic sectional view of each electrode at the N-th row of the liquid crystal display panel of the sixth preferred embodiment during the generation of a vertical electric field. FIG. 108 is a schematic sectional view of each electrode at the N-th row of the liquid crystal display panel of the sixth preferred embodiment during an initialization process step subsequent to the generation of the vertical electric field.

As illustrated in FIG. 106, the liquid crystal is preferably driven by the in-plane electric field between the pair of comb electrodes. As illustrated in FIG. 107, the comb electrodes and the lower layer electrode are set to about 7.5 V, and the opposite electrode on the side of the opposite substrate is set to about 0 V to apply the vertical electric field. As illustrated in FIG. 108, all the electrodes are set to about 7.5 V (the pair of comb electrodes may be set to be floating) to refresh the liquid crystal molecules to the initial alignment (in the initialization process step). The other reference numerals in the drawings related to the sixth preferred embodiment result from adding 9 in hundreds place to the corresponding reference numerals in the first preferred embodiment. The voltage applied to each electrode is identical to that in the fourth preferred embodiment.

In the sixth preferred embodiment, the transmittance is increased (FIG. 104) by arranging a dielectric layer (also referred to as an overcoat layer or an OC layer) on the opposite electrode commonly connected to all the pixels.

FIG. 104 illustrates simulation results that are obtained with the liquid crystal thickness d=3 μm, L/S=2.6 μm/3 μm, OC thickness 1.5 μm, and specific dielectric constant ∈=3.7. With the OC layer arranged, the transmittance was increased from 8% (without the OC) to 20% (with the OC).

If the liquid crystals with the OC and without the OC, having the same layer thickness, are compared, the liquid crystal with the OC weakens a vertical component of the electric field distribution in the liquid crystal layer and intensifies an in-plane component of the electric field distribution during the generation of the potential difference between the comb electrodes (white displaying).

A preferred range of the present preferred embodiment is described below. The specific dielectric constant of the dielectric layer: 1<∈, and the thickness of the dielectric layer: 0<d_{OC}<4 μm.

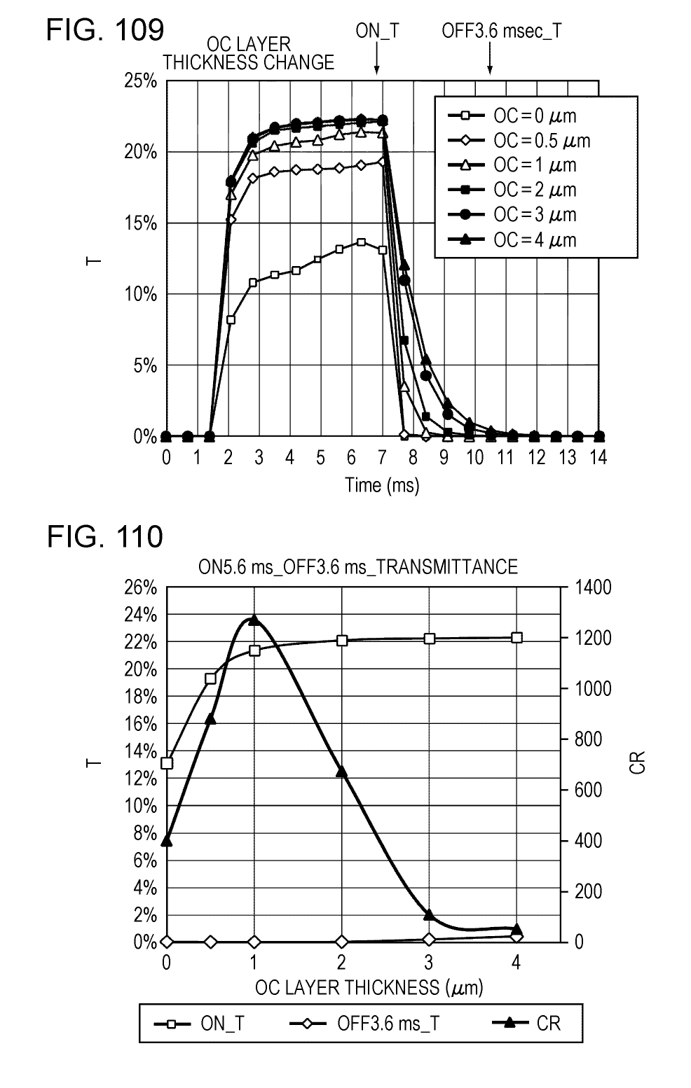

If the thickness of the OC layer is increased, or the dielectric constant of the OC layer is decreased, the transmittance increases during the in-plane driving period, but the improvement effect at a rise response time with the vertical electric field applied is reduced (see FIG. 109 and FIG. 111 to be discussed below).

The OC layer may preferably be manufactured of a typical material (such as, for example, an organic insulating layer of acrylic resin having a thickness of about 1 μm to about 3 μm and a dielectric constant of about 3 to about 4, or an inorganic insulating film of silicon nitride having a thickness of about 50 nm to about 150 nm and a dielectric constant of about 6 to about 7).

Even if the sixth preferred embodiment of the structure having the OC layer is operated using any of the one TFT driving of the fifth preferred embodiment and the driving methods of the first through third preferred embodiments, the same effect will preferably be achieved. If the liquid crystal is a negative-type liquid crystal, the same effect is achieved.

### Relationship Between Transmittance and OC Layer

FIG. 109 is a graph illustrating the transmittance with respect to time with the layer thickness of the dielectric layer varied in the sixth preferred embodiment. FIG. 110 is a graph illustrating transmittances at times T_{ON}, and T_{OFF3.6ms} and contrast ratio (CR) with respect to the layer thickness of the dielectric layer in the sixth preferred embodiment. In the CR graph, a value is read from the right-side vertical axis, and in the other graphs, a value is read from the left-side vertical axis.

Simulation conditions are as follows: the thickness of the OC layer was varied from 0 μm to 4 μm with the liquid crystal thickness d=3.5 μm, L/S=2.6 μm/3 μm, and the specific dielectric constant ∈ of the OC layer=3.7. The in-plane electric field was applied in an application waveform of 1.4 msec to 7 msec (a duration of 5.6 msec), then the vertical electric field was applied from 7 msec to 12.6 msec (a duration of 5.6 msec), and then the applied voltage was set to 0 V.

As illustrated in FIG. 109 and FIG. 110 and the following table 3, the OC layer having a thickness of 0.5 μm or more exhibits a pronounced increasing effect in the transmittance, and is thus preferable in terms of the increase of transmittance. On the other hand, as the layer thickness increases, the rise time increases. The transmittance increasing effect tends to flatten out. With these data comprehensively accounted for, the dielectric layer thickness d_{OC} preferably falls within a range of about 0 μm<d_{OC}<about 4 μm. In FIG. 110 and table 3, ON_T represents a transmittance at a time point of ON_T in FIG. 109, and OFF 3.6 ms after_T and OFF3.6 ms_normalized T respectively represent a transmittance and a normalized transmittance at a time point of OFF3.6 msec_T in FIG. 109.

TABLE 3
Change in OC layer thickness

| OC layer | | | | |
|---|---|---|---|---|
| thickness | | OFF 3.6 ms | | |
| (μm) | ON_T | after_T | CR | OFF 3.6 ms_normalized T |
| 0 | 13% | 0.0% | 400 | 0.2% |
| 0.5 | 19% | 0.0% | 880 | 0.1% |
| 1 | 21% | 0.0% | 1270 | 0.1% |
| 2 | 22% | 0.0% | 673 | 0.1% |
| 3 | 22% | 0.2% | 109 | 0.9% |
| 4 | 22% | 0.4% | 52 | 1.9% |

Relationship Between Transmittance and Specific Dielectric Constant of OC Layer

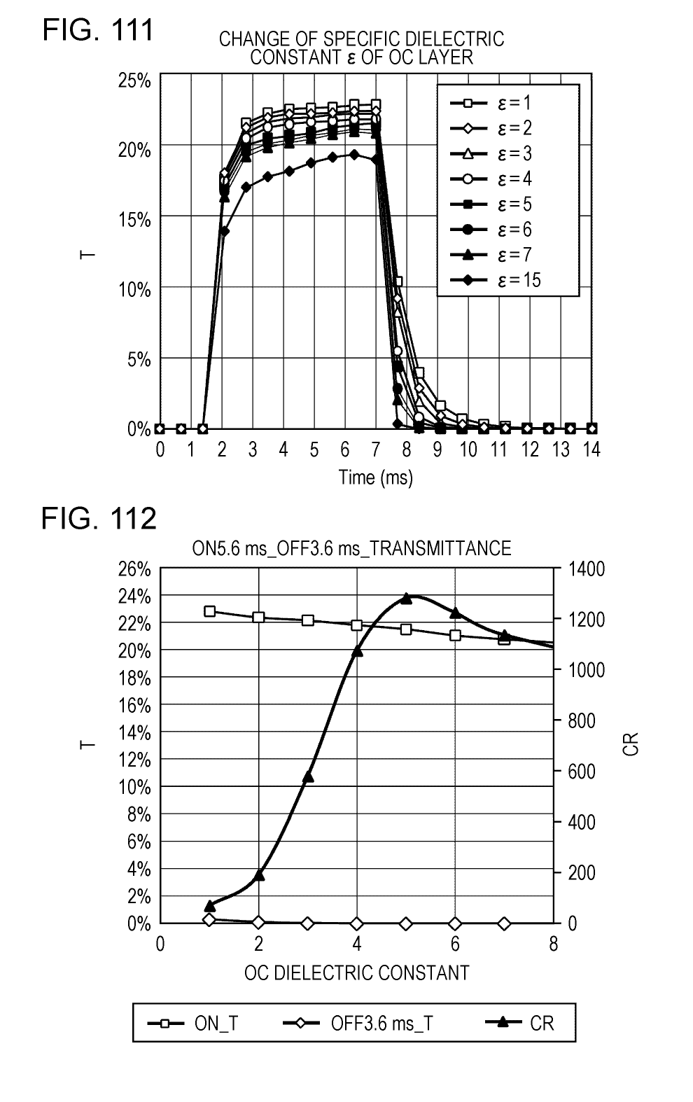

FIG. 111 is a graph illustrating the transmittance with respect to time with the specific dielectric constant of the dielectric layer varied in the sixth preferred embodiment. FIG. 112 is a graph illustrating transmittances at times T_{ON}, and T_{OFF3.6ms} and contrast ratio (CR) with respect to the specific dielectric constant of the dielectric layer in the sixth preferred embodiment. In the CR graph, a value is read from the right-side vertical axis, and in the other graphs, a value is read from the left-side vertical axis.

Simulation conditions are as follows: the specific dielectric constant of the OC layer was varied from about 1 to about 15 with the liquid crystal thickness d=3.5 μm, L/S=2.6 μm/3 μm, and the OC layer thickness=1.5 μm. The application waveform remains unchanged from that described above (in the relationship between the transmittance and the OC layer thickness).

As illustrated in FIG. 111 and FIG. 112 and the following table 4, as the dielectric constant of the OC layer decreases, the transmittance increases, but the rise time lengthens. The specific dielectric constant of the dielectric layer is preferably 1<∈. ON_T and OFF3.6 ms_T represent transmittances at the time points illustrated in FIG. 109.

TABLE 4
Change in OC dielectric constant

| OC dielectric | | OFF 3.6 ms | | |
|---|---|---|---|---|
| constant | ON_T | after_T | CR | OFF 3.6 ms_normalized T |
| 1 | 23% | 0.3% | 71 | 1.4% |
| 2 | 22% | 0.1% | 193 | 0.5% |
| 3 | 22% | 0.0% | 579 | 0.2% |
| 4 | 22% | 0.0% | 1073 | 0.1% |
| 5 | 21% | 0.0% | 1279 | 0.1% |
| 6 | 21% | 0.0% | 1222 | 0.1% |
| 7 | 21% | 0.0% | 1134 | 0.1% |
| 15 | 19% | 0.0% | 775 | 0.1% |

The preferred ranges are set for the following reason.

One frame (of 60 Hz and 16.67 ms) may be divided into three subframes. If the first two subframes are set to be an in-plane electric field application period, and the last one subframe is a rise period of the vertical electric field, permissible fall time may be about 5.56 msec (about 1/180 Hz). If a delay time of the gate bus line on the top of a screen to the gate bus line on the bottom of the screen is about 2 msec (about 4 μsec per line×500 lines), a white to black response is preferably completed within about 6 msec in order to display an image free from uneveness over the entire screen.

A range preferred in the present preferred embodiment has thus the condition that the vertical electric field is applied, the normalized transmittance about 3.6 msec after the application of the vertical electric field is less than 1% (normalized by 7 msec transmittance On_T), and that the contrast at the two time points is about 100 or higher.

The examples of the preferred embodiments and the modifications thereof may be appropriately combined so long as the combinations fall within the scope of the present invention.

This application is based on Japanese Unexamined Patent Application Publication No. 2011-061663 filed Mar. 18, 2011, and Japanese Unexamined Patent Application Publication No. 2011-273874 filed Dec. 14, 2011, and claims priority under Paris Convention or the rule of a designated state. The content of the application is incorporated by reference in the application in its entirety.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-15. (canceled)

16. A liquid crystal driving method to drive a liquid crystal by causing a potential difference between at least two pairs of electrodes arranged on an upper substrate and a lower substrate, wherein
the liquid crystal driving method comprises driving the liquid crystal during a period including a subframe period, the subframe period being a drive period extending until the liquid crystal is changed in state and restored back to an initial state thereof, and
the liquid crystal driving method includes performing during the subframe period, with one pair of electrodes being a first pair, and the other pair of electrodes different from the first pair being a second pair, a driving operation to cause a potential difference between the first pair of electrodes, a driving operation to cause a potential difference between the second pair of electrodes, and a driving operation to cause no potential difference between all the electrodes of the first pair of electrodes and the second pair of electrodes.

17. The liquid crystal driving method according to claim 16, wherein the liquid crystal driving method includes the driving operation to cause no potential difference between all the electrodes of the first pair of electrodes and the second pair of electrodes subsequent to the driving operation to cause the potential difference between the second pair of electrodes.

18. The liquid crystal driving method according to claim 17, wherein the liquid crystal driving method further comprises performing, in order:
a first driving operation to cause the potential difference between the first pair of electrodes,
a second driving operation to cause the potential difference between the second pair of electrodes, and
a third driving operation to cause no potential difference between all the electrodes of the first pair of electrodes and the second pair of electrodes.

19. The liquid crystal driving method according to claim 16, wherein
the liquid crystal driving method is an active matrix driving method, and
the active matrix driving is performed using a plurality of bus lines including thin-film transistors, and comprises inverting a potential change applied to an (N+1)-th bus line in polarity from a potential change applied to an N-th bus line.

20. The liquid crystal driving method according to claim 18, comprising:
a first driving operation to turn on thin-film transistors connected to an N-th bus line,
a second driving operation to turn on or off the thin-film transistors connected to the N-th bus line, and
a third driving operation to turn or off the thin-film transistors connected to the N-th bus line.

21. The liquid crystal driving method according to claim 20, wherein the second driving operation turns on the thin-film transistors connected to the N-th bus line.

22. The liquid crystal driving method according to claim 20, wherein the second driving operation turns off the thin-film transistors connected to the N-th bus line.

23. The liquid crystal driving method according to claim 18, further comprising:
setting a voltage applied to the electrode common to the N-th bus line to be different in level in an initial state from a voltage applied to the electrode common to the (N+1)-th bus line in the active matrix driving with one-side electrodes of the second pairs of electrodes serving as an electrode common to each bus line, and connected to one-side electrodes of the first pairs of electrodes, and
applying a predetermined voltage to the other-side electrodes of the second pairs of electrodes.

24. The liquid crystal driving method according to claim 18, comprising:
setting a voltage applied to the electrode common to the N-th bus line to be equal in level in an initial state to a voltage applied to the electrode common to the (N+1)-th bus line in the active matrix driving with one-side electrodes of the second pairs of electrodes serving as an electrode common to each bus line, and
applying a predetermined voltage to the other-side electrodes of the second pairs of electrodes.

25. The liquid crystal driving method according to claim 18, comprising:
setting a voltage applied to the electrode common to the N-th bus line to be different in level in an initial state from a voltage applied to the electrode common to the (N+1)-th bus line in the active matrix driving with one-side electrodes of the second pairs of electrodes serving as an electrode common to each bus line, and connected to one-side electrodes of the first pairs of electrode, and
setting a voltage applied to the electrode common to the N-th bus line to be different in level in an initial state from a voltage applied to the electrode common to the (N+1)-th bus line with the other-side electrodes of the second pairs of electrodes serving as an electrode common to each bus line.

26. The liquid crystal driving method according to claim 18, comprising turning on thin-film transistors connected to the N-th bus line and thin-film transistors connected to the (N+1)-th bus line between the first driving operation and the second driving operation.

27. The liquid crystal driving method according to claim 16, wherein
the first pair of electrodes is a pair of comb electrodes arranged one of the upper substrate and the lower substrate, and
the second pair of electrodes comprises opposite electrodes respectively arranged on the upper substrate and the lower substrate.

28. The liquid crystal driving method according to claim 27, wherein the opposite electrodes respectively arranged on the upper substrate and the lower substrate are planar electrodes.

29. The liquid crystal driving method according to claim 16, wherein at least one of the upper substrate and the lower substrate comprises a dielectric layer.

30. A liquid crystal display apparatus driven in the liquid crystal driving method according to claim 16.
